(19) United States
(12) Patent Application Publication
(10) Pub. No.: US 2017/0085031 A1
(43) Pub. Date: Mar. 23, 2017

(54) TERMINAL CONNECTION ASSEMBLY AND CARTRIDGE

(71) Applicant: SEIKO EPSON CORPORATION, Tokyo (JP)

(72) Inventors: Taku Ishizawa, Matsumoto-shi (JP); Hiroyuki Kawate, Hokuto-shi (JP); Yoshinao Miyata, Matsukawa-mura (JP)

(21) Appl. No.: 15/263,492

(22) Filed: Sep. 13, 2016

(30) Foreign Application Priority Data
Sep. 18, 2015 (JP) 2015-185884

(51) Int. Cl. H01R 13/631; H01R 12/57

(52) U.S. Cl. CPC H01R 13/631; H01R 12/57; H01R 2201/06

(57) ABSTRACT

There is provided a terminal connection assembly. The terminal connection assembly comprises terminals configured to be electrically connectable with an apparatus-side terminal assembly of a printing apparatus; contact regions where the apparatus-side terminal assembly is in contact with the terminals; a substrate on which the terminals are provided; a supporting structure configured to support the substrate; and convexes configured to restrict motion of a positioning structure of the printing apparatus in an intersecting direction that intersects with a mounting direction in which the terminal connection assembly is mounted. In the state that the terminal connection assembly is mounted to the printing apparatus, a plurality of the contact regions are arranged to form a plurality of lines arrayed at predetermined intervals in the mounting direction. A virtual plane passing through the plurality of contact regions is inclined to the mounting direction. The convex is protruded in a direction away from the supporting structure. The configuration of the terminal connection assembly enables a liquid container to be positioned relative to the printing apparatus with high accuracy.

### CROSS-REFERENCE TO RELATED APPLICATIONS

The present application claims priority from Japanese patent application P2015-185884 filed on Sep. 18, 2015, the entirety of disclosure of which is hereby incorporated by reference into this application.

### BACKGROUND

Field

The present invention relates to a terminal connection assembly and a cartridge.

Related Art

A liquid container has been generally known to be mountable to a printing apparatus (for example, JP 2014-61693M. In the configuration disclosed in JP 2014-61693A, the liquid container is positioned relative to the printing apparatus by engagement of convexes provided in the printing apparatus with concaves provided in the liquid container.

There is, however, a demand for another configuration of positioning the liquid container relative to the printing apparatus that is suitable for the configuration of the printing apparatus. This demand is not limited to the liquid container but is common to other containers and cartridges used to supply a printing material.

### SUMMARY

In order to solve at least part of the problems described above, the invention may be implemented by aspects described below.

(1) According to one aspect of the invention, there is provided a terminal connection assembly configured to be mountable to a printing apparatus, the printing apparatus comprising an apparatus-side terminal assembly configured to be movable in an intersecting direction that intersects with a mounting direction in which the terminal connection assembly is mounted; and a positioning structure included in the apparatus side terminal assembly. The terminal connection assembly comprises: terminals configured to be electrically connectable with the apparatus-side terminal assembly; contact regions where the apparatus-side terminal assembly is in contact with the terminals; a substrate on which the terminals are provided; a supporting structure configured to support the substrate; and convexes configured to restrict motion of the positioning structure in the intersecting direction, wherein in a state that the terminal connection assembly is mounted to the printing apparatus, a plurality of the contact regions are arranged to form a plurality of lines arrayed at predetermined intervals in the mounting direction, a virtual plane passing through the plurality of contact regions is inclined to the mounting direction, and the convex is protruded in a direction away from the supporting structure.

The terminal connection assembly of this aspect enables the convexes to restrict the motion of the positioning structure in the intersecting direction.

(2) In the terminal connection assembly of the above aspect, the convex may be protruded forward in the mounting direction from the supporting structure.

The terminal connection assembly of this aspect enables the convexes to effectively restrict the motion of the positioning structure in the intersecting direction.

(3) In the terminal connection assembly of the above aspect, the convex may be engaged with a positioning concave provided in the positioning structure.

In the terminal connection assembly of this aspect, the convexes are engaged with the positioning concaves provided in the positioning structure, so as to restrict the motion of the positioning structure in the intersecting direction.

(4) In the terminal connection assembly of the above aspect, some of a plurality of the convexes may be protruded in the intersecting direction to face each other.

In the terminal connection assembly of this aspect, some of the plurality of convexes are protruded in the intersecting direction to face each other. This configuration prevents the terminal connection assembly from readily coming off from the printing apparatus.

(5) In the terminal connection assembly of the above aspect, the convex may have a lower portion arranged to abut on the positioning structure.

In the terminal connection assembly of this aspect, the lower portion of the convex abuts on the positioning structure. This configuration restricts the motion of the positioning structure in the intersecting direction.

(6) In the terminal connection assembly of the above aspect, the convex may have a side portion arranged to abut on the positioning structure.

In the terminal connection assembly of this aspect, the side portion of the convex abuts on the positioning structure. This configuration restricts the motion of the positioning structure in the intersecting direction.

(7) In the terminal connection assembly of the above aspect, the convex may be protruded upward from the supporting structure.

The terminal connection assembly of this aspect enables the convexes to effectively restrict the motion of the positioning structure in the intersecting direction.

(8) In the terminal connection assembly of the above aspect, the convex may be engaged with a positioning convex provided in the positioning structure.

In the terminal connection assembly of this aspect, the convexes are engaged with the positioning convexes provided in the positioning structure, so as to restrict the motion of the positioning structure in the intersecting direction.

(9) In the terminal connection assembly of the above aspect, some of a plurality of the convexes may be protruded in the intersecting direction to face each other.

In the terminal connection assembly of this aspect, some of the plurality of convexes are protruded in the intersecting direction to face each other. This configuration prevents the terminal connection assembly from readily coming off from the printing apparatus.

(10) In the terminal connection assembly of the above aspect, the convex may have a lower portion arranged to abut on the positioning structure.

In the terminal connection assembly of this aspect, the lower portion of the convex abuts on the positioning structure. This configuration restricts the motion of the positioning structure in the intersecting direction.

(11) In the terminal connection assembly of the above aspect, the convex may have a side portion arranged to abut on the positioning structure.

In the terminal connection assembly of this aspect, the side portion of the convex abuts on the positioning structure. This configuration restricts the motion of the positioning structure in the intersecting direction.

The invention may be implemented by any of various aspects other than the terminal connection assembly described above, for example, a cartridge, a method of manufacturing the cartridge, a printing apparatus and a method of manufacturing the printing apparatus.

### BRIEF DESCRIPTION OF DRAWINGS

FIG. 1 is a perspective view illustrating the configuration of a printing material supply system;

FIG. 2 is an appearance perspective view illustrating a cartridge mounting assembly in a mounted state;

FIG. 3 is a 2-2 sectional view taken on a line 2-2 in FIG. 2;

FIG. 4 is an enlarged view illustrating components involved in flowing ink to the cartridge mounting assembly;

FIG. 5 is a first appearance perspective view illustrating the cartridge mounting assembly;

FIG. 6 is a second appearance perspective view illustrating the cartridge mounting assembly;

FIG. 7 is a third appearance perspective view illustrating the cartridge mounting assembly;

FIG. 8 is a fourth appearance perspective view illustrating the cartridge mounting assembly;

FIG. 9 is a fifth appearance perspective view illustrating the cartridge mounting assembly;

FIG. 10 is a first appearance perspective view illustrating an apparatus-side front wall portion and peripheral components;

FIG. 11 is a second appearance perspective view illustrating the apparatus-side front wall portion and peripheral components;

FIG. 12 is an exploded perspective view illustrating the apparatus-side front wall portion and peripheral components;

FIG. 13 is a 10-10 sectional view taken on a line 10-10 in FIG. 10;

FIG. 14 is a first exploded perspective view illustrating an apparatus-side terminal assembly;

FIG. 15 is a second exploded perspective view illustrating the apparatus-side terminal assembly;

FIG. 16 is a first appearance perspective view illustrating the apparatus-side terminal assembly;

FIG. 17 is a second appearance perspective view illustrating the apparatus-side terminal assembly;

FIG. 18 is a 17-17 sectional view taken on a line 17-17 in FIG. 17;

FIG. 19 is a first appearance perspective view illustrating a cartridge;

FIG. 20 is a second appearance perspective view illustrating the cartridge;

FIG. 21 is a front view illustrating the cartridge;

FIG. 22 is a rear view illustrating the cartridge;

FIG. 23 is a top view illustrating the cartridge;

FIG. 24 is a bottom view illustrating the cartridge;

FIG. 25 is a first side view illustrating the cartridge;

FIG. 26 is a second side view illustrating the cartridge;

FIG. 27 is an appearance perspective view illustrating periphery of a recess;

FIG. 28 is a front view illustrating periphery of the recess;

FIG. 29 is a 28a-28a sectional view taken on a line 28a-28a in FIG. 28;

FIG. 30 is a 28b-28b sectional view taken on a line 28b-28b in FIG. 28;

FIG. 31 is a diagram illustrating a state of connection of the apparatus-side terminal assembly with a circuit board;

FIG. 32 is a 28a-28a sectional view in the mounted state;

FIG. 33 is a first diagram illustrating contact state;

FIG. 34 is a second diagram illustrating the contact state;

FIG. 35 is a third diagram illustrating the contact state;

FIG. 36 is a diagram illustrating the contact state;

FIG. 37 is an exploded perspective view illustrating the cartridge;

FIG. 38 is an appearance perspective view illustrating the periphery of a terminal placing structure;

FIG. 39 is a diagram illustrating the periphery of the terminal placing structure viewed from the +Z-axis direction side;

FIG. 40 is a diagram illustrating the periphery of the terminal placing structure viewed from the −X-axis direction side;

FIG. 41 is a front view illustrating the periphery of the terminal placing structure;

FIG. 42 is a sectional view along a YZ plane illustrating the state that a convex of a cartridge is engaged with a positioning concave of a printer;

FIG. 43 is a sectional view along an XY plane illustrating the state that that the convex of the cartridge is engaged with the positioning concave of the printer;

FIG. 44 is an appearance perspective view illustrating the periphery of another terminal placing structure;

FIG. 45 is an XZ sectional view illustrating a relationship between members of the cartridge and positioning convexes of an apparatus-side terminal assembly in the state that the cartridge is mounted to the printer;

FIG. 46 is an appearance perspective view illustrating the periphery of another terminal placing structure;

FIG. 47 is an appearance perspective view illustrating the state that convexes of the cartridge are engaged with concaves of the printer;

FIG. 48 is an appearance perspective view illustrating the periphery of another terminal placing structure;

FIG. 49 is a front view illustrating the periphery of the terminal placing structure;

FIG. 50 is an appearance perspective view illustrating the periphery of another terminal placing structure;

FIG. 51 is an appearance perspective view illustrating the periphery of another terminal placing structure;

FIG. 52 is an appearance perspective view illustrating another cartridge;

FIG. 53 is an enlarged view illustrating the periphery of a circuit board provided on the −Y-axis direction side of the cartridge;

FIG. 54 is a diagram illustrating the configuration of the cartridge having a storage unit separate from the circuit board;

FIG. 55 is a top view illustrating another cartridge having a circuit board integrated with a supporting structure;

FIG. 56 is a diagram illustrating another cartridge configured to contain ink outside thereof;

FIG. 57 is a diagram illustrating another cartridge configured to contain ink outside thereof;

FIG. 58 is a diagram illustrating one example of a circuit board configured to be not inclined to a mounting direction (−Y-axis direction) in the state that the circuit board is not mounted to the printer;

FIG. 59 is a diagram illustrating another example of a circuit board configured to be not inclined to a mounting direction (−Y-axis direction) in the state that the circuit board is not mounted to the printer; and

FIG. 60 is an appearance perspective view illustrating the state that convexes of FIG. 46 and convexes of FIG. 48 of the cartridge are engaged with concaves and positioning convexes of the printer.

### DESCRIPTION OF EMBODIMENTS

### A. First Embodiment

### A-1. General Configuration of Printing Material Supply System

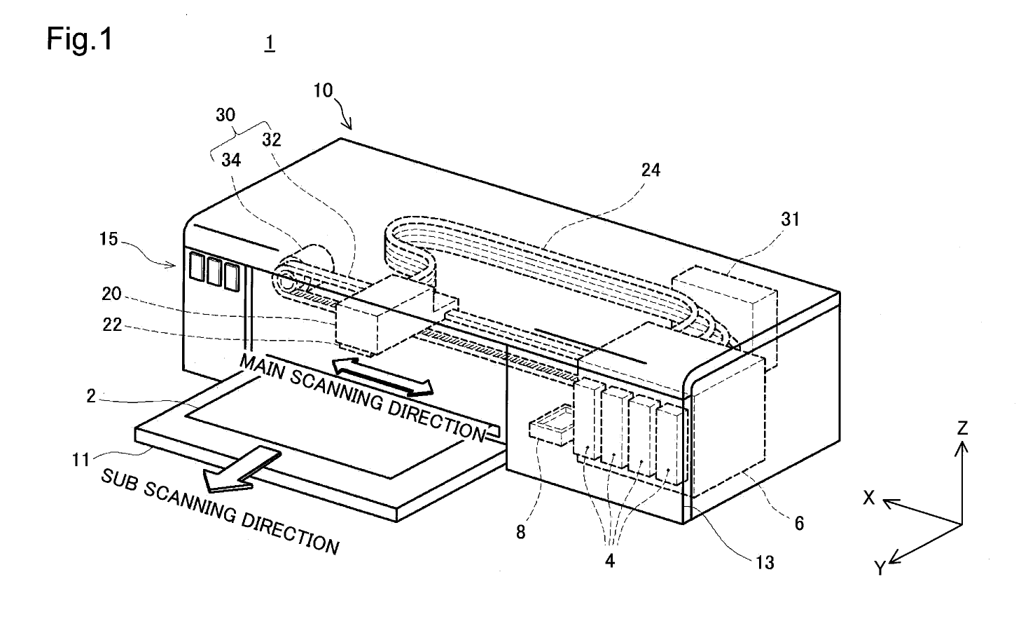

FIG. 1 is a perspective view illustrating the configuration of a printing material supply system 1. XYZ axes that are three space axes orthogonal to one another are shown in FIG. 1. The directions of arrows representing the X axis, the Y axis and the Z axis respectively indicate the positive directions along the X axis, the Y axis and the Z axis. The positive directions along the X axis, the Y axis and the Z axis are respectively expressed as +X-axis direction, +Y-axis direction and +Z-axis direction. The directions opposite to the directions of arrows representing the X axis, the Y axis and the Z axis respectively indicate the negative directions along the Y axis, the Y axis and the Z axis. The negative directions along the X axis, the Y axis and the Z axis are respectively expressed as −X-axis direction, −Y-axis direction and −Z-axis direction. The directions along the X axis, the Y axis and the X axis regardless whether positive or negative are expressed as X-axis direction, Y-axis direction and Z-axis direction. The same applies to subsequent drawings and description. The directions of the XYZ axes shown in the other drawings correspond to the directions of the XYZ axes shown in FIG. 1. The printing material supply system 1 includes a printer 10 as a printing apparatus and cartridges 4.

The printer 10 of the embodiment is an inkjet printer configured to eject ink from a head 22. This printer 10 is a large-size printer used for printing on large sheets of paper (for example, size A2 to size A0) like posters. The printer 10 includes a cartridge mounting assembly 6, a controller 31, a carriage 20, a head 22 and a driving mechanism 30. The printer 10 also includes operation buttons 15 manipulated by the user for the operations of the printer 10.

A plurality of cartridges 4 are detachably mounted to the cartridge mounting assembly 6. According to this embodiment, four different types of cartridges 4 corresponding to four color inks (black, yellow, magenta and cyan), one for each color, i.e., the total of four cartridges 4, are mounted to the cartridge mounting assembly 6. The printer 10 of the embodiment has a cover for replacement 13 provided on a front face (+Y-axis direction side surface). Pulling the +Z-axis direction side of the cover for replacement 13 forward (toward the +Y-axis direction side) makes accessible to an opening of the cartridge mounting assembly 6 to allow for mounting and demounting of the cartridge 4. Mounting the cartridge 4 to the cartridge mounting assembly 6 enables ink to be supplied to the head 22 provided on the carriage 20 via a tube 24. According to this embodiment, a pump mechanism (not shown) of the printer 10 serves to suck the ink contained in the cartridge 4 and supply the ink to the head 22. The tube 24 is provided for each type of ink. In the description below, the state that the cartridges 4 are mounted to the cartridge mounting assembly 6 is called “mounted state”.

The head 22 has nozzles provided for each type of ink. The head 22 is configured to eject ink from ejection nozzles toward a sheet of printing paper 2 and print data including characters and images. Mounting the cartridge 4 to the cartridge mounting assembly 6 and the detailed configurations of the cartridge 4 and the cartridge mounting assembly 6 will be described later. According to this embodiment, the printer 10 is an “off-carriage type” printer in which the cartridge mounting assembly 6 is not linked with the motion of the carriage 20. The invention is, however, also applicable to an “on-carriage type” printer in which the cartridge mounting assembly 6 is provided on the carriage 20 and moves along with the carriage 20.

The controller 31 is configured to control the respective parts of the printer 10 and to send and receive signals to and from the cartridges 4. The carriage 20 moves the head 22 relative to the printing paper 2.

The driving mechanism 30 reciprocates the carriage 20, in response to control signals from the controller 31. The driving mechanism 30 includes a timing belt 32 and a drive motor 34. The carriage 20 is reciprocated in a main scanning direction (X-axis direction) by transmitting the power of the drive motor 34 via the timing belt 32 to the carriage 20. The printer 10 also has a feed mechanism configured to move the printing paper 2 in a sub-scanning direction (+Y-axis direction). The printing paper 2 is moved in the sub-scanning direction by the feed mechanism during printing and is output onto a front cover 11 after completion of printing.

An area called home position is provided at a location outside of a printing area to which the carriage 20 is moved in the main scanning direction. A maintenance mechanism is mounted at the home position for maintenance to ensure normal printing. The maintenance mechanism may include, for example, a cap member 8 that is pressed against a surface provided with nozzles (hereinafter called “nozzle surface”) on the bottom side of the head 22 (i.e., on the side facing the printing paper 2) to form a closed space that surrounds the ejection nozzles, a lift mechanism (not shown) that is configured to move up and down the cap member 8 to be pressed against the nozzle surface of the head 22, and a suction pump (not shown) configured to provide a negative pressure to the closed space formed by pressing the cap member 8 against the nozzle surface of the head 22.

According to this embodiment, in the use state of the printing material supply system 1 (including the printer 10 and the cartridges 4), an axis along the sub-scanning direction in which the printing paper 2 is fed is specified as Y axis, an axis along the gravity direction (vertical direction) is specified as Z axis, and an axis along the moving direction (left-right direction) of the carriage 20 is specified as X axis. The “use state of the printing material supply system 1” herein means the state that the printing material supply system 1 is placed on a horizontal plane. According to this embodiment, the sub-scanning direction (forward direction) is specified as +Y-axis direction, and its opposite direction (rearward direction) is specified as −Y-axis direction. The direction from the bottom toward the top along the gravity direction (upward direction) is specified as +Z-axis direction, and its opposite direction (downward direction) is specified as −Z-axis direction. When the printing material supply system 1 is viewed from the front side (+Y-axis direction side), the direction from the right toward the left is specified as +X-axis direction, and its opposite direction is specified as −X-axis direction. According to this embodiment, the direction of insertion for mounting the cartridge 4 to the cartridge mounting assembly 6 is the −Y-axis direction, and the direction for demounting the cartridge 4 from the cartridge mounting assembly 6 is the +Y-axis direction. The −Y-axis direction side of the cartridge mounting assembly 6 may thus be called rear side, and the +Y-axis direction side of the cartridge mounting assembly 6 may be called front side. According to this embodiment, the direction of array of the plurality of cartridges 4 is the X-axis direction.

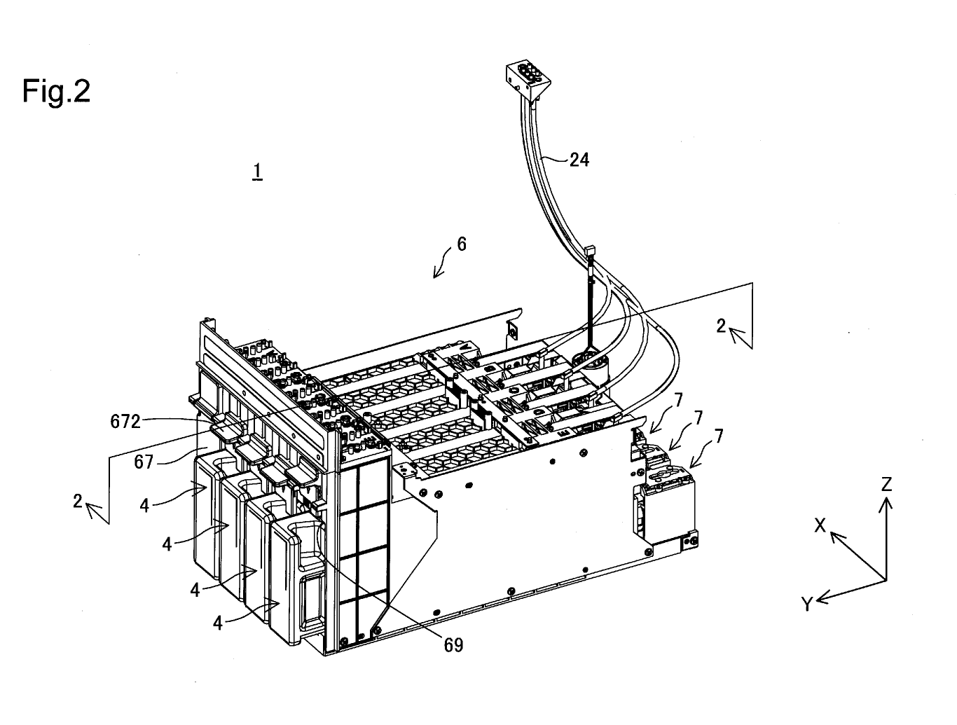

FIG. 2 is an appearance perspective view illustrating the cartridge mounting assembly 6 in the mounted state. FIG. 2 illustrates the state that the four cartridges 4 are mounted to respective slots of the cartridge mounting assembly 6. Levers 672 are pushed down in three slots other than one slot on the −X-axis direction side of the four slots. Pushing down the lever 672 after mounting the cartridge 4 to the cartridge mounting assembly 6 restricts the motion of the cartridge 4 and prevents the cartridge 4 from unintentionally coming off from the cartridge mounting assembly 6. When the cartridge 4 is to be demounted from the cartridge mounting assembly 6, the lever 672 is pulled up to release the restriction and allow for detachment of the cartridge 4. The lever 672 configured to be movable in the Z-axis direction is provided in a wall portion 67 having an insertion opening 69 through which the cartridge 4 is mounted and demounted. A pump mechanism 7 is driven to make the ink flow from the mounted cartridge 4 to the tube 24. The detailed configuration of the cartridge mounting assembly 6 will be described later.

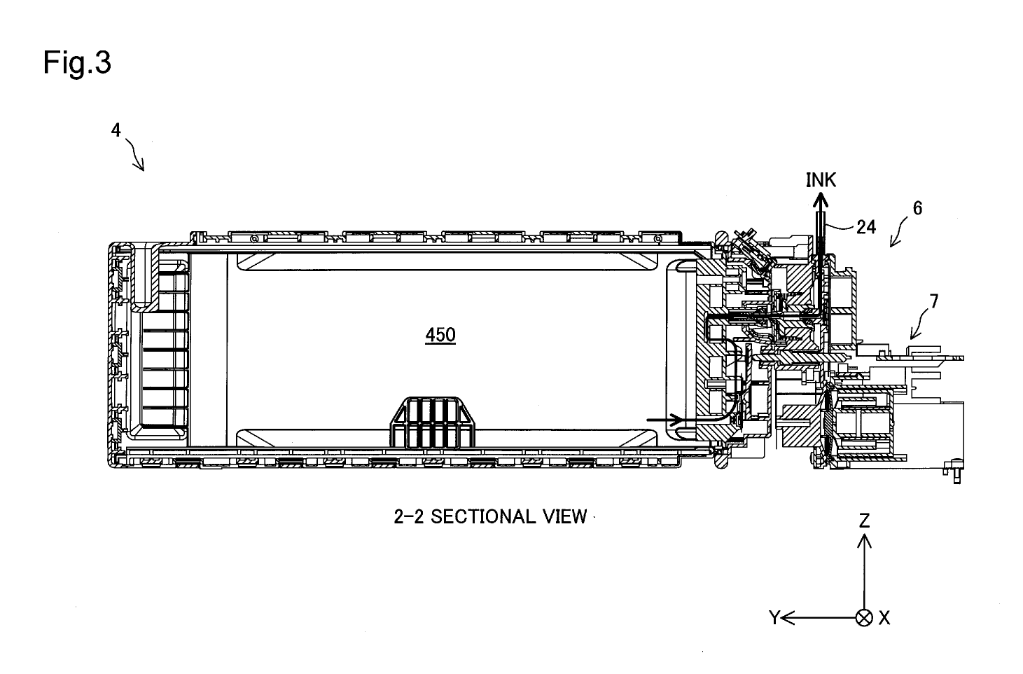

FIG. 3 is a 2-2 sectional view taken on a line 2-2 in FIG. 2. FIG. 3 illustrates the cartridge 4 and part of the cartridge mounting assembly 6. When the cartridge 4 is mounted to the cartridge mounting assembly 6, the pump mechanism 7 is driven to make the ink flow from a printing material container 450 of the cartridge 4 to the tube 24 as shown by an arrow.

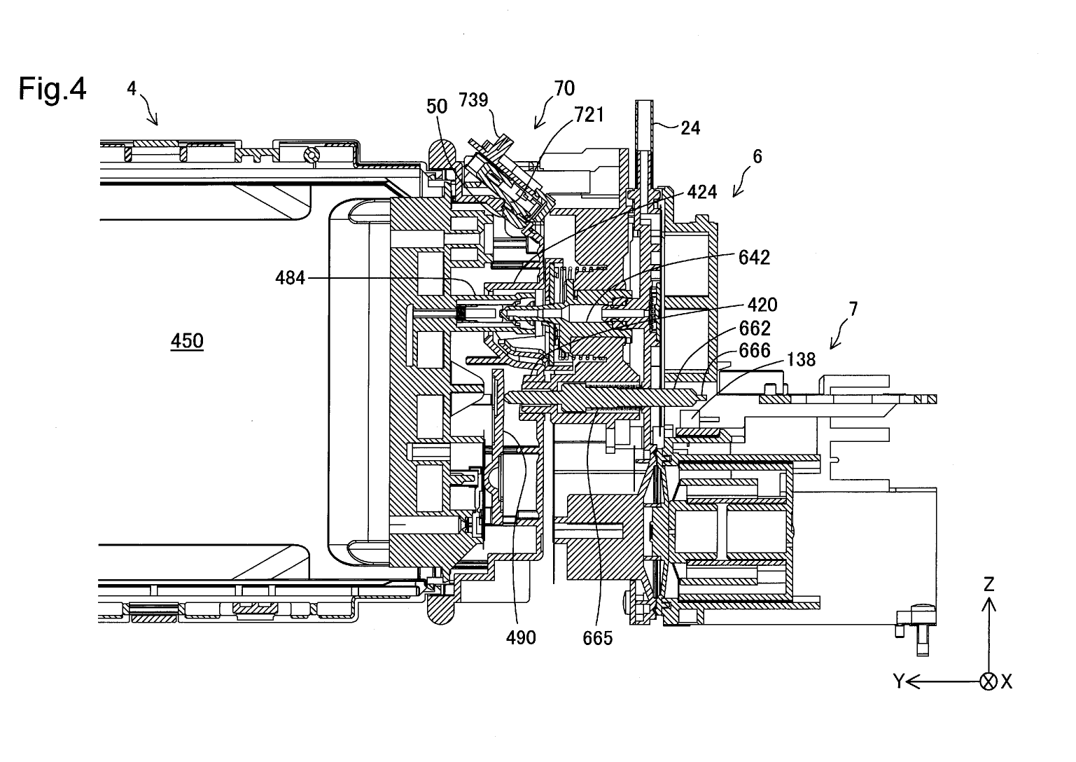

FIG. 4 is a partial enlarged view on the −Y-axis direction side of FIG. 3. In the mounted state, the respective components of the cartridge 4 and the cartridge mounting assembly 6 are arranged as described below.

A printing material supply pipe 642 of the cartridge mounting assembly 6 is inserted into and connected with a printing material outlet pipe 484 of the cartridge 4. The ink contained in the printing material container 450 is flowed through the printing material outlet pipe 484 to the outside (i.e., the printing material supply pipe 642). The ink discharged from the printing material outlet pipe 484 is flowed through the printing material supply pipe 642 to be fed toward the head 22. In the mounted state, a rod 662 of the cartridge mounting assembly 6 abuts on a lever member 490 of the cartridge 4. The rod 662 and the lever member 490 are used to allow the out-of-ink state in the printing material container 450 (also called “ink end state”) to be detected by the printer 10. More specifically, a sensor 138 detects a displacement of the rod 662, so that the printer 10 detects the ink end state. The ink end state herein denotes the state that the cartridge 4 is out of ink or has a small amount of remaining ink.

Respective terminals of a cartridge-side terminal group (not shown) provided on the surface of a circuit board 50 of the cartridge 4 come into contact with corresponding respective terminals of an apparatus-side terminal group 721 on the cartridge mounting assembly 6. The apparatus-side terminal group 721 is electrically connected with a connector 739, and wiring (not shown) connecting with the connector 739 is electrically connected with the controller 31 of the printer 10. This causes a storage unit of the circuit board 50 to be electrically connected with the controller 31 and allows signals to be transmitted between the controller 31 and the circuit board 50. The apparatus-side terminal group 721 and the connector 739 are components of an apparatus-side terminal assembly 70. The detailed configuration of the apparatus-side terminal assembly 70 will be described later.

### A-2. Detailed Configuration of Cartridge Mounting Assembly

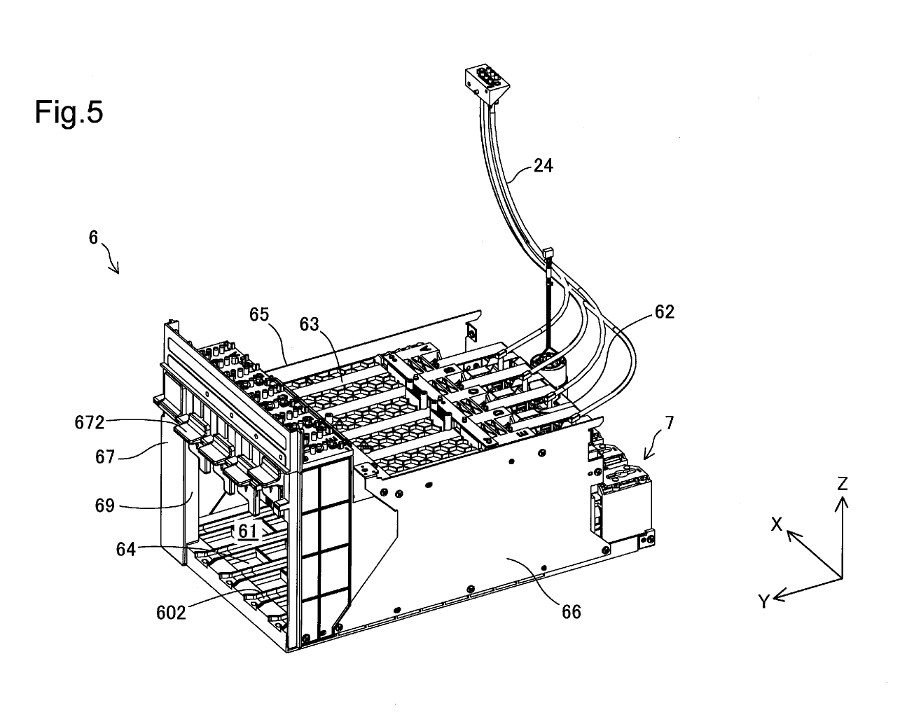

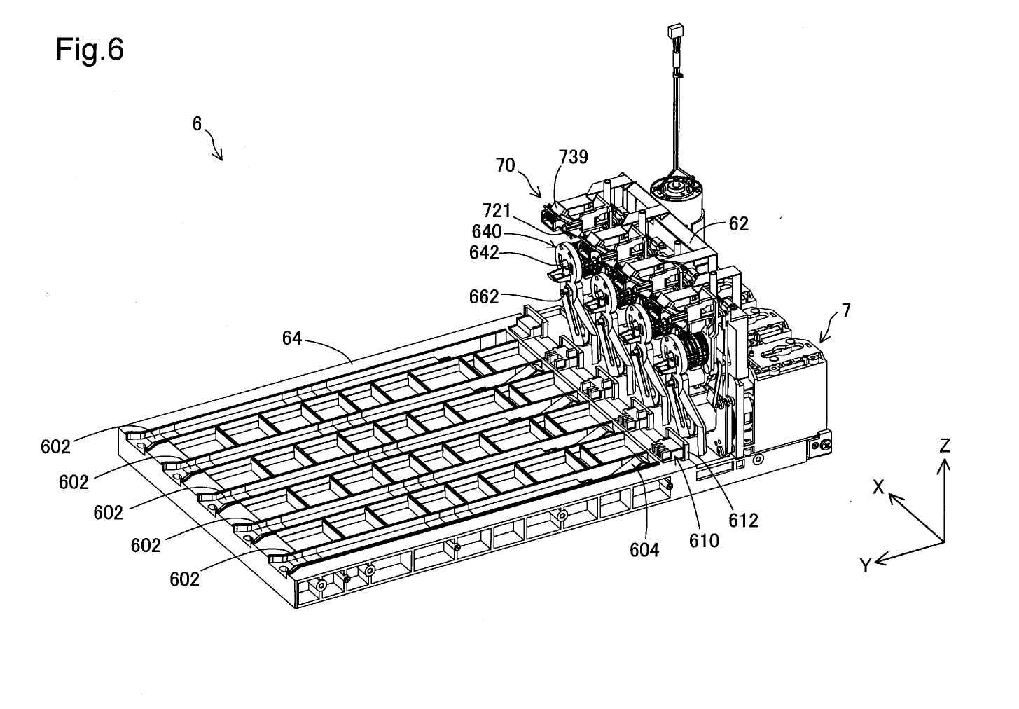

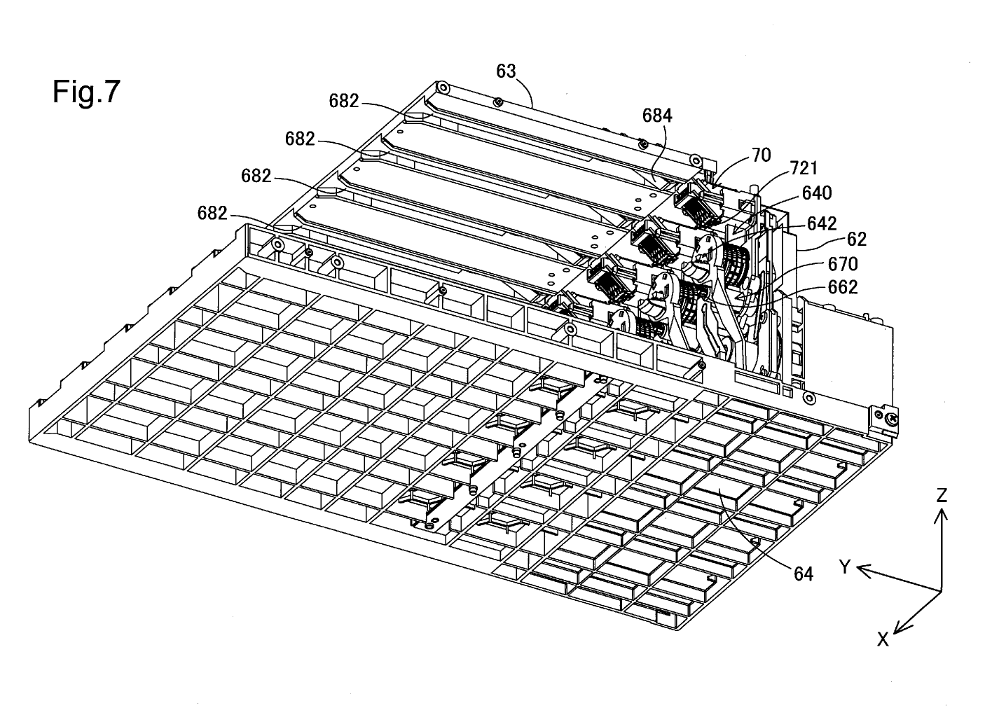

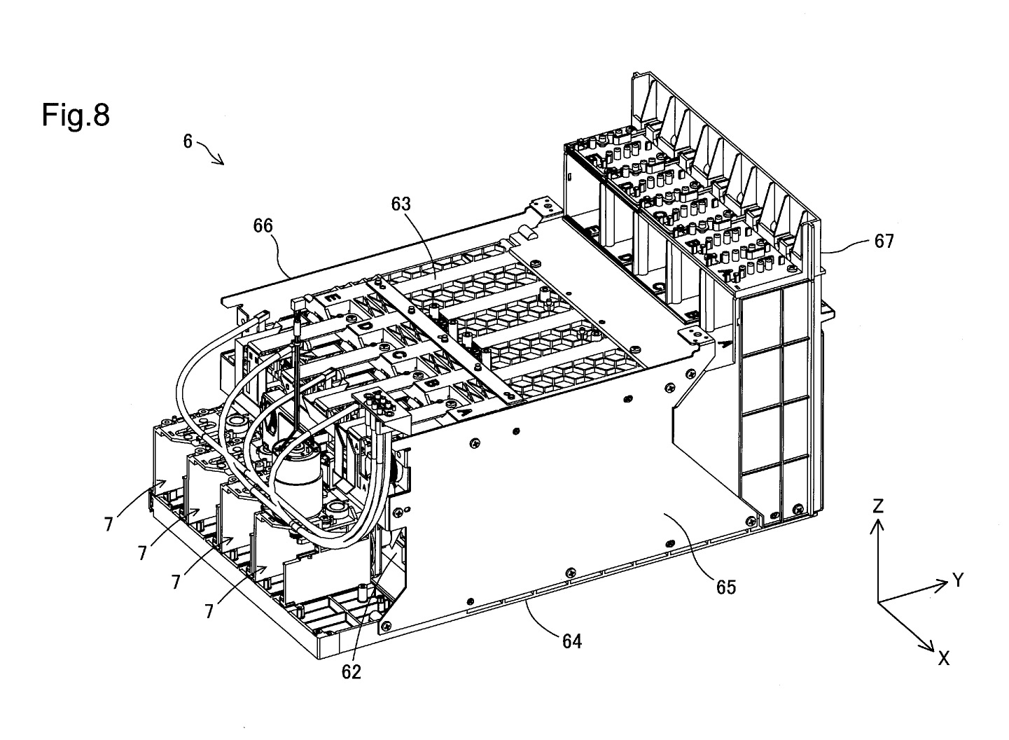

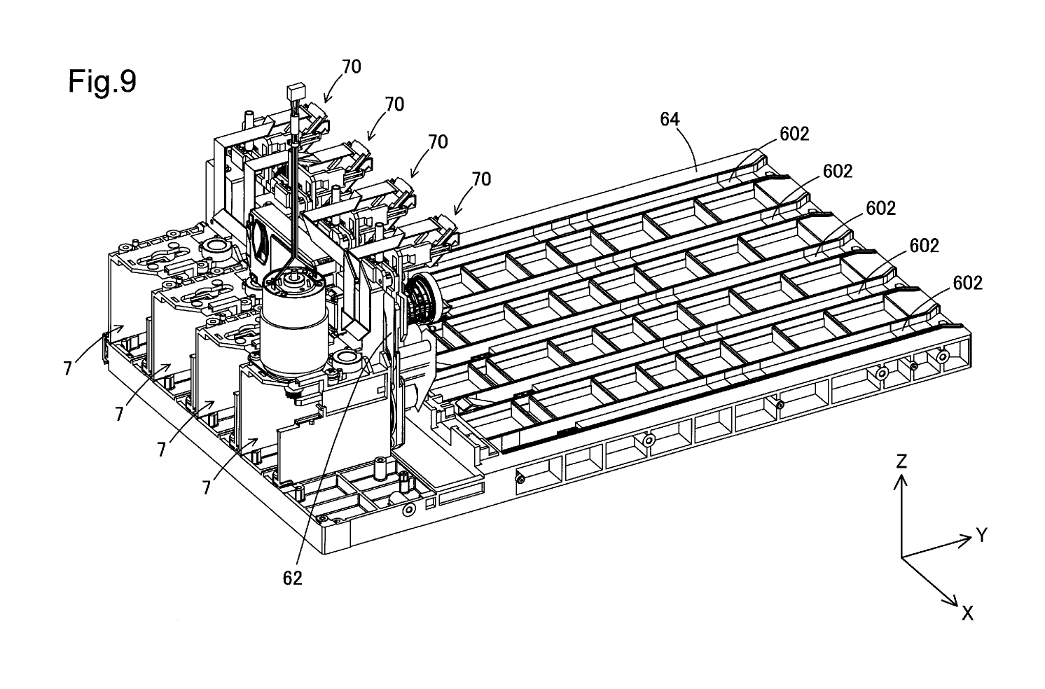

The detailed configuration of the cartridge mounting assembly 6 is described with reference to FIGS. 5 to 9. FIG. 5 is a first appearance perspective view illustrating the cartridge mounting assembly 6. FIG. 6 is a second appearance perspective view illustrating the cartridge mounting assembly 6. FIG. 7 is a third appearance perspective view illustrating the cartridge mounting assembly 6. FIG. 8 is a fourth appearance perspective view illustrating the cartridge mounting assembly 6. FIG. 9 is a fifth appearance perspective view illustrating the cartridge mounting assembly 6. The tubes 24 attached to the cartridge mounting assembly 6 are also illustrated in FIGS. 5 and 8. Part of the configuration is omitted from the illustration of FIGS. 6, 7 and 9, in order to make the internal configuration of the cartridge mounting assembly 6 visible. The cartridge mounting assembly 6 of the embodiment is configured to allow the four cartridges 4 to be independently mounted to and demounted from but is also configured to allow an increased number of cartridges 4 to be mounted to and demounted from according to the specification of the printer 10. More specifically, as shown in FIG. 6, an extra mounting space and extra members are provided on the most +X-axis direction side to allow for attachment of an additional cartridge 4.

As shown in FIG. 5, the cartridge mounting assembly 6 has the following six wall portions arranged to form a cartridge chamber 61 in which the cartridges 41 are placed. The cartridge chamber 61 is formed in an approximately rectangular parallelepiped shape. The shape of the cartridge chamber 61 corresponds to the appearance shape of the cartridge 4. Each portion of the cartridge chamber 61 to receive one of the four cartridges 4 placed therein is called slot.

The cartridge mounting assembly 6 includes an apparatus-side front wall portion 62, an apparatus-side first side wall portion 63 and an apparatus-side second side wall portion 64. The cartridge mounting assembly 6 also includes an apparatus-side third side wall portion 65, an apparatus-side fourth side wall portion 66 and an opening wall portion 67. These six wall portions 62, 63, 64, 65, 66 and 67 define and form the cartridge chamber 61. Each of the six wall portions 62, 63, 64, 65, 66 and 67 has an approximately rectangular shape.

As shown in FIGS. 5 and 6, the apparatus-side front wall portion 62 is located on the −Y-axis direction side of the cartridge chamber 61. The apparatus-side front wall portion 62 is a vertical wall portion in the use state of the printer 10.

As shown in FIG. 6, the apparatus-side front wall portion 62 is provided with the apparatus-side terminal assemblies 70, printing material supply mechanisms 640 and the rods 662. More specifically, the apparatus-side terminal assembly 70, the printing material supply mechanism 640 and the rod 662 are arranged sequentially from the +Z-axis direction side toward the −Z-axis direction side. The apparatus-side terminal assembly 70 and the printing material supply mechanism 640 are provided on a surface of the +Y-axis direction side of the apparatus-side front wall portion 62 (i.e., on the side where the cartridge chamber 61 is located). The rod 662 is provided to pass through the apparatus-side front wall portion 62 in the Y-axis direction. The pump mechanism 7 is provided on the −Y-axis direction side of the apparatus-side front wall portion 62 (i.e., on the side opposite to the cartridge chamber 61).

The printing material supply mechanism 640 includes the printing material supply pipe 642 described above and is used to cause the ink contained in the cartridge 4 to be flowed toward the printer 10. The apparatus-side terminal assembly 70 includes the apparatus-side terminal group 721 (shown in FIG. 7) and the connector 739 (shown in FIG. 6) described above and is used to electrically connect the cartridge 4 with the printer 10. As shown in FIG. 6, the apparatus-side terminal assembly 70 is provided on the apparatus-side first side wall portion 63-side (i.e., on +Z-axis direction side) of the printing material supply pipe 642. The rod 662 is used to detect the ink end state of the cartridge 4 by the printer 10. The rod 662 accordingly serves as part of a detection mechanism of the printer 10 described later. The rod 62 also serves as a positioning member to reduce a positional misalignment from the correct mounting position when the cartridge 4 is mounted on the cartridge mounting assembly 6. The detailed configuration of the apparatus-side terminal assembly 70, the printing material supply mechanism 640 and the rod 662 will be described later.

As shown in FIG. 5, the apparatus-side first side wall portion 63 is located on the +Z-axis direction side of the cartridge chamber 61. The apparatus-side first side wall portion 63 is arranged to intersect with the apparatus-side front wall portion 62. According to this embodiment, the apparatus-side first side wall portion 63 is arranged perpendicular to the apparatus-side front wall portion 62. The apparatus-side first side wall portion 63 is a horizontal wall portion in the use state of the printer 10. The apparatus-side first side wall portion 63 forms a top face of the cartridge mounting assembly 6. In the description hereof, the term “cross” or “intersect” means one of the following states: (i) the state that two elements intersect with each other and actually cross each other; (ii) the state that an extension of one element crosses the other element; and (iii) the state that respective extensions of two elements cross each other.

As shown in FIG. 7, the apparatus-side first side wall portion 63 has first rails 682, each being configured to guide the cartridge 4 to the mounting position. The first rails 682 are provided corresponding to at least the number of cartridges 4 mounted to the cartridge mounting assembly 6. According to this embodiment, a total of five first rails 682, i.e., four first rails 682 corresponding to the number of the cartridges 4 actually mounted to the cartridge mounting assembly 6 and one extra, are provided. The first rail 682 is a groove extended in the Y-axis direction to receive part of the cartridge 4 inserted therein. A leaf spring 684 is provided as a locking member on a −Y-axis direction side end of the first rail 682. In the mounted state, the leaf spring 684 locks the cartridge 4, so as to prevent the cartridge 4 from unintentionally coming off from the cartridge mounting assembly 6.

As shown in FIGS. 5, 6 and 9, the apparatus-side second side wall portion 64 is located on the −Z-axis direction side of the cartridge chamber 61. The apparatus-side second side wall portion 64 is arranged to face the apparatus-side first side wall portion 63 across the cartridge chamber 61. The apparatus-side second side wall portion 64 is arranged to intersect with the apparatus-side front wall portion 62. According to this embodiment, the apparatus-side second side wall portion 64 is arranged perpendicular to the apparatus-side front wall portion 62. The apparatus-side second side wall portion 64 is a horizontal wall portion in the use state of the printer 10. The apparatus-side second side-wall portion 64 forms a bottom face of the cartridge mounting assembly 6.

As shown in FIG. 6, the apparatus-side second side wall portion 64 has second rails 602, each being configured to guide the cartridge 4 to the mounting position. The second rails 602 are provided corresponding to at least the number of cartridges 4 mounted to the cartridge mounting assembly 6. According to this embodiment, five second rails 602 are provided, like the first rails 682. The second rail 602 is a groove extended in the Y-axis direction to receive part of the cartridge 4 inserted therein. A leaf spring 604 is provided as a locking member on a −Y-axis direction side end of the second rail 602. In the mounted state, the leaf spring 604 locks the cartridge 4, so as to prevent the cartridge 4 from unintentionally coming off from the cartridge mounting assembly 6. The first rail 682 and the second rail 602 provided corresponding to the same cartridge 4 are arranged to face each other across the cartridge chamber 61.

The first rail 682 and the second rail 602 have different dimensions in the X-axis direction. More specifically, the first rail 682 has the smaller dimension in the X-axis direction than the second rail 602. This configuration prevents the cartridge 4 from being wrongly inserted into the first rail 682 and the second rail 602 when the cartridge 4 is turned upside down in the Z-axis direction to be inserted into the cartridge mounting assembly 6. This reduces the likelihood that the cartridge 4 is inserted into the cartridge mounting assembly 6 in the wrong attitude of the reversed direction in the Z-axis direction.

As shown in FIG. 6, the apparatus-side second side wall portion 64 is also provided with apparatus-side identification members 610 at a location near to the apparatus-side front wall portion 62. The apparatus-side identification members 610 are provided corresponding to the number of cartridges 4 mounted to the cartridge mounting assembly 6. According to this embodiment, four apparatus-side identification members 610 are provided. The apparatus-side identification member 610 is used to identify whether the correct type (correct ink color according to this embodiment) of the cartridge 4 is mounted in each slot of the cartridge chamber 61. Each of the apparatus-side identification members 610 is formed in a different shape according to the color of ink contained in the cartridge 4 mounted in the slot. More specifically, each of the apparatus-side identification members 610 is formed by at least one rib. The pattern defined by the number and the positions of ribs differs according to the type of the cartridge 4. The cartridge 4 is also provided an identification member formed by ribs (also called “cartridge-side identification member”). The identification member of the cartridge 4 is also formed in a different shape according to the color of ink contained in the cartridge 4. When the correct type of cartridge 4 is inserted into the slot, the apparatus-side identification member 610 and the cartridge-side identification member fit each other. When a wrong type of the cartridge 4 is inserted into the slot, on the other hand, the apparatus-side identification member 610 and the cartridge-side identification member do not fit each other. This configuration reduces the likelihood that the wrong type of cartridge 4 is mounted in each slot of the cartridge mounting assembly 6.

As shown in FIG. 6, the apparatus-side second side wall portion 64 is further provided with restriction members 612 at a location near to the apparatus-side front wall portion 62. The restriction members 612 are provided corresponding to at least the number of cartridges 4 mounted to the cartridge mounting assembly 6. According to this embodiment, five restriction members 612 are provided, but only four restriction members 612 are actually used. The cartridge 4 abuts on the restriction member 612 when the cartridge 4 is inserted in the cartridge chamber 61 of the cartridge mounting assembly 6 from the insertion opening 69 (shown in FIG. 5) on the +Y-axis direction side toward the apparatus-side front wall portion 62 on the −Y-axis direction side and reaches the correct mounting position. This configuration reduces the likelihood that the cartridge 4 is further pressed in from the correct mounting position.

As shown in FIG. 5, the opening wall portion 67 is located on the +Y-axis direction side of the cartridge chamber 61. The opening wall portion 67 has the insertion opening 69 through which the cartridge 4 is mounted and demounted. The opening wall portion 67 is arranged to face the apparatus-side front wall portion 62 across the cartridge chamber 61. The opening wall portion 67 is arranged to intersect with the apparatus-side first side wall portion 63 and the apparatus-side second side wall portion 64. According to this embodiment, the opening wall portion 67 is arranged perpendicular to the apparatus-side first side wall portion 63 and the apparatus-side second side wall portion 64. The opening wall portion 67 is a vertical wall portion in the use state of the printer 10.

The lever 672 configured to be movable in the Z-axis direction is provided on the opening wall portion 67. The lever 672 is moved in the −Z-axis direction after the cartridge 4 is mounted to the cartridge mounting assembly 6. The lever 672 is then caught on the cartridge 4 and prevents the cartridge 4 from being mistakenly detached. The state that the lever 672 is caught on the cartridge 4 is the state of the three levers 672 corresponding to the three cartridges 4 on the +X-axis direction side shown in FIG. 2.

As shown in FIGS. 5 and 8, the apparatus-side third side wall portion 65 is located on the +X-axis direction side of the cartridge chamber 61. The apparatus-side third side wall portion 65 is arranged to intersect with the apparatus-side front wall portion 62, the apparatus-side first side wall portion 63, the apparatus-side second side wall portion 64 and the opening wall portion 67. According to this embodiment, the apparatus-side third side wall portion 65 is arranged perpendicular to the apparatus-side front wall portion 62, the apparatus-side first side wall portion 63, the apparatus-side second side wall portion 64 and the opening wall portion 67. The apparatus-side third side wall portion 65 is a vertical wall portion in the use state of the printer 10. The apparatus-side third side wall portion 65 forms a side face of the cartridge mounting assembly 6.

As shown in FIG. 5, the apparatus-side fourth side wall portion 66 is located on the −X-axis direction side of the cartridge chamber 61. The apparatus-side fourth side wall portion 66 is arranged to face the apparatus-side third side wall portion 65 across the cartridge chamber 61. The apparatus-side fourth side wall portion 66 is arranged to intersect with the apparatus-side front wall portion 62, the apparatus-side first side wall portion 63, the apparatus-side second side wall portion 64 and the opening wall portion 67. According to this embodiment, the apparatus-side fourth side wall portion 66 is arranged perpendicular to the apparatus-side front wall portion 62, the apparatus-side first side wall portion 63, the apparatus-side second side wall portion 64 and the opening wall portion 67. The apparatus-side fourth side wall portion 66 is a vertical wall portion in the use state of the printer 10. The apparatus-side fourth side wall portion 66 forms a side face of the cartridge mounting assembly 6.

The arrangement of the respective wall portions 62, 63, 64, 65, 66 and 67 defines the following relationship. The direction in which the apparatus-side front wall portion 62 faces the opening wall portion 67 or the insertion opening 69 is the Y-axis direction. The direction from the opening wall portion 67 or the insertion opening 69 toward the apparatus-side front wall portion 62, i.e., the direction of inserting (mounting) the cartridge 4 into the cartridge mounting assembly 6, is the −Y-axis direction. The opposite direction, i.e., the direction of pulling out (demounting) the cartridge 4 from the cartridge mounting assembly 6, is the +Y-axis direction. The direction in which the apparatus-side first side wall portion 63 faces the apparatus-side second side wall portion 64 is the Z-axis direction. The direction from the apparatus-side first side wall portion 63 toward the apparatus-side second side wall portion 64 is the −Z-axis direction, and the opposite direction is the +Z-axis direction. The direction in which the apparatus-side third side wall portion 65 faces the apparatus-side fourth side wall portion 66 is the X-axis direction. The direction from the apparatus-side third side wall portion 65 toward the apparatus-side fourth side wall portion 66 is the −X-axis direction, and the opposite direction is the +X-axis direction.

### A-3. Detailed Configuration of Respective Components of Cartridge Mounting Assembly

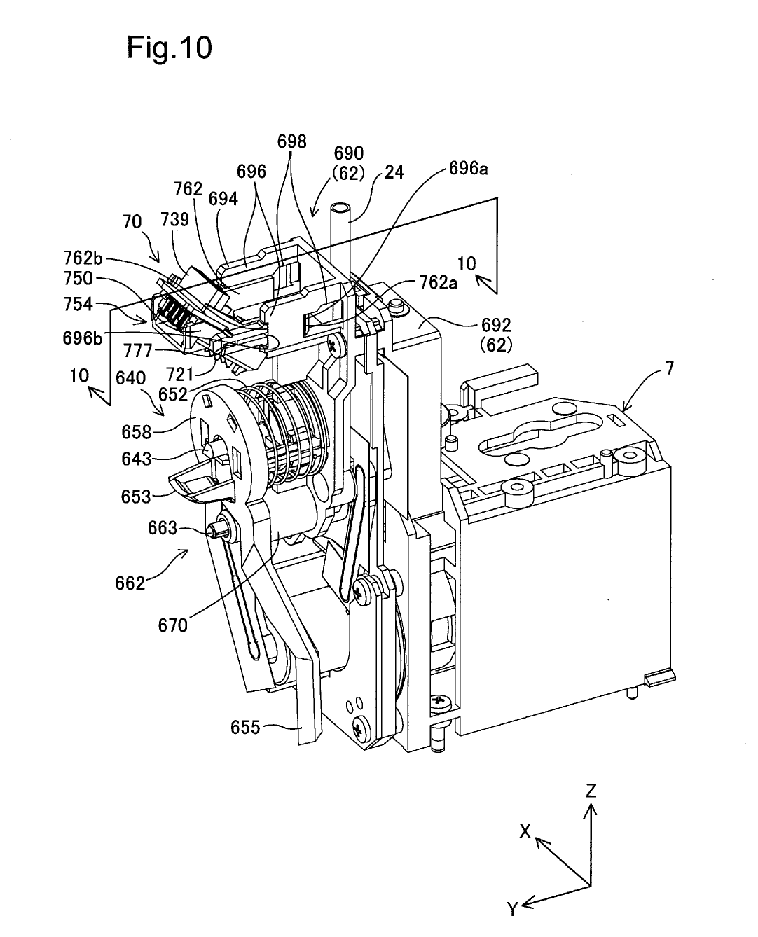

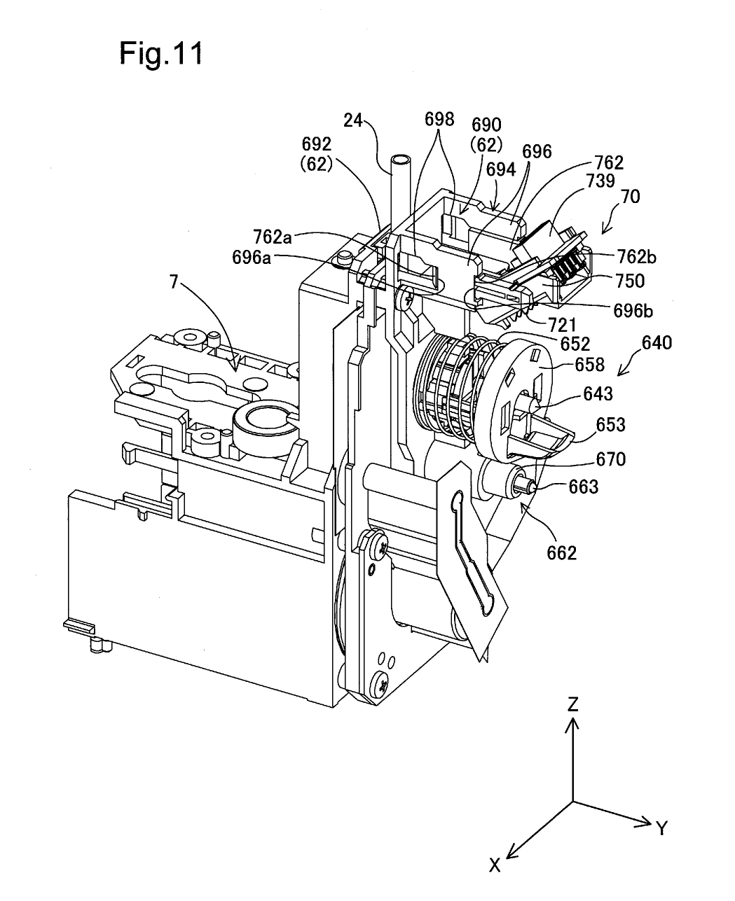

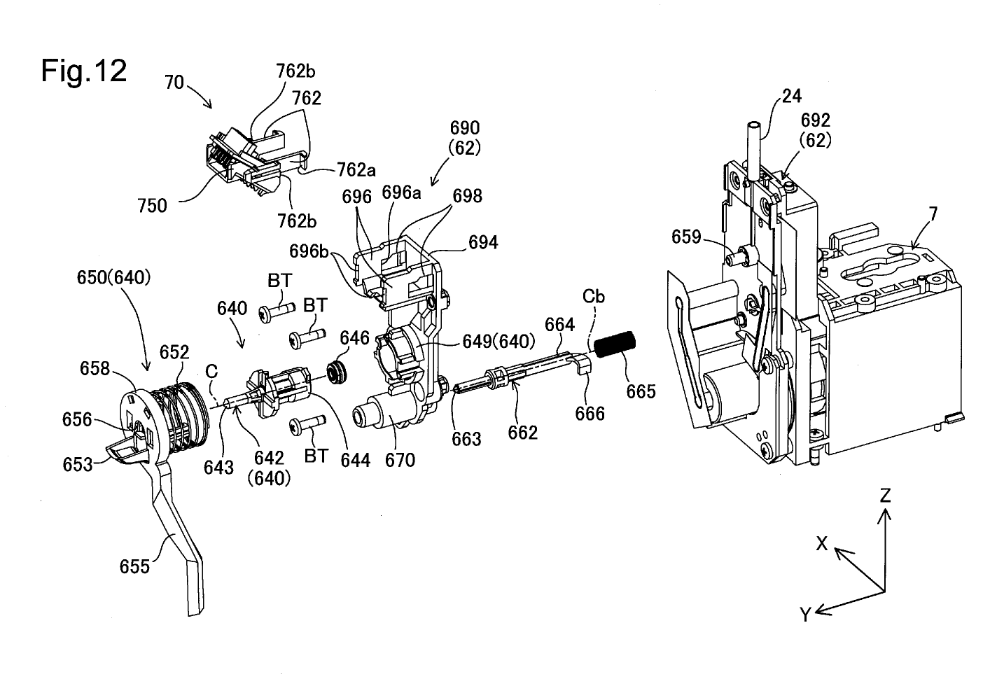

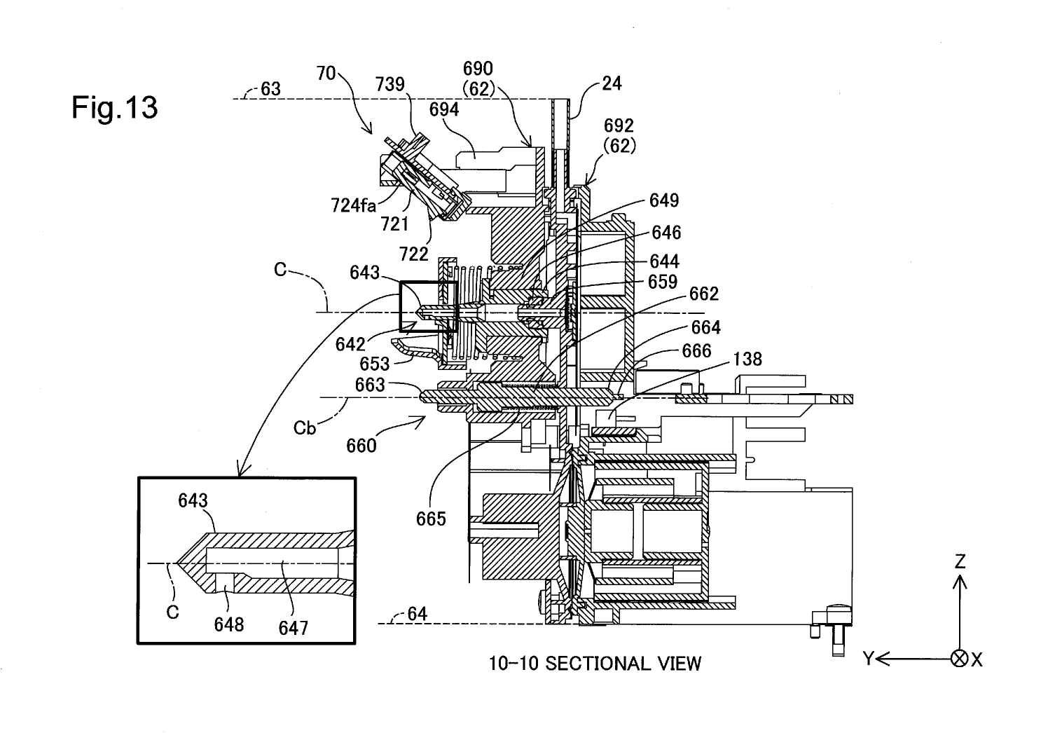

The detailed configuration of the components 70, 640 and 662 provided on the apparatus-side front wall portion 62 is described below with reference to FIGS. 10 to 13. FIG. 10 is a first appearance perspective view illustrating the apparatus-side front wall portion 62 and peripheral components. FIG. 11 is a second appearance perspective view illustrating the apparatus-side front wall portion 62 and peripheral components. FIG. 12 is an exploded perspective view illustrating the apparatus-side front wall portion 62 and peripheral components. FIG. 13 is a 10-10 sectional view taken on a line 10-10 in FIG. 10.

As shown in FIGS. 10 and 11, the apparatus-side terminal assembly 70, the printing material supply mechanism 640 and the rod 662 are provided for each slot of the cartridge mounting assembly 6 and are arranged on the apparatus-side front wall portion 62 in this sequence from the +Z-axis direction side toward the −Z-axis direction side. As shown in FIG. 12, the apparatus-side front wall portion 62 includes a first front wall portion 690 and a second front wall portion 692. The first front wall portion 690 is attached to the second front wall portion 692 by means of bolts BT.

A-3-1. Detailed Configuration of Printing Material Supply Mechanism 640

As shown in FIG. 12, the printing material supply mechanism 640 includes a cover member 650, the printing material supply pipe 642, a seal member 646 and an attachment member 649.

The printing material supply pipe 642 is connected with a flow pipe 659 provided on the second front wall portion 692. More specifically, the printing material supply pipe 642 is inserted into the attachment member 649 in a tubular shape and is connected with the flow pipe 659 that is also inserted into the attachment member 649. The flow pipe 659 communicates with the tube 24.

As shown in FIG. 13, the printing material supply pipe 642 includes a supply flow path 647 of a circular passage section formed inside thereof. A communication hole 648 is formed on the +Y-axis direction side of the circumference of the printing material supply pipe 642 to make the supply flow path 647 communicate with the outside. The ink contained in the cartridge 4 flows through the communication hole 648, the supply flow path 647 and an inner flow path of the flow pipe 659 to the tube 24.

The seal member 646 is placed between the outer circumference of the flow pipe 659 and the inner circumference of the printing material supply pipe 642. The seal member 646 is an elastic member (for example, rubber) and serves to prevent leakage of ink to the outside. According to this embodiment, the attachment member 649 is part of the first front wall portion 690.

The printing material supply pipe 642 has a center axis C. As shown in FIGS. 12 and 13, the printing material supply pipe 642 includes a base end 644 fixed to the apparatus-side front wall portion 62 and a leading end 643 connected with the cartridge 4. The center axis C is parallel to the Y axis. With regard to the direction along the Y axis (Y-axis direction), the direction from the base end 644 toward the leading end 643 is the +Y-axis direction, and the opposite direction to the +Y-axis direction is the −Y-axis direction.

As shown in FIG. 12, the cover member 650 is a member configured to reduce the likelihood that ink splatters from the printing material supply pipe 642 (or more specifically, from the communication hole 648) to the outside during mounting or demounting the cartridge 4. The cover member 650 includes a biasing member 652, an abutting member 658, an anti-splatter structure 653 and a communication structure 655. The abutting member 658 has an approximately circular shape. The abutting member 658 abuts on the cartridge 4. The abutting member 658 is configured to be movable in the Y-axis direction. A through hole 656 is formed at the center of the abutting member 658 to receive the printing material supply pipe 642 inserted therein. The anti-splatter structure 653 receives ink when any ink is leaked from the printing material supply pipe 642. This configuration reduces the likelihood that ink splatters around the printing material supply pipe 642. The anti-splatter structure 653 is formed in a concave shape. The biasing member 652 is a coil spring. The biasing member 652 has one end that abuts on the abutting member 658 and the other end that abuts on the first front wall portion 690. In the mounted state, the biasing member 652 biases the abutting member 658 to be pressed against the cartridge 4. In the course of mounting the cartridge 4 to the cartridge mounting assembly 6, the cartridge 4 presses the abutting member 658 in the −Y-axis direction, so that the anti-splatter structure 653 also moves in the −Y-axis direction. The anti-splatter structure 653 is located on the −Z-axis direction side of (located immediately below) the printing material supply pipe 642, irrespective of a displacement from the state prior to mounting the cartridge 4 to the mounted state. More specifically, the anti-splatter structure 653 is located on the −Z-axis direction side of (located immediately below) the communication hole 648 of the printing material supply pipe 642, irrespective of a displacement from the state prior to mounting the cartridge 4 to the mounted state. The ink received by the anti-splatter structure 653 flows in the communication structure 655 and reaches an absorber (not shown) provided in the cartridge mounting assembly 6.

A-3-2. Detailed Configuration of Rod 662

As shown in FIGS. 12 and 13, the rod 662 has a center axis Cb that is parallel to the Y-axis direction. A biasing member 665 and a rod cover 670 are provided on the outer circumference of the rod 662. The rod cover 670 is in a tubular shape, and the rod 662 and the biasing member 665 are placed in the rod cover 670. The rod cover 670 is part of the first wall portion 690. The rod 662 is configured to be movable in the Y-axis direction. The rod 662 has one end portion 663 located on the +Y-axis direction side and the other end portion 664 located on the −Y-axis direction side. As shown in FIGS. 10 and 11, the one end portion 663 is protruded from the rod cover 670 in the +Y-axis direction. In the mounted state, the one end portion 663 abuts on the lever member 490 of the cartridge 4 (shown in FIG. 4). The other end portion 664 is located on the −Y-axis direction side of the apparatus-side front wall portion 62. The other end portion 664 has a light shield 666. A sensor 138 is provided on the −Y-axis direction side of the apparatus-side front wall portion 62 to detect a displacement of the light shield 666, so that the controller 31 of the printer 10 detects the ink end state. The biasing member 665 is a coil spring. The biasing member 665 biases the rod 662 in the +Y-axis direction. A method of detecting the ink end state using the rod 662 will be described later.

The rod 662 is provided on the apparatus-side front wall portion 62 at an intermediate position between the apparatus-side first side wall portion 63 and the apparatus-side second side wall portion 64. More specifically, the rod 662 is provided at an intermediate position of a line segment connecting the inner surface of the apparatus-side first side wall portion 63 with the inner surface of the apparatus-side second side wall portion 64 in the Z-axis direction. In other words, the center axis Cb of the rod 662 is located at an intermediate position in the Z-axis direction between the apparatus-side first side wall portion 63 and the apparatus-side second side wall portion 64, as shown in FIG. 13. The “intermediate position” herein is not necessarily limited to the exact middle position but may be any position that is not significantly near to one of the apparatus-side first side wall portion 63 and the apparatus-side second side wall portion 64. For example, the “intermediate position” may include the position in a range within 10% from the center position with respect to the distance in the Z-axis direction between the inner wall surfaces of the apparatus-side first side wall portion 63 and the apparatus-side second side wall portion 64.

A-3-3. Detailed Configuration of Apparatus-Side Terminal Assembly 70

As shown in FIGS. 10 and 11, the apparatus-side terminal assembly 70 is provided in a terminal mounting structure 694. More specifically, as shown in FIG. 12, a pair of terminal-side fitting elements 762 of the apparatus-side terminal assembly 70 are fit in the terminal mounting structure 694, so that the apparatus-side terminal assembly 70 is mounted to the terminal mounting structure 694. The apparatus-side terminal assembly 70 is mounted to be movable in the X-axis direction and in the Z-axis direction relative to the apparatus-side front wall portion 62 (or more specifically, the terminal mounting structure 694). More specifically, the apparatus-side terminal assembly 70 is mounted to be slightly movable in the X-axis direction and in the Z-axis direction relative to the apparatus-side front wall portion 62.

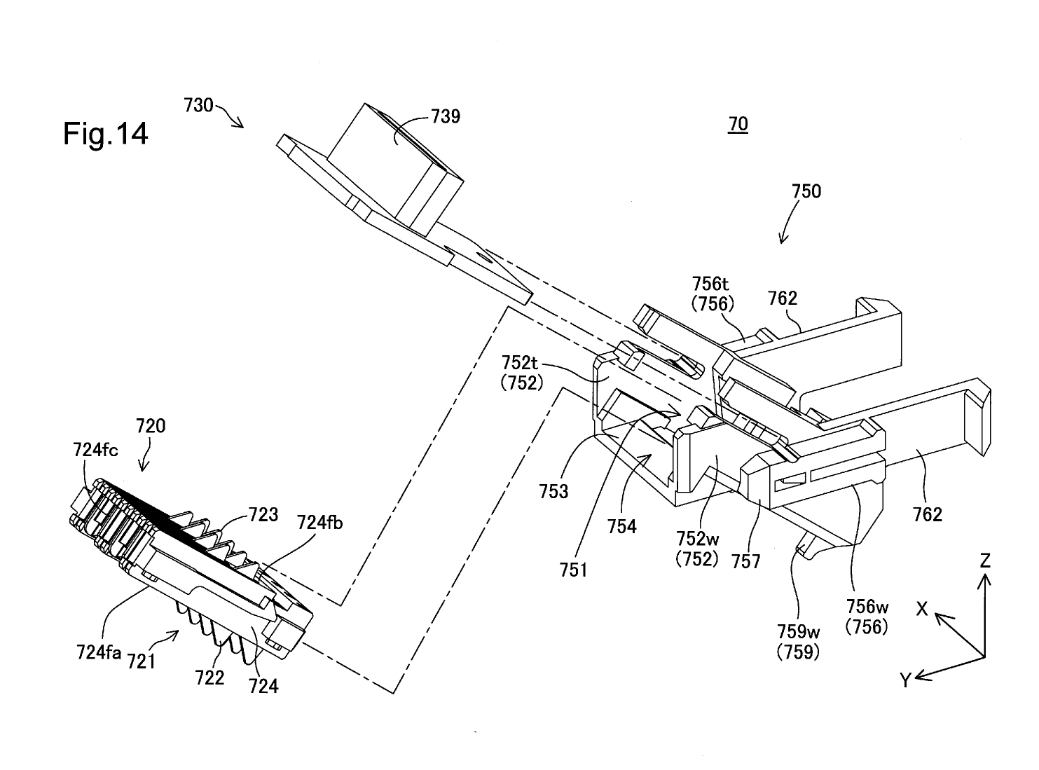

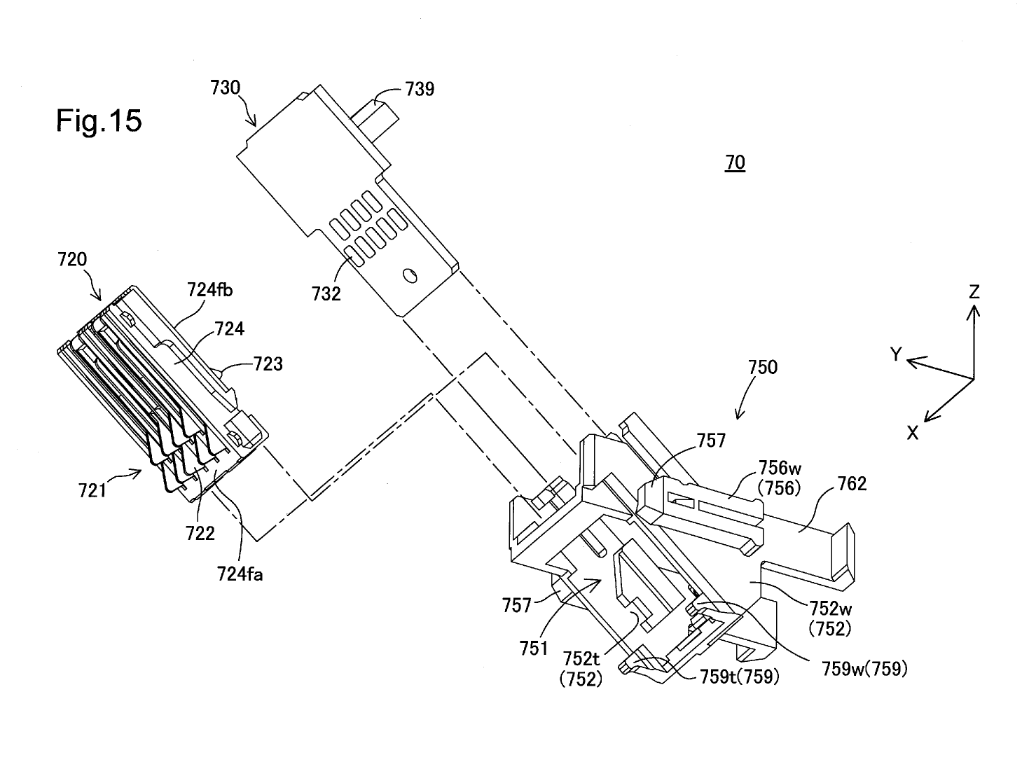

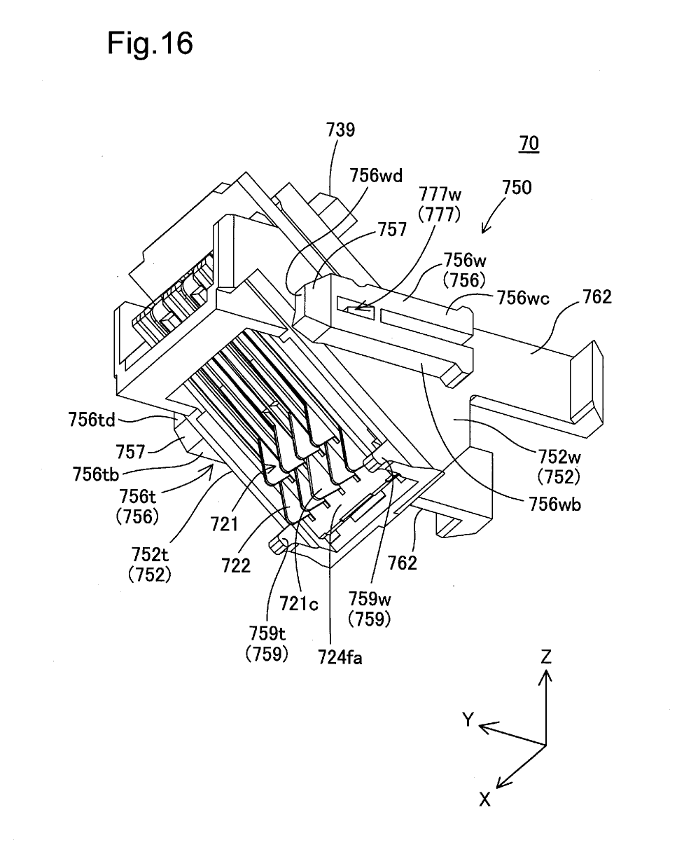

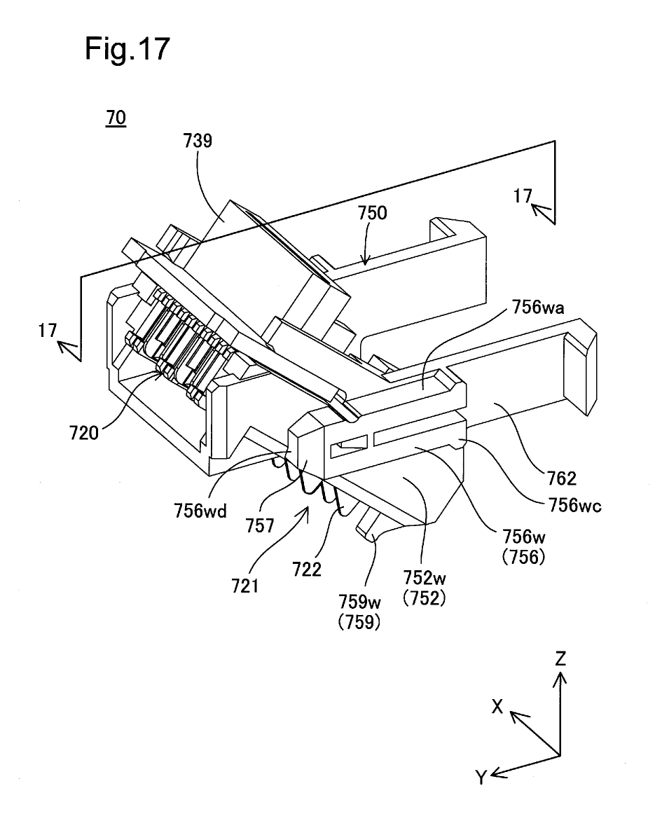

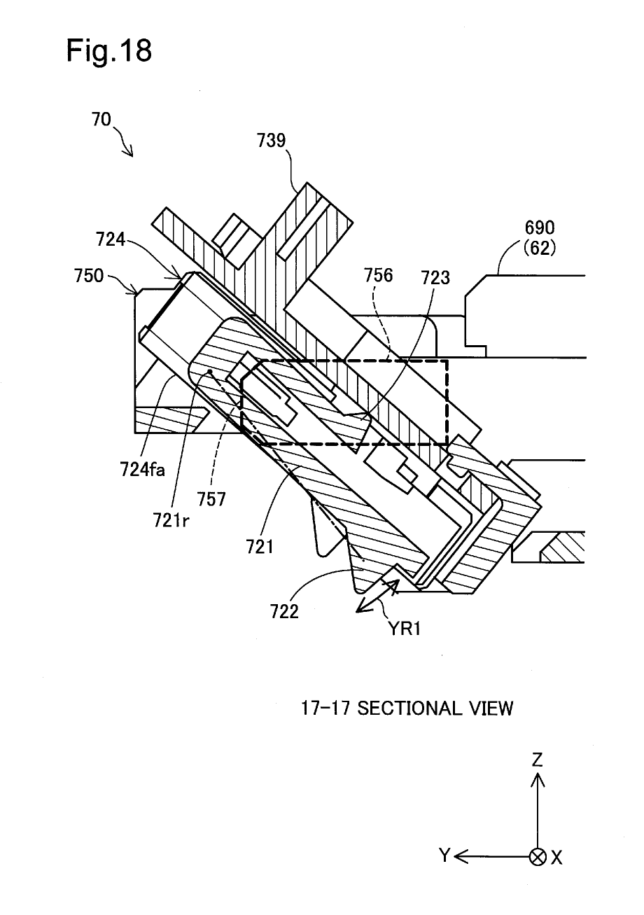

The apparatus-side terminal assembly 70 is described more in detail with reference to FIGS. 14 to 18. FIG. 14 is a first exploded perspective view illustrating the apparatus-side terminal assembly 70. FIG. 15 is a second exploded perspective view illustrating the apparatus-side terminal assembly 70. FIG. 16 is a first appearance perspective view illustrating the apparatus-side terminal assembly 70. FIG. 17 is a second appearance perspective view illustrating the apparatus-side terminal assembly 70. FIG. 18 is a 17-17 sectional view taken on a line 17-17 in FIG. 17. For the purpose of better understanding, part of the first front wall portion 690 is shown by the solid line, and a positioning convex 756 is shown by the dotted line in FIG. 18.

As shown in FIGS. 14 and 15, the apparatus-side terminal assembly 70 includes an apparatus-side terminal group 721, a terminal base 724 and a positioning structure 750. The apparatus-side terminal assembly 70 also includes a connector substrate 730. The connector substrate 730 includes a terminal group 732 provided on its surface (shown in FIG. 15) and a connector 739 provided on its rear face. The terminal group 732 includes a plurality of terminals (nine terminals according to this embodiment) and is electrically connected with the connector 739.

The apparatus-side terminal group 721 includes a plurality of terminals (nine terminals according to this embodiment). Each terminal of the apparatus-side terminal group 721 is configured to be elastically deformable. Each terminal of the apparatus-side terminal group 721 is configured by a U-shaped leaf spring. One ends of the respective terminals are exposed on a surface 724fa of the terminal base 724. The one ends of the respective terminals exposed on the surface 724fa of the terminal base 724 form terminal contacts 722 that are in contact with the corresponding cartridge-side terminals on the circuit board 50 of the cartridge 4 in the mounted state. In other words, the terminal contacts 722 are provided on the surface 724fa of the terminal base 724. The other ends of the respective terminals are exposed on a rear face 724th of the terminal base 724. The other ends of the respective terminals exposed on the rear face 724th of the terminal base 724 form terminal contacts 723 that are in contact with the corresponding terminals of the terminal group 732. In other words, the terminal contacts 723 are provided on the rear face 724th of the terminal base 724.

The terminal base 724 is configured to hold the apparatus-side terminal group 721. More specifically, the terminal base 724 is configured to hold the apparatus-side terminal group 721, such that the respective one ends of the terminals of the apparatus-side terminal group 721 forming the terminal contacts 722 are exposed on the surface 724fa. The terminal base 724 is also configured to hold the apparatus-side terminal group 721, such that the respective other ends of the terminals of the apparatus-side terminal group 721 forming the terminal contacts 723 are exposed on the rear face 724th. As shown in FIG. 18, the terminal base 724 is configured to hold the apparatus-side terminal group 721, such that each terminal of the apparatus-side terminal group 721 is moved about an axis 721r parallel to the X-axis direction by elastic deformation. In other words, the terminal base 724 is configured to hold the apparatus-side terminal group 721, such that each terminal of the apparatus-side terminal group 721 is elastically deformed along a predetermined plane to move the terminal contact 722.

As shown in FIGS. 14 to 18, the positioning structure 750 is configured to hold the terminal base 724 and the connector substrate 730. More specifically, the positioning structure 750 has a space 751. The terminal base 724 and the connector substrate 730 are placed in the space 751, so as to be held by the positioning structure 750. As shown in FIG. 18, the positioning structure 750 is configured to hold the terminal base 724 in a state that the surface 724fa of the terminal base 724 is inclined in a direction including a +Y-axis direction component and a −Z-axis direction component and is kept parallel to the X axis (hereinafter referred to as “first state”). In other words, the positioning structure 750 is configured to hold the terminal base 724, such that the surface 724fa of the terminal base 724 is inclined to the Y axis and the Z axis. Holding the terminal base 724 in this state by the positioning structure 750 causes the terminal contacts 722 of the apparatus-side terminal group 721 to be provided on the surface 724fa that is inclined in the direction including the +Y-axis direction component and the −Z-axis direction component. The positioning structure 750 is also configured to hold the terminal base 724 in a state that the axis 721r is located on the +Y-axis direction side and on the +Z-axis direction side of the terminal contacts 722 (hereinafter referred to as “second state”). When the positioning structure 750 holds the terminal base 724 to satisfy the first state and the second state, the terminal contacts 722 are elastically deformable in a direction of an arrow YR1 as shown in FIG. 18. The following describes elastic deformation of the apparatus-side terminal group 721 from another point of view. The positioning structure 750 is configured to hold the terminal base 724 in a state that the predetermined plane along which the respective terminals of the apparatus-side terminal group 721 are elastically deformed is a plane parallel to the Y axis and the Z axis (called “YZ plane”). Holding the terminal base 724 in this state by the positioning structure 750 causes the respective terminal contacts 722 to be movable on the YZ plane.

As shown in FIGS. 14 and 15, the positioning structure 750 includes a pair of wall portions 752 located on the respective sides in the X-axis direction of the space 751, and a pair of positioning convexes 756 provided on the wall portions 752. In the pair of wall portions 752, one wall portion located on the +X-axis direction side of the space 751 is called first wall portion 752t, and the other wall portion located on the −X-axis direction side of the space 751 is called second wall portion 752w. In the pair of positioning convexes 756, one positioning convex provided on the first wall portion 752t is called first positioning convex 756t, and the other positioning convex provided on the second wall portion 752w is called second positioning convex 756w. When there is no need to distinguish between the first wall portion 752t and the second wall portion 752w, these are collectively called wall portions 752. When there is no need to distinguish between the first positioning convex 756t and the second positioning convex 756w, these are collectively called positioning convexes 756.

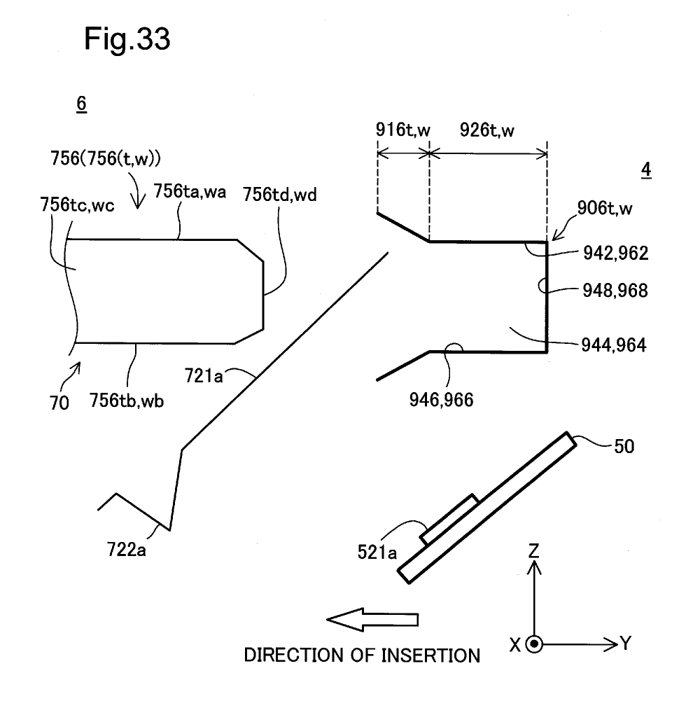

The first wall portion 752t and the second wall portion 752w are walls arranged to define and form the space 751. The first positioning convex 756t and the second positioning convex 756w are respectively located lateral to the +X-axis direction side and the −X-axis direction side of the surface 724fa of the terminal base 724. The first and the second positioning convexes 756t and 756w serve to guide the cartridge 4 and the apparatus-side terminal assembly 70 to a contact location where the respective terminals of the apparatus-side terminal group 721 are in contact with the corresponding respective terminals of the cartridge-side terminal group in the course of mounting the cartridge 4 to the cartridge mounting assembly 6. More specifically, the first positioning convex 756t and the second positioning convex 756w are configured to start insertion into grooves formed in the cartridge 4 before the apparatus-side terminal group 721 starts coming into contact with the cartridge-side terminal group in the course of mounting the cartridge 4 to the cartridge mounting assembly 6. This configuration enables the cartridge 4 and the apparatus-side terminal assembly 70 to be moved to the contact location with high accuracy. The first positioning convex 756t is extended along the Y-axis direction (i.e., the direction of insertion of the cartridge 4). The first positioning convex 756t is protruded in the +X-axis direction from the first wall portion 752t. The second positioning convex 756w is extended along the Y-axis direction (i.e., the direction of insertion of the cartridge 4). The second positioning convex 756w is protruded in the −X-axis direction from the second wall portion 752w. According to this embodiment, in order to achieve this configuration, the positioning convexes 756 are provided to have their edge portions 757 on the +Y-axis direction side located on the +Y-axis direction side of the terminal contacts 722. The edge portion 757 is tapered to increase the dimension in the Z-axis direction from the +Y-axis direction side toward the −Y-axis direction side. The positioning convexes 756 are thus readily insertable into restriction elements of the cartridge 4 described later. Each of the positioning convexes 756t and 756w has four contact surfaces that are in contact with a groove formed in the cartridge 4 in the mounted state that the cartridge 4 is mounted to the cartridge mounting assembly 6. Among the respective four contact surfaces, only contact surfaces 756wa, 756wb, 756wc and 756wd of the positioning convex 756w and contact surfaces 756tb and 756td of the positioning convex 756t are shown in FIGS. 16 and 17. In respective two surfaces opposed to each other in the Z-axis direction among the respective four contact surfaces, surfaces located on the +Z-axis direction side are also called planes A 756ta (shown in FIGS. 33 to 36) and 756wa, and surfaces located on the −Z-axis direction side are also called planes B 756tb and 756wb. Surfaces crossing these planes A and planes B in the X-axis direction are also called planes C 756tc (shown in FIGS. 33 to 36) and 756wc. Edge surfaces on the +Y-axis direction side are also called planes D 756td and 756wd.

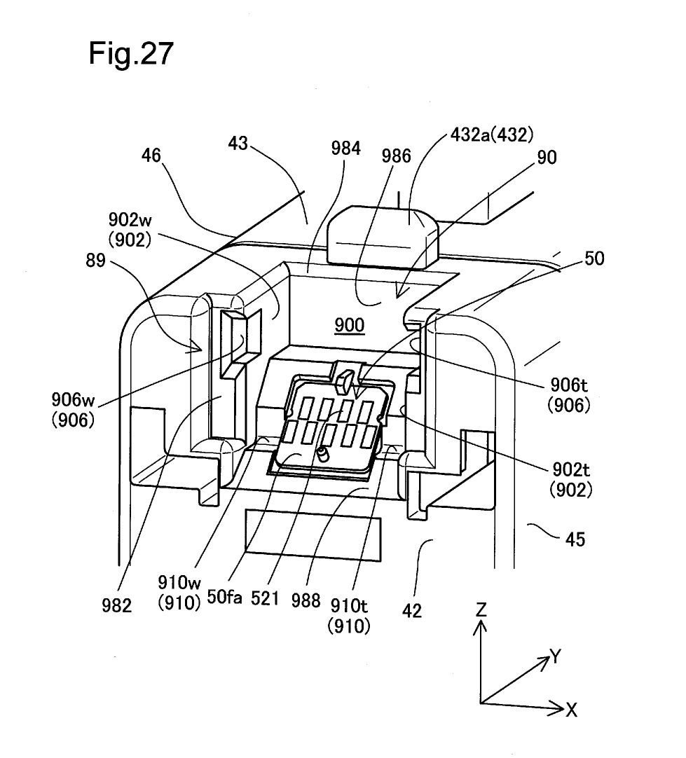

As shown in FIG. 16, the positioning structure 750 also has a pair of projections 759 that are protruded from the pair of wall portions 752 in the direction where the terminal contacts 722 of the apparatus-side terminal group 721 are exposed (i.e., the direction including the +Y-axis direction component and the −Z-axis direction component). In the pair of projections 759, one projection provided on the first wall portion 752t is called first projection 759t, and the other projection provided on the second wall portion 752w is called second projection 759w. The first projection 759t is provided to be protruded in the direction including the +Y-axis direction component and the −Z-axis direction component from lateral to the +X-axis direction side of the apparatus-side terminal group 721 toward the surface 724fa of the terminal base 724. The second projection 759w is provided to be protruded in the direction including the +Y-axis direction component and the −Z-axis direction component from lateral to the −X-axis direction side of the apparatus-side terminal group 721 toward the surface 724fa of the terminal base 724. The first projection 759t and the second projection 759w are received in part of the cartridge 4 (more specifically, in bottom wall recesses 910 described later and shown in FIG. 27) in the mounted state. When there is no need to distinguish between the first projection 759t and the second projection 759w, these are collectively called projections 759.

As shown in FIGS. 10 to 12, the positioning structure 750 arranged to hold the terminal base 724 is mounted to the apparatus-side front wall portion 62. More specifically, the positioning structure 750 is mounted to the terminal mounting structure 694 of the first front wall portion 690. The terminal mounting structure 694 includes a pair of support walls 696 opposed to each other in the X-axis direction and a pair of fitting holes 698 provided in these walls 696. The apparatus-side terminal assembly 70, on the other hand, has a pair of terminal-side fitting elements 762 opposed to each other in the X-axis direction. The terminal-side fitting elements 762 are fit in the pair of fitting holes 698 of the positioning structure 750, so that the apparatus-side terminal assembly 70 is mounted to the apparatus-side front wall portion 62. There are clearances in the X-axis direction between the pair of terminal-side fitting elements 762 and the pair of support walls 696. This configuration allows the apparatus-side terminal assembly 70 to be slightly moved in the X-axis direction relative to the apparatus-side front wall portion 62. There are also clearances in the Z-axis direction between the pair of terminal-side fitting elements 762 and the pair of fitting holes 698. This configuration allows the apparatus-side terminal assembly 70 to be slightly moved in the Z-axis direction relative to the apparatus-side front wall portion 62.

Each of the pair of support walls 696 of the terminal mounting structure 694 is provided with a pair of engagement elements 696a and 696b opposed to each other in the Y-axis direction. Each of the pair of terminal-side fitting elements 762 of the positioning structure 750 is provided with a pair of engagement elements 762a and 762 opposed to each other in the Y-axis direction. When the terminal-side fitting elements 762 are fit in the pair of fitting holes 698 of the terminal mounting structure 694, the engagement elements 696a engage with the engagement element 762a on the −Y-axis direction side, and the engagement elements 696b engage with the engagement elements 762b on the +Y-axis direction side. There are substantially no clearances between the engagement elements 696a and the engagement elements 762a. Similarly there are substantially no clearances between the engagement elements 696b and the engagement elements 762b. This configuration does not allow the apparatus-side terminal assembly 70 to be substantially moved in the Y-axis direction relative to the apparatus-side front wall portion 62.

### A-4. Appearance Configuration of Cartridge 4

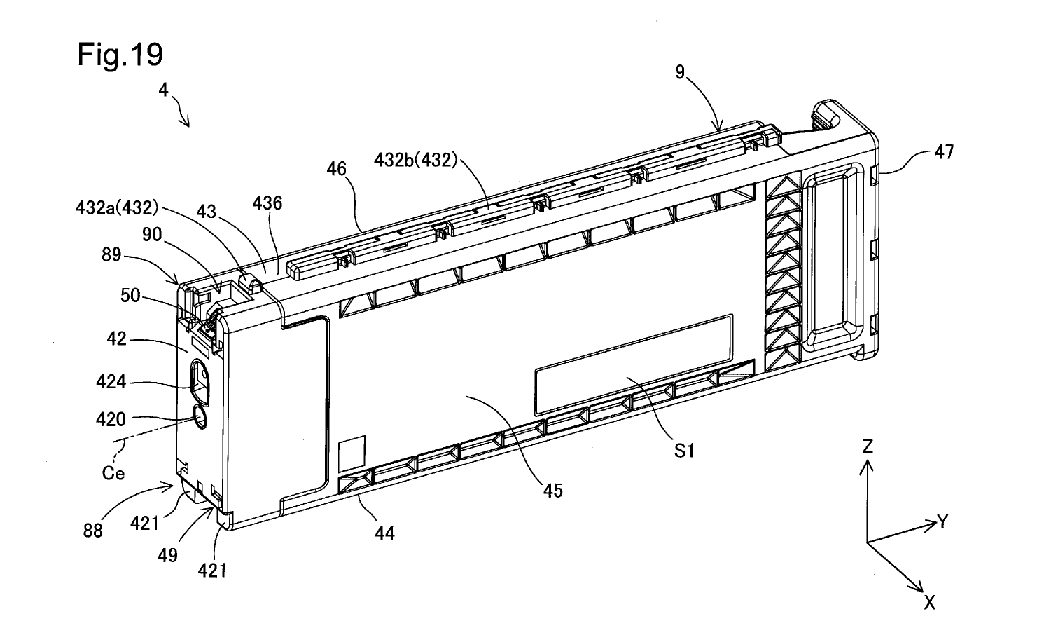

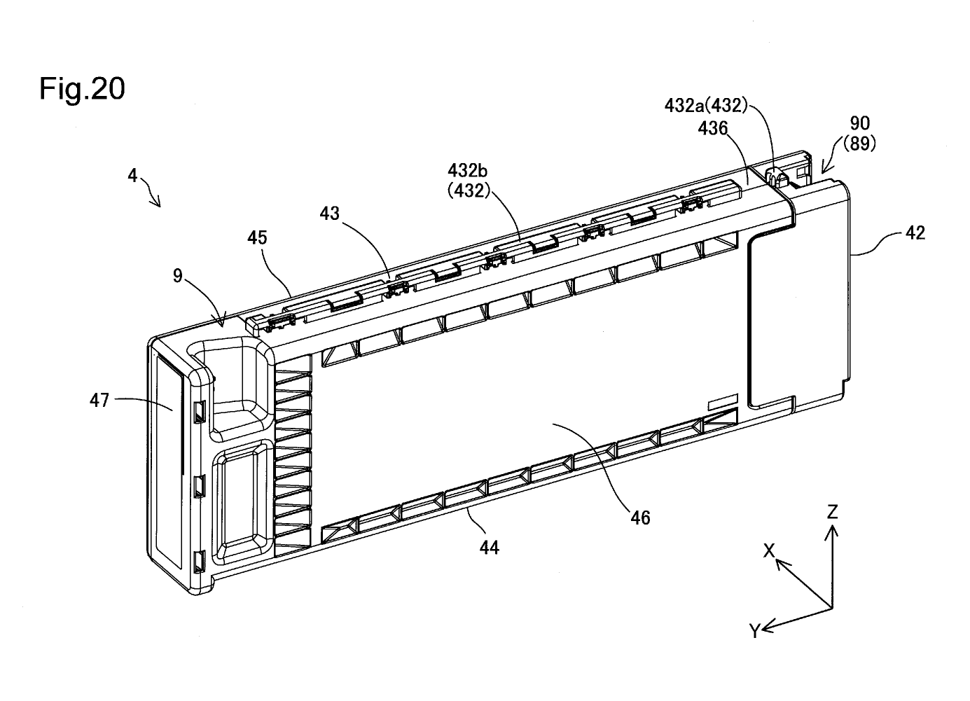

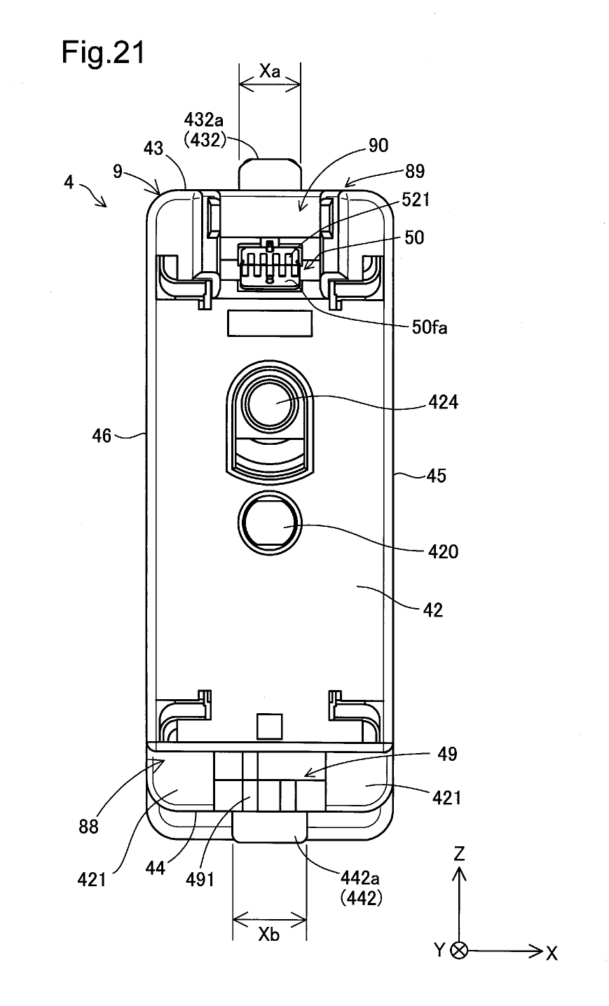

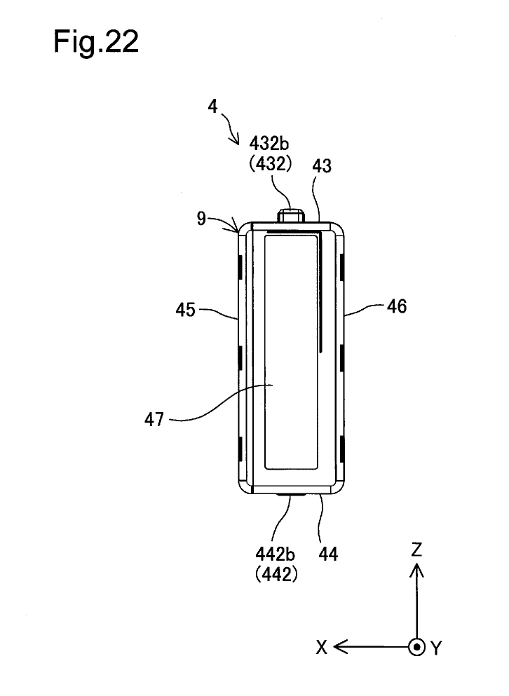

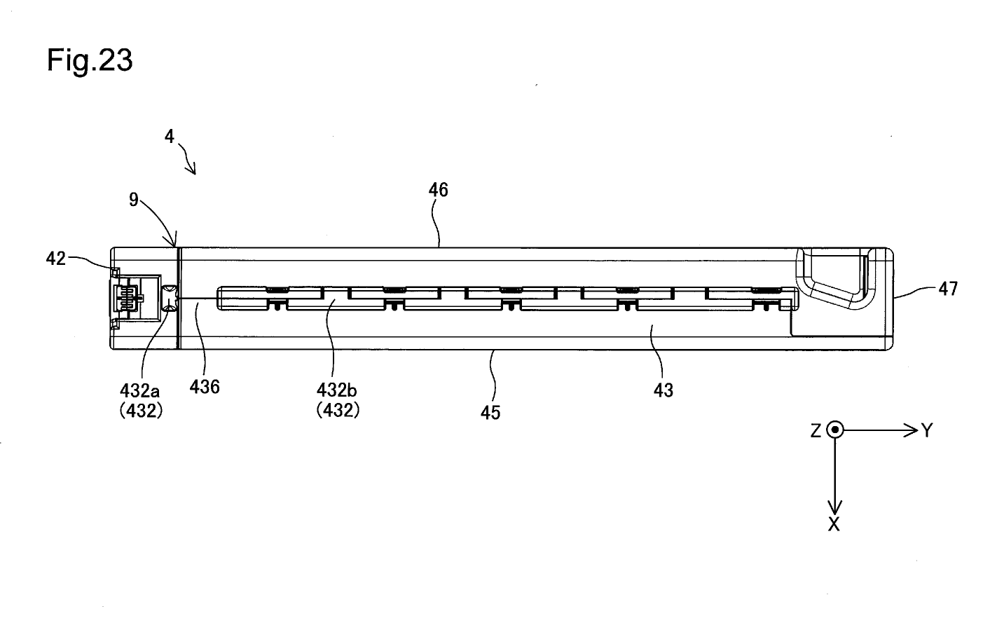

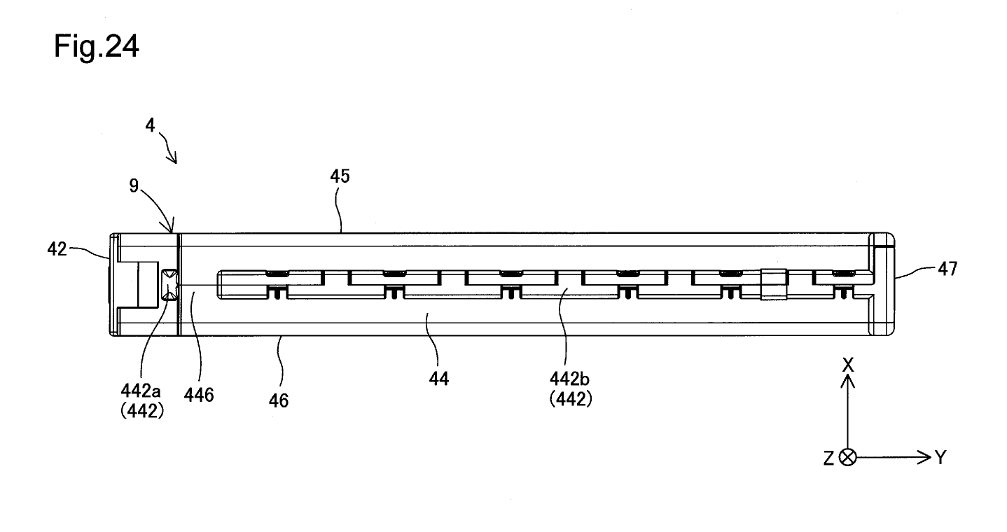

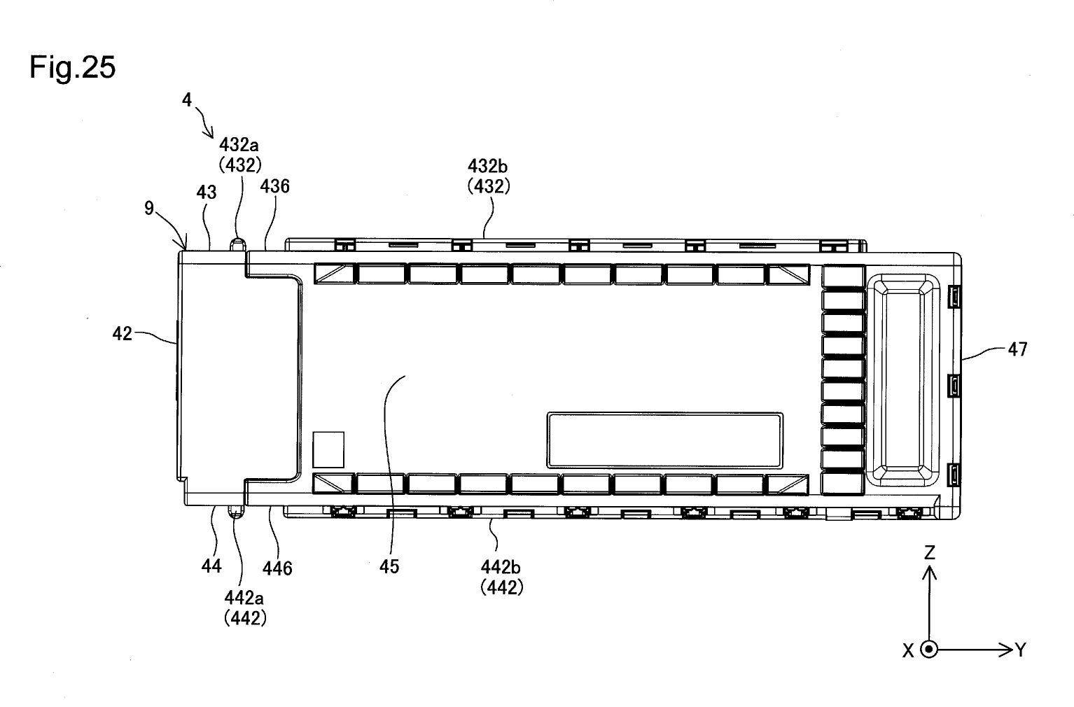

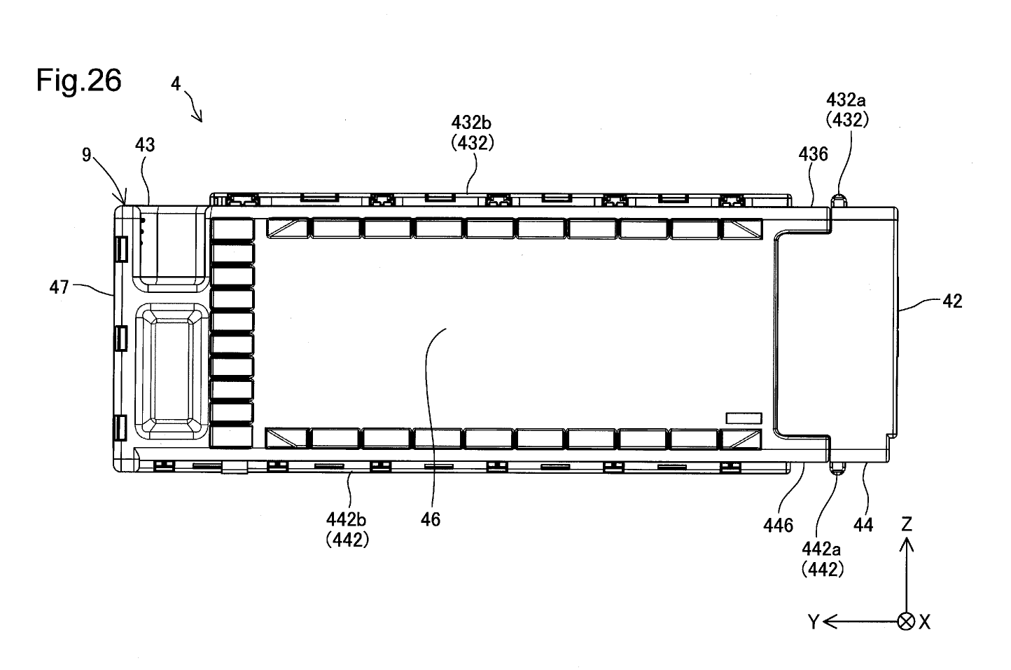

The schematic configuration of the cartridge 4 is described below with reference to FIGS. 19 to 26. The XYZ axes shown in the drawings illustrating the cartridge 4 correspond to the XYZ axes of the cartridge 4 in the mounted state. FIG. 19 is a first appearance perspective view illustrating the cartridge 4. FIG. 20 is a second appearance perspective view illustrating the cartridge 4. FIG. 21 is a front view illustrating the cartridge 4. FIG. 22 is a rear view illustrating the cartridge 4. FIG. 23 is a top view illustrating the cartridge 4. FIG. 24 is a bottom view illustrating the cartridge 4. FIG. 25 is a first side view illustrating the cartridge 4. FIG. 26 is a second side view illustrating the cartridge 4.

As shown in FIGS. 19 and 20, the cartridge 4 is formed in an approximately rectangular parallelepiped shape. According to this embodiment, the cartridge 4 has dimensions decreasing in the sequence of the Y-axis direction, the Z-axis direction and the X-axis direction. The cartridge 4 has a case 9 containing ink inside thereof. The case 9 is a housing formed by molding a synthetic resin. The cartridge 4 includes a front face 42, a rear face 47, a first side face 43, a second side face 44, a third side face 45 and a fourth side face 46. The first side face 43 is also called top face 43; the second side face 44 is also called bottom face 44; the third side face 45 is also called right side face 45; and the fourth side face 46 is also called left side face 46. The front face 42 and the rear face 47 are opposed to each other in the Y-axis direction. The front face 42 is located on the −Y-axis direction side, and the rear face 47 is located on the +Y-axis direction side. The first side face 43 and the second side face 44 cross the front face 42 and the rear face 47 and are opposed to each other in the Z-axis direction. The first side face 43 is located on the +Z-axis direction side, and the second side face 44 is located on the −Z-axis direction side. The third side face 45 and the fourth side face 46 cross the front face 42, the rear face 47, the first side face 43 and the second side face 44 and are opposed to each other in the X-axis direction. The third side face 45 is located on the +X-axis direction side, and the fourth side face 46 is located on the −X-axis direction side.

The front face 42 is in an approximately rectangular shape having a dimension in the Z-axis direction larger than a dimension in the X-axis direction. The front face 42 is arranged to face the apparatus-side front wall portion 62 (shown in FIG. 6) in the mounted state. A rod insertion hole 420 and a supply pipe insertion hole 424 are formed in the front face 42. The rod insertion hole 420 is provided on the front face 42 at an intermediate position between the first side face 43 and the second side face 44. In other words, the rod insertion hole 420 is provided at an intermediate position of a line segment connecting the first side face 43 with the second side face 44 in the Z-axis direction. Accordingly a center axis Ce of the rod insertion hole 420 is located at an intermediate position in the Z-axis direction between the first side face 43 and the second side face 44. The “intermediate position” herein is not necessarily limited to the exact middle position but may be any position that is not significantly near to one of the first side face 43 and the second side face 44. For example, the “intermediate position” may include the position in a range within 10% from the center position with respect to the distance in the Z-axis direction between the first side face 43 and the second side face 44.

In the mounted state, the printing material supply pipe 642 (shown in FIG. 12) is inserted into the supply pipe insertion hole 424. The printing material outlet pipe 484 through which the ink contained in the cartridge 4 is flowed to the outside (shown in FIG. 4) is also placed in the supply pipe insertion hole 424. Connecting the printing material supply pipe 642 with the printing material outlet pipe 484 allows the ink contained in the cartridge 4 to be flowed to the printing material supply pipe 642.

In the mounted state, the rod 662 having part of its outer circumference covered by the rod cover 720 (shown in FIG. 12) is inserted into the rod insertion hole 420. Insertion of the rod 662 into the rod insertion hole 420 positions the entire cartridge 4 relative to the cartridge mounting assembly 6 and reduces a positional misalignment from the correct mounting position. In the mounted state, the rod 662 abuts on the lever member 490 (shown in FIG. 4).

As shown in FIGS. 19, 23, 25 and 26, the first side face 43 has a first convex 432. The first convex 432 is protruded in the +Z-axis direction from the first side face 43. The first convex 432 is extended along the Y-axis direction. More specifically, as shown in FIGS. 25 and 26, the first convex 432 is extended on the first side face 43 from a location close to the front face 42 to a location close to the rear face 47. Furthermore specifically, the first convex 432 is parted into a first portion 432a on the −Y-axis direction side and a second portion 432b on the +Y-axis direction side and includes a first locking element 436 in a concave shape formed between the first portion 432a and the second portion 432b. As shown in FIGS. 24 to 26, the second side face 44 has a second convex 442. The second convex 442 is protruded in the −Z-axis direction from the second side face 44. The second convex 442 is extended along the Y-axis direction. More specifically, as shown in FIGS. 25 and 26, the second convex 442 is extended on the second side face 44 from a location close to the front face 42 to a location close to the rear face 47. Furthermore specifically, the second convex 442 is parted into a first portion 442a on the −Y-axis direction side and a second portion 442b on the +Y-axis direction side and includes a second locking element 446 in a concave shape between the first portion 442a and the second portion 442b. In the course of mounting the cartridge 4 to the cartridge mounting assembly 6, the first convex 432 is inserted into the first rail 682 (shown in FIG. 7), and the second convex 442 is inserted into the second rail 602 (shown in FIG. 6). This configuration allows the cartridge 4 to be smoothly pressed into the corresponding slot of the cartridge mounting assembly 6.

As shown in FIG. 21, the first convex 432 has a dimension Xa in the X-axis direction (width) that is different from a dimension Xb in the X-axis direction (width) of the second convex 442. The configuration of this embodiment satisfies a relationship of dimension Xa<dimension Xb. The second convex 442 has the dimension in the X-axis direction larger than that of the first rail 682 (shown in FIG. 7) and is thus not insertable into the first rail 682. This configuration reduces the likelihood that the cartridge 4 is mounted to the cartridge mounting assembly 6 in the state that the directions of the first side face 43 and the second side face 44 are mistakenly reversed. In the mounted state, the leaf spring 684 (shown in FIG. 7) enters the first locking element 436, and the leaf spring 604 (shown in FIG. 6) enters the second locking element 446. This configuration prevents the cartridge 4 from unintentionally coming off from the cartridge mounting assembly 6.

As shown in FIG. 19, a label S1 is attached on the third side face 45. Information regarding handling of the cartridge 4 (for example, handling instructions) is described on this label S1.

As shown in FIG. 21, a recess 49 and a pair of restriction planes 421 are provided in a corner section 88 where the front face 42 intersects with the second side face 44. A cartridge-side identification member 491 is provided in the recess 49. The cartridge-side identification member 491 is formed by one or more ribs and is formed in a different shape according to the color of ink contained in the cartridge 4. When the cartridge 4 is mounted to the correct slot of the cartridge mounting assembly 6, the cartridge-side identification member 491 and the apparatus-side identification member 610 (shown in FIG. 6) fit each other. The pair of restriction plane 421 are located on the respective sides in the X-axis direction of the recess 49. The pair of restriction planes 421 abuts on the restriction member 612 (shown in FIG. 6) when the cartridge 4 reaches the correct mounting position.

As shown in FIGS. 19 and 21, the cartridge 4 further includes a recess 90 provided in a corner section 89 where the front face 42 intersects with the first side face 43. In other words, the recess 90 is provided from the front face 42 to the first side face 43. The circuit board 50 is placed in the recess 90. A cartridge-side terminal group 521 is formed on a surface 50fa of the circuit board 50 (shown in FIG. 21). The cartridge-side terminal group 521 includes a plurality of terminals (nine terminals according to this embodiment). In the mounted state, the respective terminals of the cartridge-side terminal group 521 are in contact with the corresponding respective terminals of the apparatus-side terminal group 721 (shown in FIG. 15) so as to be electrically connected with the corresponding terminals.

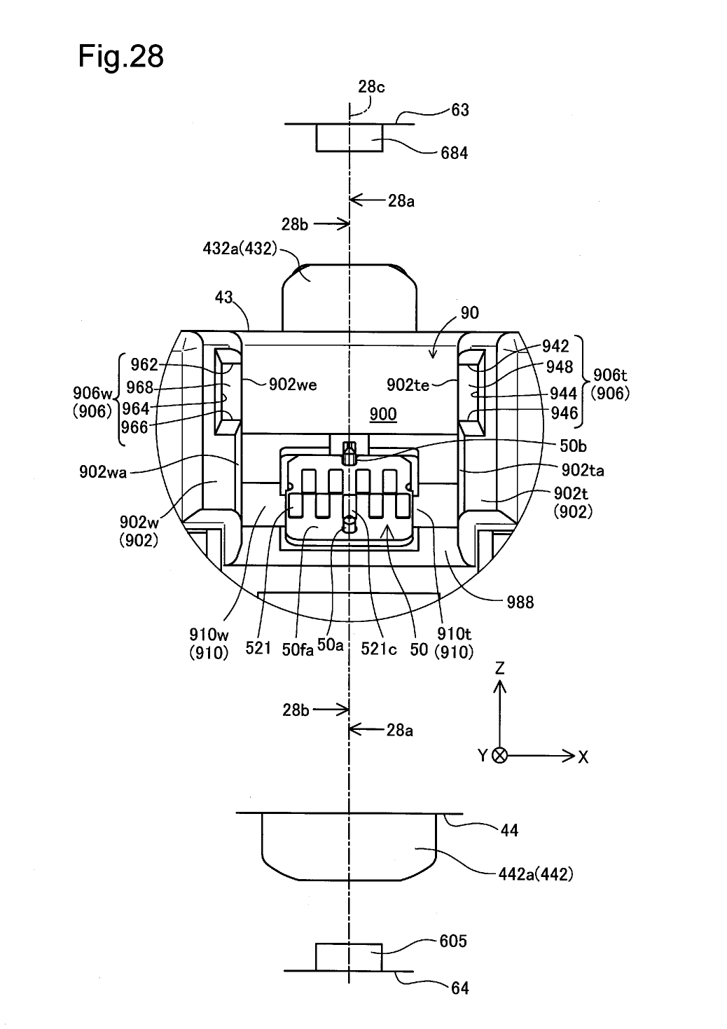

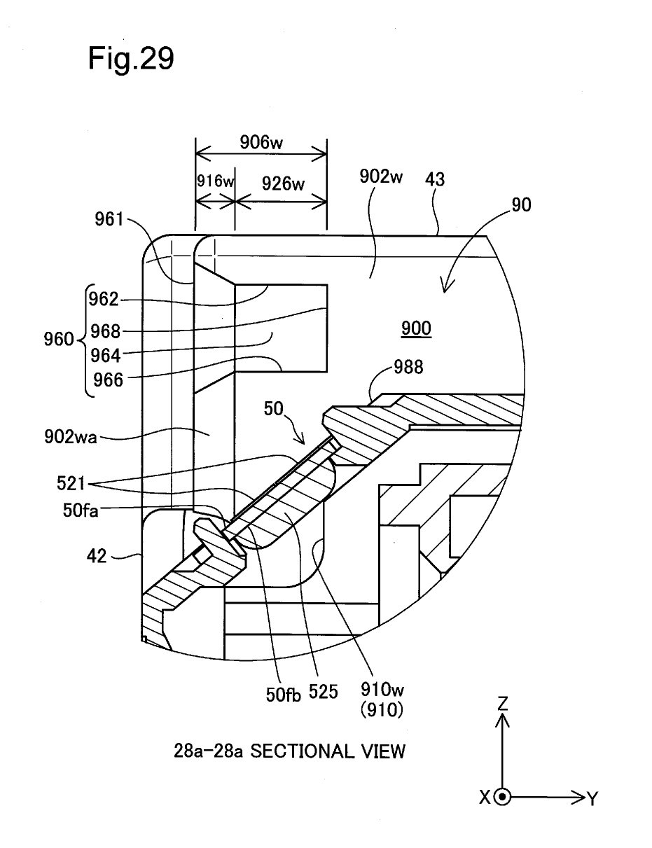

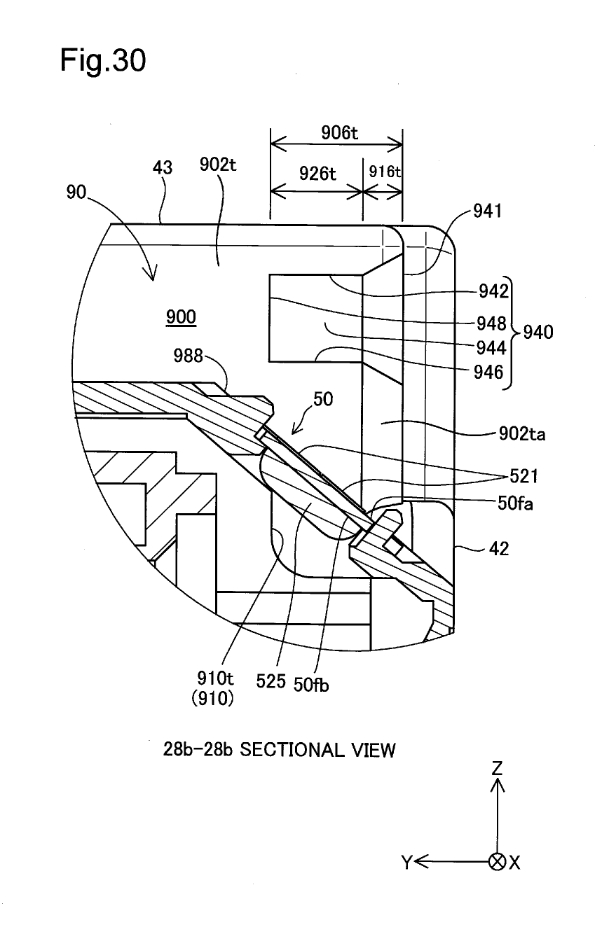

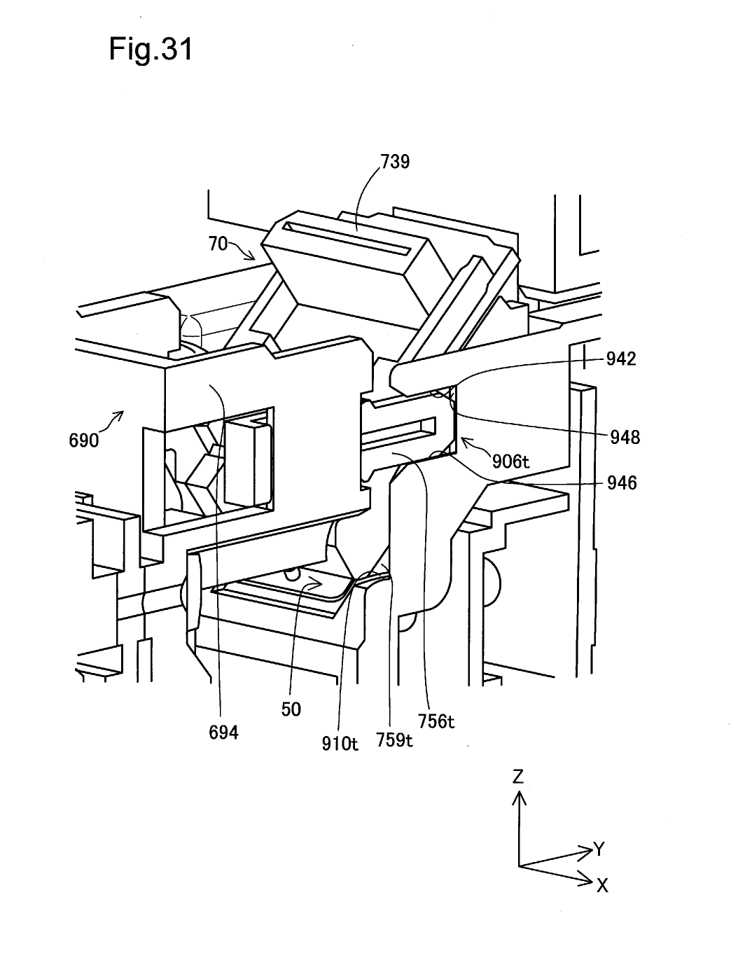

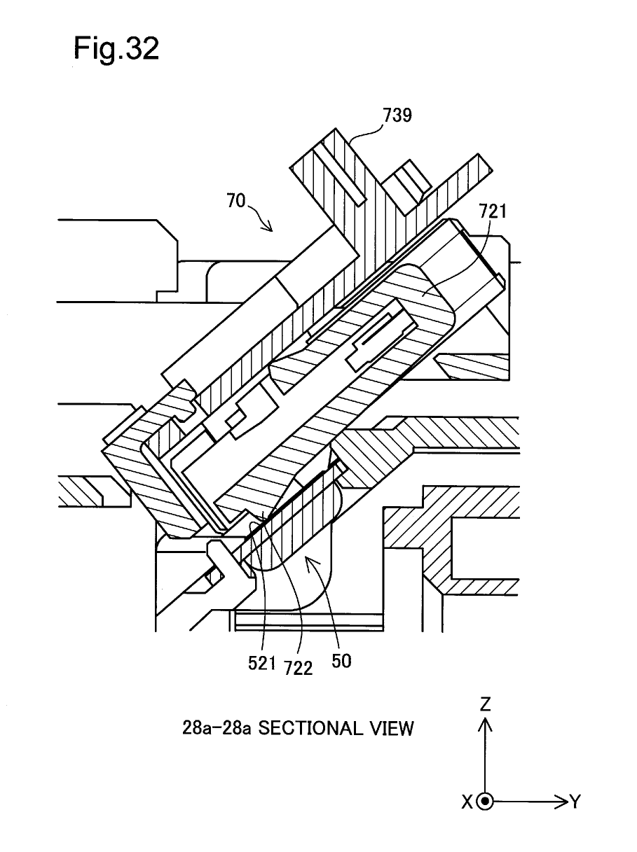

The detailed configuration of the recess 90 is described below with reference to FIGS. 27 to 32. FIG. 27 is an appearance perspective view illustrating periphery of the recess 90. FIG. 28 is a front view illustrating periphery of the recess 90. FIG. 29 is a 28a-28a sectional view taken on a line 28a-28a in FIG. 28. FIG. 30 is a 28b-28b sectional view taken on a line 28b-28b in FIG. 28. FIG. 31 is a diagram illustrating a state of connection of the apparatus-side terminal assembly 70 with the circuit board 50. FIG. 32 is a 28a-28a sectional view in the mounted state.

As shown in FIG. 27, the recess 90 has an opening 982 provided along a plane perpendicular to the Y axis and an opening 984 provided along a plane perpendicular to the Z axis. The recess 90 has inner walls mainly including a pair of side walls 902 (902t, 902w), a bottom wall 988 and a rear wall 986. These inner walls 902, 986 and 988 define and form a terminal chamber (terminal placing structure) 900 inside of the recess 90 to receive the apparatus-side terminal assembly 70 inserted therein. The recess 90 is in an approximately hexahedral shape formed from the opening 982, the opening 984, the pair of side walls 902t and 902w, the bottom wall 988 and the rear wall 986 as main surfaces. The opening 982 and the rear wall 986 are opposed to each other in the Y-axis direction. The opening 982 is located on the −Y-axis direction side, and the rear wall 986 is located on the +Y-axis direction side. The pair of side walls 902t and 902w are opposed to each other in the X-axis direction. The first side wall 902t is located on the +X-axis direction side and the second side wall 902w is located on the −X-axis direction side. The opening 984 and the bottom wall 988 are opposed to each other in a non-parallel arrangement in the Z-axis direction. The opening 984 is located on the +Z-axis direction side, and the bottom wall 988 is located on the −Z-axis direction side. The opening 982 serves as an inlet for inserting the apparatus-side terminal assembly 70 into the recess 90 when the cartridge 4 is mounted to the cartridge mounting assembly 6. The bottom wall 988 crosses the first side wall 902t and the second side wall 902w. The −Z-axis direction side of the bottom wall 988 crosses the opening 982. The bottom wall 988 is extended in the +Y-axis direction with inclination in the +Z-axis direction from the position of the −Z-axis direction side in the opening 982 to cross the rear wall 986. The rear wall 986 crosses the bottom wall 988, the first side wall 902t and the second side wall 902w. The opening 984 crosses the rear wall 986, the first side wall 902t, the second side wall 902w and the opening 982. When there is no need to distinguish between the first side wall 902t and the second side wall 902w, these are collectively called side walls 902.

The circuit board 50 is mounted on the bottom wall 988. More specifically, as shown in FIG. 29, the circuit board 50 is arranged such that the surface 50fa of the circuit board 50 is inclined in a direction including a −Y-axis direction component and a +Z-axis direction component. In other words, the surface 50fa of the circuit board 50 is inclined to the Y axis and the Z axis. As described above, the surface 50fa has the cartridge-side terminal group 521. In other words, the cartridge-side terminal group 521 is provided on a plane inclined to the −Y axis direction that is the direction of insertion into the cartridge mounting assembly 6 of the printer 10. A storage unit 525 is provided on a rear face 50th of the circuit board 50. Information with regard to the cartridge 4 (for example, the color of ink and the manufacturing date) is stored in the storage unit 525. Information such as the remaining amount of ink or the presence/absence of ink may be additionally included as the information with regard to the cartridge 4 stored in the storage unit 525. The cartridge-side terminal group 521 is electrically connected with the storage unit 525.

As shown in FIGS. 27 to 30, a pair of grooves 906t and 906w are respectively provided on the pair of side walls 902t and 902w of the recess 90 opposed to each other in the X-axis direction. These grooves 906t and 906w are formed to face each other in the X-axis direction. As shown in FIG. 28, the grooves 906t and 906w are arranged symmetrically about a YZ plane 28c. This YZ plane 28c is a plane including the center of the dimension in the X-axis direction (width) of the cartridge 4. The circuit board 50 placed in the recess 90 and the respective elements of the recess 90 are arranged symmetrically about this YZ plane 28c. In other words, the YZ plane 28c passes through the center of the dimension in the X-axis direction (width) of the cartridge-side terminal group 521. In the cartridge-side terminal group 521, a terminal 521c located at the center in the width direction of the cartridge-side terminal group 521 crosses the YZ plane 28c. The YZ plane 28c also passes through the center of the dimension in the X-axis direction (width) of the circuit board 50. The YZ plane 28c also passes through mounting elements 50a and 50b provided on the bottom wall 988 to mount the circuit board 50 to the bottom wall 988. The YZ plane 28c further passes through the terminal 521c located at the center in the X-axis direction of the cartridge-side terminal group 521. This terminal 521c is in contact with a terminal 721c located at the center in the X-axis direction of the apparatus-side terminal group 721 (shown in FIG. 16). The pair of grooves 906t and 906w and the pair of side walls 902t and 902w of the recess 90 are arranged symmetrically about the YZ plane 28c. The YZ plane 28c also passes through the center of the dimension in the X-axis direction (width) of the first convex 432 (432a and 432b) and the center of the dimension in the X-axis direction (width) of the second convex 442 (442a and 442b) (shown in FIGS. 21 and 25) described above. Although not being illustrated in FIG. 28, the YZ plane 28c also passes through the center of the dimension in the Z-axis direction (width) of the first locking element 436 provided on the first side face 43 (shown in FIG. 25) and the center of the dimension in the Z-axis direction (width) of the second locking element 446 provided on the second side face 44 (shown in FIG. 25). The leaf springs 684 and 604 (shown in FIGS. 6 and 7) provided to lock the first locking element 436 and the second locking element 446 are arranged to intersect with this YZ plane 28c.

As shown in FIGS. 27 and 30, the first groove 906t serving as a first restriction element is provided on the first side wall 902t. Part of the first side wall 902t is recessed in the +X-axis direction to form the first groove 906t. In other words, the first groove 906t is recessed in the +X-axis direction from the first side wall 902t. The first groove 906t is extended along the Y-axis direction. More specifically, the first groove 906t is extended in the +Y-axis direction from the position of the opening 982 toward the rear wall 986. In the mounted state, the first positioning convex 756t (shown in FIG. 16) is inserted into the first groove 906t. The first groove 906t has an open −Y-axis direction-side end surface and an open −X-axis direction-side surface. As shown in FIGS. 27 and 29, the second groove 906w serving as a second restriction element is provided on the second side wall 902w. Part of the second side wall 902w is recessed in the −X-axis direction to form the second groove 906w. In other words, the second groove 906w is recessed in the −X-axis direction from the second side wall 902w. The second groove 906w is extended along the Y-axis direction. More specifically, the second groove 906w is extended in the +Y-axis direction from the position of the opening 982 toward the rear wall 986. The second groove 906w has an open −Y-axis direction-side end surface and an open +X-axis direction-side surface.

As shown in FIGS. 29 and 30, the grooves 906t and 906w respectively have openings 941 and 961 in their respective −Y-axis direction-side end faces. The grooves 906t and 906w have inlet portions 916t and 916w respectively extended in the +Y-axis direction from the openings 941 and 961 and contact portions 926t and 926w respectively extended in the +Y-axis direction from respective +Y-axis direction-side ends of the inlet portions 916t and 916w. The openings 941 and 961 in the −Y-axis direction-side end faces serve as inlets into which the corresponding positioning convexes 756t and 756w are inserted in the course of mounting the cartridge 4 to the cartridge mounting assembly 6. The openings 941 and 961 are formed on the −Y-axis direction side of the cartridge-side terminal group 521. Insertion of the positioning convexes 756t and 756w into the grooves 906t and 906w is accordingly started, before the apparatus-side terminal group 721 and the cartridge-side terminal group 521 start coming into contact with each other.

The inlet portions 916t and 916w are portions of the grooves 906t and 906w into which the corresponding positioning convexes 756t and 756w are inserted first. As shown in FIGS. 28 to 30, a dimension in the Z-axis direction of each of the inlet portions 916t and 916w monotonically decreases toward the +Y-axis direction side. As shown in FIG. 28, each of the inlet portions 916t and 916w also has a dimension in the X-axis direction decreasing from the −Y-axis direction side toward the +Y-axis direction side. Accordingly the inlet portions 916t and 916w are tapered to gradually decrease the dimensions in the Z-axis direction and in the X-axis direction. In other words, the inlet portions 916t and 916w are tapered to have their largest areas at the respective openings 941 and 961.

As shown in FIGS. 28 to 30, inlet portions 902ta and 902wa of the side walls 902t and 902w of the recess 90 are also tapered corresponding to the inlet portions 916t and 916w. More specifically, the distance between the side walls 902t and 902w (interval in the X-axis direction) at the inlet portions 902ta and 902wa decreases from the −Y-axis direction side toward the +Y-axis direction side.

In the mounted state, the contact portions 926t and 926w are respectively in contact with the positioning convexes 756t and 756w. As shown in FIGS. 29 and 30, the contact portions 926t and 926w respectively have contact faces 940 and 960 that are in contact with the positioning convexes 756t and 756w in the mounted state. As shown in FIG. 30, the contact faces 940 that are in contact with the the first positioning convex 756t, i.e., the contact faces 940 of the groove 906t include four surfaces 942, 946, 948 and 944. Similarly, as shown in FIG. 29, the contact faces 960 that are in contact with the second positioning convex 756w, i.e., the contact faces 960 of the groove 906w include four surfaces 962, 966, 968 and 964. The respective four contact faces are also called planes A 942 and 962, planes B 946 and 966, planes C 944 and 964 and planes D 948 and 968.

As shown in FIG. 30, the plane A 942 and the plane B 946 of the groove 906t are opposed to each other in the Z-axis direction. The plane A 942 is located on the +Z-axis direction side, and the plane B 946 is located on the −Z-axis direction side. The plane D 948 of the groove 906t is opposed to the opening 941 in the Y-axis direction. The opening 941 is located on the −Y-axis direction side, and the plane D 948 is located on the +Y-axis direction side. The plane D 948 is also arranged to cross the plane A 942 and the plane B 946. The plane C 944 of the groove 906t is opposed to an extended surface 902te of the first side wall 902t and is located on the +X-axis direction side of the extended surface 902te of the first side wall 902t as shown in FIG. 28. The plane C 944 is also arranged to cross the plane A 942, the plane B 946 and the plane D 948. The plane A 942 of the groove 906t is in contact with a +Z-axis direction-side end of the first positioning convex 756t (shown in FIG. 16). The plane B 946 is in contact with a −Z-axis direction-side end of the first positioning convex 756t. The plane D 948 is in contact with a +Y-axis direction-side end of the first positioning convex 756t. The plane C 944 is in contact with a +X-axis direction-side end of the first positioning convex 756t.

As shown in FIG. 29, the plane A 962 and the plane B 966 of the groove 906w are opposed to each other in the Z-axis direction. The plane A 962 is located on the +Z-axis direction side, and the plane B 966 is located on the −Z-axis direction side. The plane D 968 of the groove 906w is opposed to the opening 961 in the Y-axis direction. The opening 961 is located on the −Y-axis direction side, and the plane D 968 is located on the +Y-axis direction side. The plane D 968 is also arranged to cross the plane A 962 and the plane B 966. The plane C 964 of the groove 906w is opposed to an extended surface 902we of the second side wall 902w and is located on the −X-axis direction side of the extended surface 902we of the second side wall 902w as shown in FIG. 28. The plane C 964 is also arranged to cross the plane A 962, the plane B 966 and the plane D 968. The plane A 962 of the groove 906w is in contact with a +Z-axis direction-side end of the second positioning convex 756w (shown in FIG. 16). The plane B 966 is in contact with a −Z-axis direction-side end of the second positioning convex 756w. The plane D 968 is in contact with a +Y-axis direction-side end of the second positioning convex 756w. The plane C 964 is in contact with a −X-axis direction-side end of the second positioning convex 756w.

When there is no need to distinguish between the first grove 906t and the second groove 906w, these are collectively called “grooves 906”. When there is no need to distinguish between the first contact portion 926t and the second contact portion 926w, these are collectively called “contact portions 926”. When there is no need to distinguish between the first inlet portion 916t and the second inlet portion 916w, these are collectively called “inlet portions 916”.

As shown in FIG. 27, a pair of bottom wall recesses 910t and 910w are respectively formed on the bottom wall 988 between the inclined surface 50fa and the first side wall 902t and between the inclined surface 50fa and the second side wall 902w. As shown in FIG. 31, the pair of bottom wall recesses 910t and 910w are configured to receive the pair of projections 759t and 759w of the apparatus-side terminal assembly 70 (shown in FIG. 16) in the mounted state. The pair of bottom wall recesses 910t and 910w are also collectively called first bottom wall recesses 910.

### A-5. Contact State Between Cartridge-Side Terminal Group 521 and Apparatus-Side Terminal Group 721

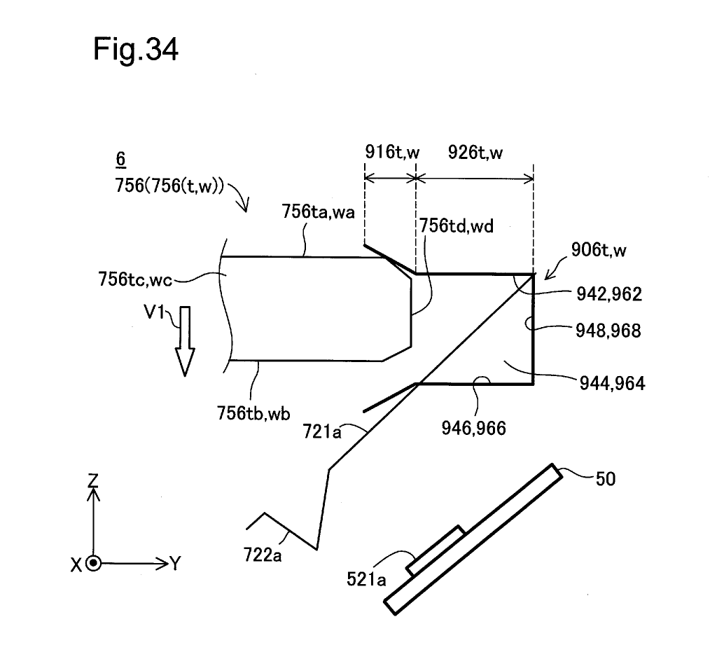

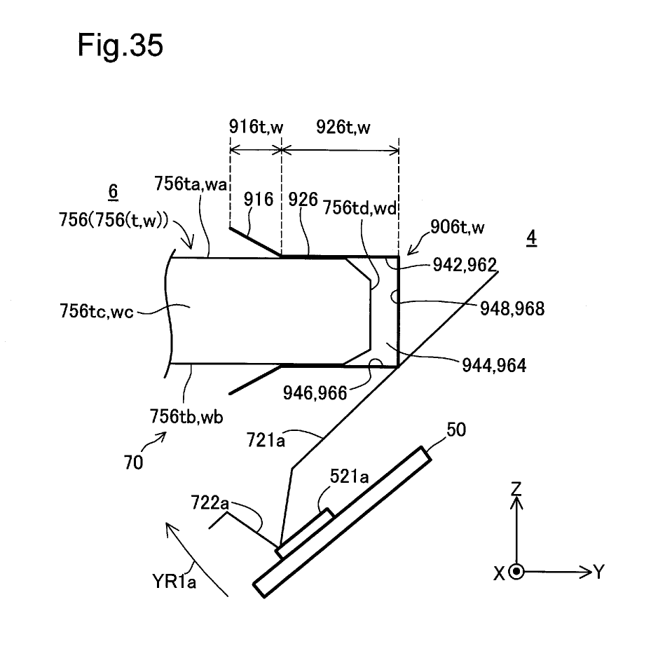

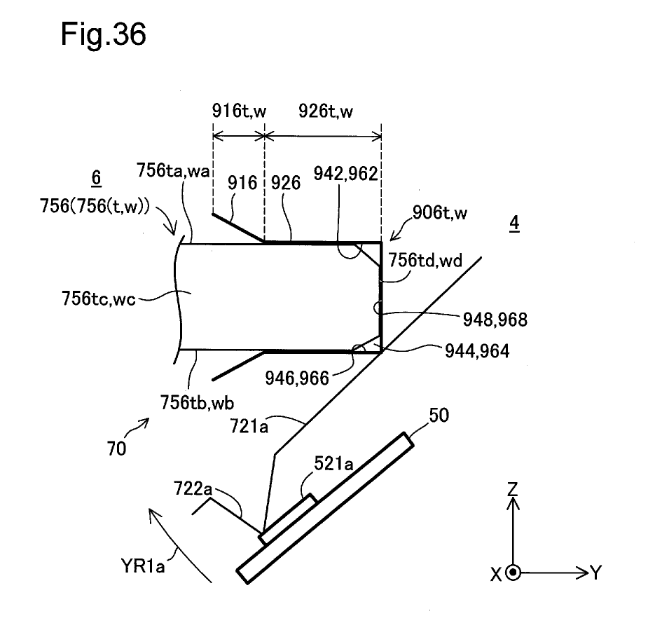

The following describes the contact state between the cartridge-side terminal group 521 and the apparatus-side terminal group 721 in the course of mounting the cartridge 4 to the cartridge mounting assembly 6, with reference to FIGS. 33 to 36. FIG. 33 is a first diagram illustrating contact state. FIG. 34 is a second diagram illustrating the contact state. FIG. 35 is a third diagram illustrating the contact state. FIG. 36 is a diagram illustrating the contact state. FIGS. 33 to 36 sequentially illustrate the state of mounting the cartridge 4 in time series. FIGS. 33 to 36 specifically note one cartridge-side terminal 521a of the cartridge-side terminal group 521 and one apparatus-side terminal 721a of the apparatus-side terminal group 721. The same applies to the other cartridge-side terminals and the other apparatus-side terminals. The first and the second positioning convexes 756t and 756w have an identical shape, and the first and the second grooves 906t and 906w have an identical shape. For the purpose of better understanding, these positioning convexes 756t and 756w and their relevant components and these grooves 906t and 906w and their relevant components are expressed by, for example, signs 756t,w and 906t,w in FIGS. 33 to 36 and the following description.

As shown in FIG. 33, in the course of mounting the cartridge 4 (shown in FIG. 19) to the cartridge mounting assembly 6 (shown in FIG. 5), the cartridge 4 is pressed in the −Y-axis direction into the slot of the cartridge mounting assembly 6. As shown in FIG. 34, insertion of the positioning convexes 756t,w into the grooves 906t,w is started, before the cartridge-side terminal 521a starts coming into contact with a terminal contact 722a of the apparatus-side terminal 721a. Even when the cartridge mounting assembly 6 has a slight manufacturing error, the apparatus-side terminal assembly 70 moves in the X-axis direction and in the Z-axis direction and is guided into the recess 90 of the cartridge 4 with absorbing the manufacturing error. The cartridge 4 is pressed in the −Y-axis direction while the positioning convexes 756t,w are in contact with the surfaces of the inlet portions 916t,w of the grooves 906t,w, so that the apparatus-side terminal assembly 70 is guided to a position where the cartridge-side terminal 521a comes into contact with the apparatus-side terminal 721a. FIG. 34 shows the state that the apparatus-side terminal assembly 70 is guided into the recess 90 (shown in FIG. 27) while slightly moving in a direction shown by an arrow V1 (−Z-axis direction).

As shown in FIG. 35, when the cartridge 4 is further pressed in the −Y-axis direction and the positioning convexes 756t,w are inserted into the contact portions 926t,w of the grooves 906t,w, the planes C 756tc,wc of the positioning convexes 756t,w come into contact with the planes C 944 and 964 of the grooves 906t,w. This restricts the motion of the apparatus-side terminal assembly 70 (shown in FIG. 10) in the X-axis direction. In this state, the planes A 756ta,wa of the positioning convexes 756t,w come into contact with the planes A 942 and 962 of the grooves 906t,w, and the planes B 756tb,wb come into contact with the planes B 946 and 966. This restricts the motion of the apparatus-side terminal assembly 70 in the Z-axis direction. This accordingly determines the positions of the cartridge-side terminal 521a and the terminal contact 722a in the X-axis direction and in the Z-axis direction. The terminal contact 722a starts coming into contact with the cartridge-side terminal 521a immediately before completion of insertion of the positioning convex 756t,w into the contact portions 926t,w. At this moment, the edge surfaces 756td,wd of the positioning contacts 756t,w have not yet come into contact with the planes D 948 and 968 of the grooves 906t,w. This state allows the cartridge 4 to be further pressed. When the cartridge 4 is further pressed in the −Y-axis direction from the state shown in FIG. 35, the apparatus-side terminal 721a is elastically deformed, so that the terminal contact 722a of the apparatus-side terminal 721a moves in a direction of an arrow YR1a while being in contact with the cartridge-side terminal 521a. In this state, the apparatus-side terminal group 721 slightly rubs against the apparatus-side terminal group 521. Eventually, as shown in FIG. 36, the edge surfaces 756td,wd of the positioning convexes 756t,w come into contact with the planes D 948 and 968 of the grooves 906t,w. This determines the positions of the cartridge-side terminal 521a and the terminal contact 722a in the Y-axis direction. This state completes mounting of the cartridge 4 to the cartridge mounting assembly 6. On completion of mounting and in the mounted state, like the final stage of mounting shown in FIG. 35, the planes A 756ta,wa of the positioning convexes 756t,w are in contact with the planes A 942 and 962 of the grooves 906t,w in the +Z-axis direction. The planes B 756tb,wb of the positioning convexes 756t,w are also in contact with the planes B 946 and 966 of the grooves 906t,w in the −Z-axis direction. The plane C 756tc of the first positioning convex 756t is in contact with the plane C 944 of the first groove 906t in the +X-axis direction. The plane C 756wc of the second positioning convex 756w is in contact with the plane C 964 of the second groove 906w in the −X-axis direction. Accordingly the motions of the positioning convexes 756t,w in the Z-axis direction and in the X-axis direction are restricted by the grooves 906t,w. The apparatus-side terminal 721a and the cartridge-side terminal 521a can thus be held at the position that provides the good contact between the apparatus-side terminal 721a and the cartridge-side terminal 521a.

### A-6. Other Configuration of Cartridge 4

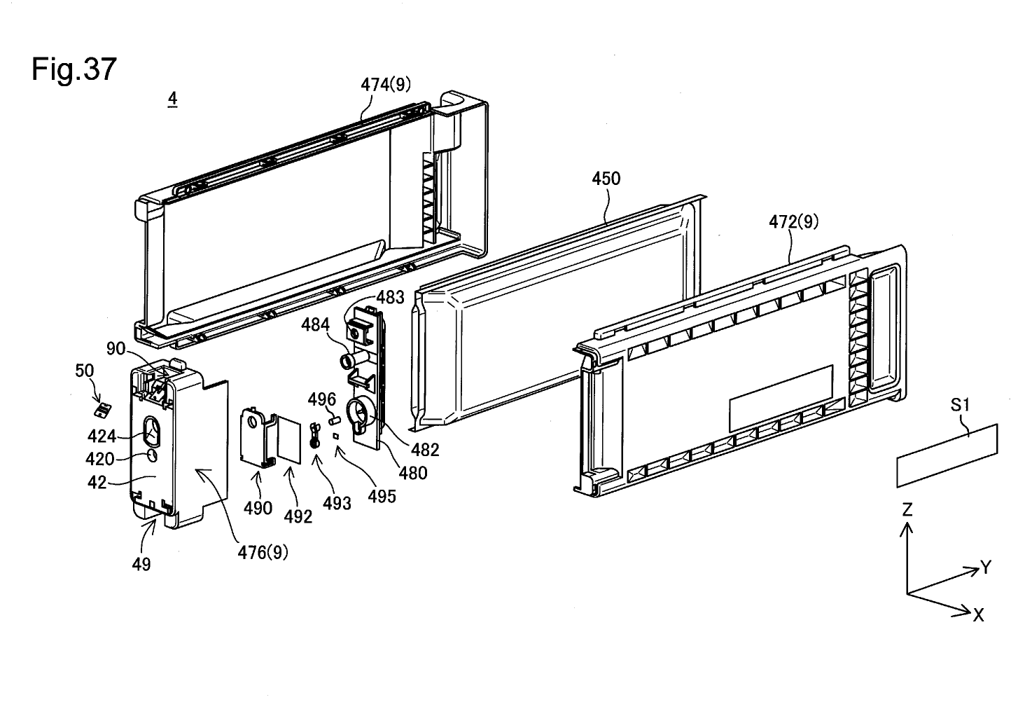

FIG. 37 is an exploded perspective view illustrating the cartridge 4. As shown in FIG. 37, the printing material container 450 and a cartridge-side flow path member 480 are placed in the case 9. The printing material container 450 is configured to contain ink. The printing material container 450 is provided as a flexible bag body. According to this embodiment, the printing material container 450 is formed from an aluminum laminated multi-layer film obtained by stacking an aluminum layer on a resin film layer. The cartridge-side flow path member 480 forms a flow path arranged to make the printing material container 450 communicate with the outside (also called “printing material outlet flow path”). More specifically, one end of the cartridge-side flow path member 480 is connected with inside of the printing material container 450, and the printing material outlet pipe 484 provided on the other end is connected with the printing material supply pipe 642 (shown in FIG. 4). A detection chamber 482 is provided in the middle of the printing material outlet flow path. A coil spring 496 as a biasing member, a check valve 495 and a pressure plate 493 are placed in the detection chamber 482. An opening on one side face of the detection chamber 482 is covered with a flexible film 492. The pressure plate 493 is placed between the coil spring 496 and the film 492. The coil spring 496 is arranged to bias the pressure plate 493 and thereby increase the volume of the detection chamber 482. The lever member 490 is also placed in the case 9. The lever member 490 comes into contact with the film 492 from outside of the detection chamber 482. The volume of the detection chamber 482 is changed with a change in the internal pressure. Changing the volume of the detection chamber 482 results in displacing the lever member 490. As described previously, the rod 662 (shown in FIG. 4) abuts on the lever member 490. In the state that ink is contained in the printing material container 450, suction from inside of the printing material container 450 by the pump mechanism 7 causes ink to be supplied into the detection chamber 482. The internal pressure of the detection chamber 482 is accordingly kept at a predetermined pressure. In this state, the detection chamber 482 is maintained to have the large volume, so that the rod 662 (shown in FIG. 4) is pressed in the −Y-axis direction by the lever member 490 against the biasing force given by the biasing member 665 (shown in FIG. 4). In the out-of-ink state of the printing material container 450, on the other hand, suction from inside of the printing material container 450 by the pump mechanism 7 provides a negative pressure in the detection chamber 482. The negative pressure in the detection chamber 482 reduces the volume of the detection chamber 482 from the volume at the predetermined pressure and thereby displaces the lever member 490. The rod 662 (shown in FIG. 4) is accordingly displaced in the +Y-axis direction by the biasing force given by the biasing member 665 (shown in FIG. 4). The sensor 138 (shown in FIG. 4) detects a displacement of the rod 662 (shown in FIG. 4) accompanied with the displacement of the lever member 490, so that the controller 31 detects the ink end state. The detection chamber 482, the coil spring 496, the pressure plate 493, the film 492 and the lever member 490 constitute a detection mechanism used to detect the ink end state by the printer 10. The cartridge-side flow path member 480 further includes an injection flow path 483 configured to inject ink from outside into the printing material container 450. After injection of ink into the printing material container 450, the injection flow path 483 is closed.

### A-7. Advantageous Effects

As described above with reference to FIGS. 10 to 12, according to this embodiment, the apparatus-side terminal assembly 70 is configured to be movable in the X-axis direction and in the Z-axis direction. As shown in FIGS. 27 to 30, the cartridge 4 has the recess 90 configured to receive the apparatus-side terminal assembly 70 inserted therein. Even when the cartridge mounting assembly 6 or the cartridge 4 has a manufacturing error, the apparatus-side terminal assembly 70 moves in the course of mounting the cartridge 4 to the cartridge mounting assembly 6 and is guided into the recess 90 of the cartridge 4 with absorbing the manufacturing error (as shown in FIG. 34). Eventually, the first and the second restriction elements 906t and 906w provided in the recess 90 serve to position the cartridge-side terminal group 521 relative to the apparatus-side terminal group 721. More specifically, on completion of mounting and in the mounted state, the first and the second restriction elements 906t and 906w provided in the recess 90 of the cartridge 4 restrict the motions of the first and the second positioning convexes 756t and 756w of the apparatus-side terminal assembly 70 in the Z-axis direction and in the X-axis direction. This positions the cartridge-side terminal group 521 relative to the apparatus-side terminal group 721. This provides the good contact between the apparatus-side terminal group 721 and the cartridge-side terminal group 521.

According to the above embodiment, as shown in FIG. 13, the rod 662 having the center axis Cb parallel to the Y-axis direction is provided on the apparatus-side front wall portion 62 at the intermediate position between the apparatus-side first side wall portion 63 and the apparatus-side second side wall portion 64. As shown in FIG. 21, the rod insertion hole 420 configured to receive the rod 662 inserted therein is provided on the front face 42 of the cartridge 4 at the intermediate position between the first side face 43 and the second side face 44. According to this embodiment, insertion of the rod 662 into the rod insertion hole 420 positions the entire cartridge 4 relative to the cartridge mounting assembly 6 and reduces a positional misalignment from the correct mounting position. This configuration effectively reduces a positional misalignment in the vicinity of the rod insertion hole 420. The cartridge-side terminal group 521 (shown in FIG. 21) provided in the corner section 89 of the front face 42 is, however, located away from the rod insertion hole 420. It may be difficult to reduce a positional misalignment of a member located away from the rod insertion hole 420. Especially the cartridge 4 of the embodiment is a large-volume cartridge used for the printer 10 for large-size printing and accordingly has the large size such as to cause the cartridge-side terminal group 521 to be located relatively away from the rod insertion hole 420. This embodiment, however, employs the configuration of the apparatus-side terminal assembly 70 movable in the X-axis direction and in the Z-axis direction and the configuration of the recess 90 to receive the apparatus-side terminal assembly 70 inserted therein as described above enables the cartridge-side terminal group 521 to be positioned relative to the apparatus-side terminal group 721 with high accuracy. The configuration of the embodiment ensures accurate positioning of the entire cartridge 4 that is even the large-volume, large-size cartridge and enables the cartridge-side terminal group 521 to be positioned relative to the apparatus-side terminal group 721 with high accuracy with absorbing the manufacturing error of the cartridge 4.

According to this embodiment, the printing material supply pipe 642 is provided between the rod 662 and the apparatus-side terminal assembly 70 (as shown in FIG. 13). The supply pipe insertion hole 424 configured to receive the printing material supply pipe 642 inserted therein is provided between the rod insertion hole 420 and the recess 90 (as shown in FIG. 21). Accordingly, the printing material supply pipe 642 is provided at the position closer to the rod 662, and the supply pipe insertion hole 424 is provided at the position closer to the rod insertion hole 420. This configuration effectively reduces a positional misalignment between the printing material supply pipe 642 and the supply pipe insertion hole 424.

As shown in FIG. 18, the apparatus-side terminal group 721 is provided on the surface 724fa that is inclined in the direction including the +Y-axis direction component and the −Z-axis direction component. As shown in FIG. 29, the cartridge-side terminal group 521 is provided on the inclined surface 50fa that is inclined in the direction including the +Y-axis direction component and the −Z-axis direction component. Accordingly, the apparatus-side terminal group 721 and the cartridge-side terminal group 521 are provided on the surfaces that are inclined similarly relative to the −Y-axis direction that is the direction of insertion of the cartridge 4 into the cartridge mounting assembly 6. As described above with reference to FIGS. 33 to 36, the cartridge 4 is moved in the −Y-axis direction to be inserted into the cartridge mounting assembly 6. In this state, the cartridge-side terminal group 521 also moves in the −Y-axis direction to gradually approach to the apparatus-side terminal group 721. The cartridge-side terminal group 521, however, does not start coming into contact with the apparatus-side terminal group 721 immediately before completion of mounting. In the final stage of mounting, immediately before completion of mounting after insertion of the apparatus-side terminal assembly 70 into the recess 90 of the cartridge 4, the cartridge-side terminal group 521 slightly rubs against the apparatus-side terminal group 721 (as shown in FIGS. 35 and 36). On completion of mounting and in the mounted state, the first and the second restriction elements 906t and 906w provided in the recess 90 of the cartridge 4 restrict the motions of the first and the second positioning convexes 756t and 756w of the apparatus-side terminal assembly 7 in the X-axis direction and in the Z-axis direction. This positions the cartridge-side terminal group 521 relative to the apparatus-side terminal group 721. As described above, the apparatus-side terminal group 721 and the cartridge-side terminal group 521 hardly rub against each other in the course of mounting the cartridge 4. The apparatus-side terminal group 721 and the cartridge-side terminal group 521, however, slightly rub each other immediately before completion of mounting of the cartridge 4. This configuration reduces the likelihood that the apparatus-side terminal group 721 rubs against the case 9 of the cartridge 4 and the like to cause shavings in the course of mounting the cartridge 4. Even when dust is present in the vicinity of the apparatus-side terminal group 721 and is placed between the apparatus-side terminal group 721 and the cartridge-side terminal group 521, the apparatus-side terminal group 721 comes into contact with the cartridge-side terminal group 521 with linearly rubbing against the surface of the cartridge-side terminal group 521. This provides the effect of discharging the dust from the contact region (wiping effect) and thereby reduces the likelihood that the dust is placed between the apparatus-side terminal group 721 and the cartridge-side terminal group 521.

According to the above embodiment, as shown in FIGS. 16, 17 and 36, the planes A 756ta,wa are provided on the +Z-axis direction-side ends of the first and the second positioning convexes 756t,w of the apparatus-side terminal assembly 70, and the planes B 756tb,wb are provided on the −Z-axis direction-side ends. As shown in FIGS. 28 to 30 and 36, the planes A 942 and 962 and the planes B 946 and 966 are provided in the grooves 906t,w provided as the first and the second restriction elements in the recess 90. As shown in FIG. 36, the planes A 942 and 962 of the grooves 906t,w come into contact with the planes A 756ta,wa provided on the +Z-axis direction-side ends of the first and the second positioning convexes 756t,w in the mounted state. The planes B 946 and 966 of the grooves 906t,w come into contact with the planes B 756tb,wb provided on the −Z-axis direction-side ends of the first and the second positioning convexes 756t,w in the mounted state. Accordingly the first and the second restriction elements 906t,w restrict the motions of the first and the second positioning convexes 756t,w in the +Z-axis direction and in the −Z-axis direction. This configuration enables the cartridge-side terminal group 521 to be positioned with high accuracy relative to the apparatus-side terminal group 721 in the Z-axis direction. This accordingly ensures the good contact between the apparatus-side terminal group 721 and the cartridge-side terminal group 521. Additionally, the apparatus-side terminal assembly 70 is held on both the +Z-axis direction side and the −Z-axis direction side. Even when a vibration or an external shock is applied to the printer 10 during use, this configuration reduces a positional misalignment of the contact between the apparatus-side terminal group 721 and the cartridge-side terminal group 521 due to such a vibration or impact.

Furthermore, according to the above embodiment, as shown in FIGS. 16, 17, 27 and 28, the first groove 906t as the first restriction elements comes into contact with the first positioning convex 756t to restrict the motion of the first positioning convex 756t in the +X-axis direction. The second groove 906w as the second restriction element comes into contact with the second positioning convex 756w to restrict the motion of the second positioning convex 756w in the −X-axis direction. Accordingly the first groove 906t and the second groove 906w restrict the motion of the apparatus-side terminal assembly 70 in the +X-axis direction and in the −X-axis direction. This configuration enables the cartridge-side terminal group 521 to be positioned with high accuracy relative to the apparatus-side terminal group 721 in the X-axis direction. This accordingly ensures the good contact between the apparatus-side terminal group 721 and the cartridge-side terminal group 521. Additionally, the apparatus-side terminal assembly 70 is held on both the +X-axis direction side and the −X-axis direction side. Even when a vibration or an external shock is applied to the printer 10 during use, this configuration further reduces a positional misalignment of the contact between the apparatus-side terminal group 721 and the cartridge-side terminal group 521 due to such a vibration or impact.

Moreover, according to the above embodiment, as shown in FIGS. 28 to 30 and 36, the grooves 906t,w as the first and the second restriction elements have the planes D 948 and 968 that respectively come into contact with the planes D 756td,wd on the +Y-axis direction-side ends of the first and the second positioning convexes 756t,w. This configuration prevents the apparatus-side terminal assembly 70 from being excessively pressed in the +Y-axis direction and strongly hitting against the bottom wall 988 of the recess 90 of the cartridge 4 in the course of insertion of the cartridge 4 into the cartridge mounting assembly 6. This prevents breakage of the apparatus-side terminal assembly 70.

According to the above embodiment, as shown in FIGS. 27 to 30, forming the grooves 906t and 906w in the first side walls 902t and 902w readily forms the first and the second restriction elements to restrict the motions of the first and the second positioning convexes 756t and 756w. According to this embodiment, the groove 906 is provided as the component of the cartridge 4 that is mounted and demounted by the user as shown in FIGS. 27 to 30, whereas the positioning convex 756 is provided as the component of the stationary cartridge mounting assembly 6 as shown in FIGS. 15 and 17. This configuration reduces the likelihood that the first and the second restriction elements 906t and 906w of the cartridge 4 hit against the components of the printer 10 and damage the printer 10 or the cartridge 4 in the course of mounting and demounting the cartridge 4.

According to the above embodiment, as shown in FIGS. 29, 30 and 33 to 36, the first and the second restriction elements 906t,w respectively have the inlet portions 916t,w that are extended in the +Y-axis direction from the openings 941 and 961 provided on the respective −Y-axis direction-side end faces and have the dimension in the Z-axis direction decreasing toward the +Y-axis direction side. In other words, the inlet portions 916t,w are tapered to gradually decrease their dimensions in the Z-axis direction. Even when the cartridge 4 or the cartridge mounting assembly 6 has a manufacturing error in the Z-axis direction, this configuration enables the restriction elements 906 provided in the recess 90 of the cartridge 4 to readily guide the positioning convexes 756 of the apparatus-side terminal assembly 70 that is movable in the Z-axis direction (as shown in FIG. 34). The first and the second restriction elements 906t,w also have the contact portions 926t,w that are extended from the +Y-axis direction-side ends of the inlet portions 916t,w in the +Y-axis direction, have constant dimensions in the Z-axis direction and respectively come into contact with the first and the second positioning convexes 756t,w in the mounted state. The first and the second positioning convexes 756t,w of the apparatus-side terminal assembly 70 are guided to the inlet portions 916t,2 and are then pressed into the contact portions 926t,w. This enables the apparatus-side terminal group 721 to be positioned relative to the cartridge-side terminal group 521 with high accuracy.

According to the above embodiment, as shown in FIG. 28, the inlet portions 916 also have the dimensions in the X-axis direction decreasing from the −Y-axis direction side toward the +Y-axis direction side. Even when the cartridge 4 or the cartridge mounting assembly 6 has a manufacturing error in the X-axis direction, this configuration enables the restriction elements 906 to readily guide the positioning convexes 756. The dimensions (widths) in the X-axis direction of the cartridge 4 and each slot of the cartridge mounting assembly 6 are significantly smaller than the dimensions in the Z-axis direction. The manufacturing error in the X-axis direction is thus expected to be relatively smaller than the manufacturing error in the Z-axis direction. Accordingly even the configuration of tapering the inlet portions 916t,w in the Z-axis direction without tapering the inlet portions 916t,w in the X-axis direction provides the sufficient effect of readily guiding the positioning convexes 756t,w.

According to the above embodiment, as shown in FIGS. 28 to 30, the inlet portions 902ta,wa of the side walls 902t,w of the recess 90 are tapered corresponding to the tapered shapes of the inlet portions 916t,w of the restriction elements 906t,w. More specifically, the distance between the side walls 902t and 902w (interval in the X-axis direction) of the inlet portions 902ta,wa is decreased from the −Y-axis direction side toward the +Y-axis direction side. Widening the openings of the inlet portions 902ta,wa of the recess 90 to receive the apparatus-side terminal assembly 70 facilitates guiding the apparatus-side terminal assembly 70 into the recess 90 of the cartridge 4.

According to the above embodiment, as shown in FIG. 27, the pair of bottom wall recesses 910t,w configured to receive part of the apparatus-side terminal assembly 70 inserted therein are formed on the respective sides of the surface 50fa in the X-axis direction in the bottom wall 988 of the recess 90, i.e., between the inclined surface 50fa with the cartridge-side terminal group 521 provided thereon and the first side wall 902t of the recess 90 and between the inclined surface 50fa and the second side wall 902w of the recess 90. The pair of bottom wall recesses 910t,w cause approximately triangular surfaces to be exposed on the +X-axis direction side and on the −X-axis direction side of the cartridge-side terminal group 521. This configuration enables the circuit board 50 with the cartridge-side terminal group 521 provided thereon to be readily mounted and demounted. As shown in FIG. 16, the pair of projections 759t,w are provided on the +X-axis direction side and on the −X-axis direction side of the apparatus-side terminal group 721 to be protruded from the surface 724fa in the direction including the +Y-axis direction component and the −Z-axis direction component. The bottom wall recesses 910t,w provided in the recess 90 respectively serve as the spaces to receive the projections 759t,w. The configuration that the projections 759t,w are received in the bottom wall recesses 910t,w enables the cartridge-side terminal group 521 and the apparatus-side terminal group 721 to be positioned relative to each other and reduces their positional misalignment at the location closer to the cartridge-side terminal group 521 and the apparatus-side terminal group 721, in addition to the configuration of the restriction elements 906 and the positioning convexes 756 that enables the cartridge-side terminal group 521 and the apparatus-side terminal group 721 to be positioned relative to each other and reduces their positional misalignment. This configuration accordingly ensures the better contact between the apparatus-side terminal group 721 and the cartridge-side terminal group 521.

According to the above embodiment, as shown in FIG. 28, the respective components of the circuit board 50 and the recess 90 are arranged symmetrically about the YZ plane 28c that includes the center of the dimension in the X-axis direction of the cartridge 4. Although not being specifically illustrated in FIG. 28, the YZ plane 28c passes through the center of the dimension in the Z-axis direction (width) of the first locking element 436 provided on the first side face 43 (shown in FIG. 25) and passes through the center of the dimension in the Z-axis direction (width) of the second locking element 446 provided on the second side face 44 (shown in FIG. 25). The leaf springs 684 and 604 (shown in FIGS. 6 and 7) provided to lock the first locking element 436 and the second locking element 446 are arranged to intersect with this YZ plane 28c. This configuration causes the force received from, for example, the apparatus-side terminal assembly 70 and the leaf springs 604 and 684 (shown in FIGS. 6 and 7) to be applied to the cartridge 4 in a well-balanced manner in the state that the cartridge 4 is mounted to the cartridge mounting assembly 6 and thereby makes it unlikely to incline the cartridge 4. This configuration also ensures the better contact between the apparatus-side terminal group 721 and the cartridge-side terminal group 521.

According to the above embodiment, the cartridge mounting assembly 6 has the positioning structure 750 to hold the terminal base 724 (shown in FIGS. 14 to 16). More specifically, according to the above embodiment, the terminal base 724 is not directly attached to the apparatus-side front wall portion 62 but is attached to the apparatus-side front wall portion 62 via the positioning structure 750. This configuration provides the terminal base 724 and the apparatus-side terminal group 721 of high versatility. The positioning convexes 756 used to position the apparatus-side terminal group 721 and the cartridge-side terminal group 521 relative to each other may be changed according to the specifications of the cartridge 4 and the printer 10. The positioning convexes 756 that may require the change of design are provided not on the terminal base 724 but on the positioning structure 750. This configuration provides the fixed shapes of the terminal base 724 and the apparatus-side terminal group 721 that is held on the terminal base 724. Accordingly the terminal base 724 and the apparatus-side terminal group 721 are components of high versatility.

### B. Second Embodiment

A printing material supply system 1A of a second embodiment differs from the printing material supply system 1 of the first embodiment by the configuration of the terminal chamber (terminal placing structure) 900 of the cartridge 4 (shown in FIG. 27), but otherwise has the similar configuration to that of the printing material supply system 1 of the first embodiment. The like components in the second embodiment to those in the first embodiment are expressed by the like signs and are not specifically described. The printer 10 of the second embodiment has the same configuration as that of the first embodiment.

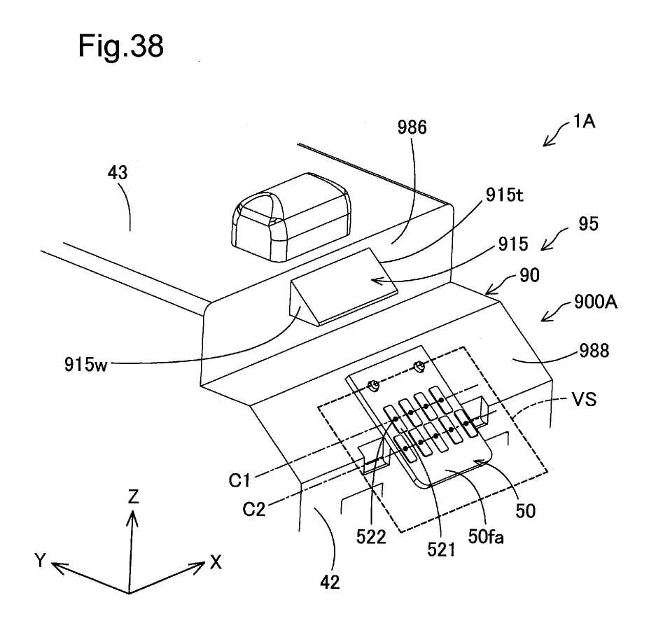

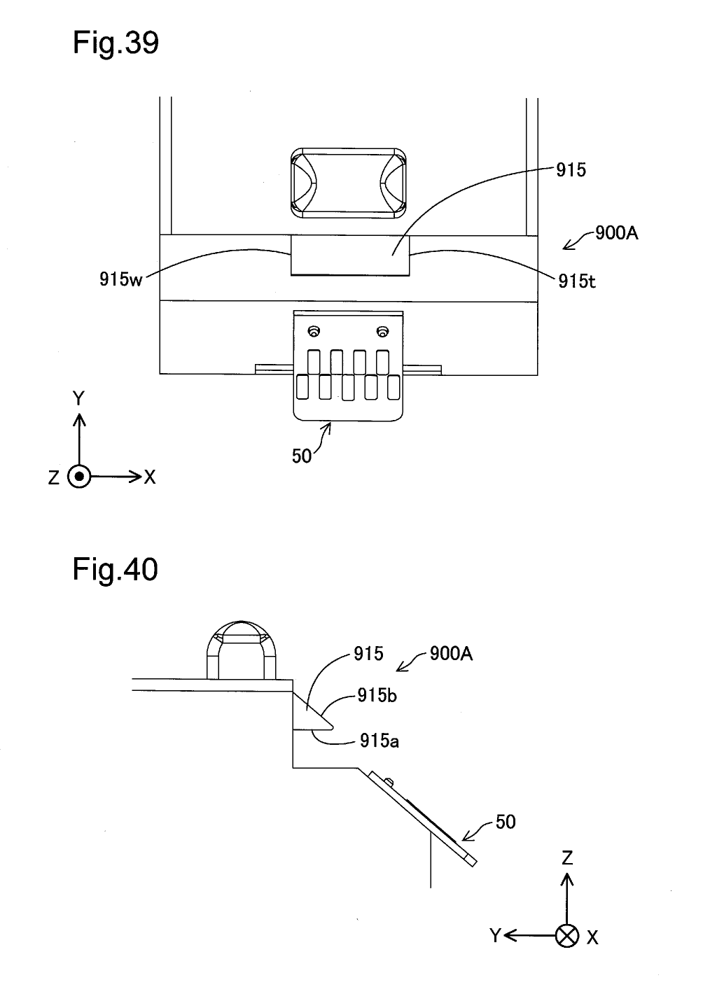

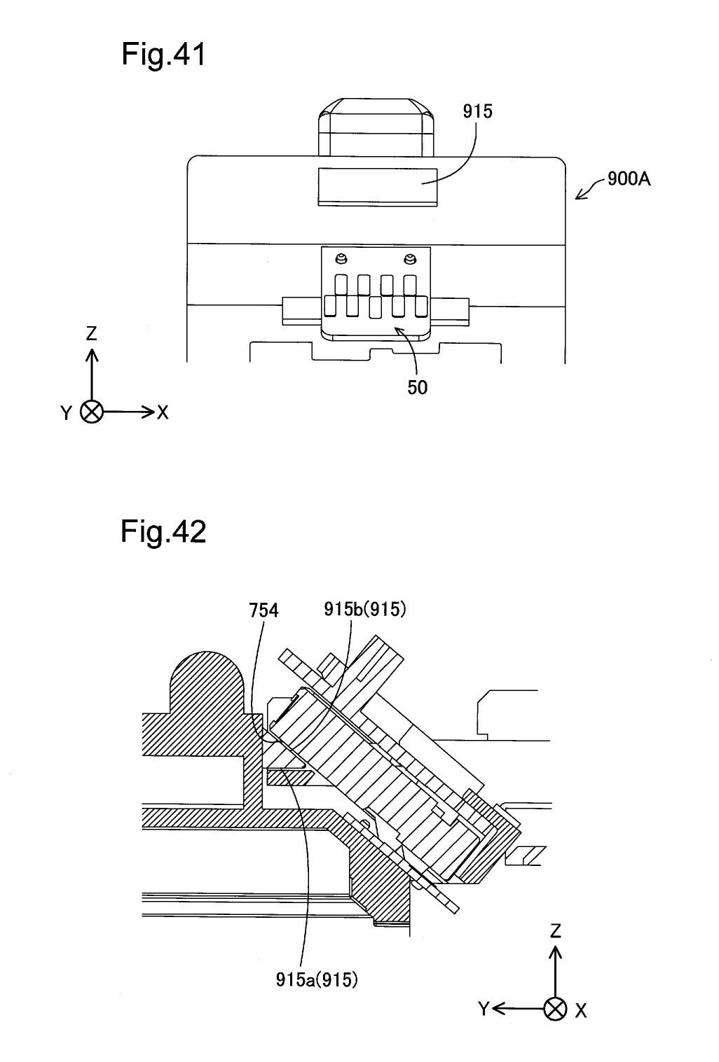

FIG. 38 is an appearance perspective view illustrating the periphery of a terminal placing structure 900A. FIG. 39 is a diagram illustrating the periphery of the terminal placing structure 900A viewed from the +Z-axis direction side. FIG. 40 is a diagram illustrating the periphery of the terminal placing structure 900A viewed from the −X-axis direction side. FIG. 41 is a front view illustrating the periphery of the terminal placing structure 900A.

As shown in FIG. 38, like the terminal placing structure 900 of the first embodiment, the terminal placing structure 900A of the second embodiment has a recess 90 that is formed to receive the apparatus-side terminal assembly 70 of the printer 10 (shown in FIG. 10) inserted therein. The recess 90 denotes a recessed portion in the neighborhood of a section where a top face 43 and a front face 42 of the cartridge 4 cross each other. Unlike the terminal placing structure 900 of the first embodiment, the terminal placing structure 900A of the second embodiment has the recess 90 that does not have the pair of side walls 902t and 902w (shown in FIG. 27) but is configured from a bottom wall 988 and a rear wall 986 as primary surfaces.

A circuit board 50 is provided in the recess 90. The rear wall 986 and the bottom wall 988 that are the surfaces constituting the recess 90 serve to support the circuit board 50 and are thus also called supporting structure. A cartridge-side terminal group 521 is provided on a surface 50fa of the circuit board 50. The cartridge-side terminal group 521 includes a plurality of terminals (nine terminals according to the embodiment). In the mounted state, the respective terminals of the cartridge-side terminal group 521 are in contact with the corresponding respective terminals of the apparatus-side terminal group 721 (shown in FIG. 16) to be electrically connected with the corresponding respective terminals.

As shown in FIG. 38, regions of the cartridge-side terminal group 521 that are in contact with the apparatus-side terminal group 721 are called contact regions 522. The terminal contacts 722 of the apparatus-side terminal group 721 (shown in FIG. 16) that is in contact with the cartridge-side terminal group 521 are arrayed to form a plurality of lines (two lines C1 and C2 according to the embodiment) arranged at predetermined intervals in the −Y-axis direction (mounting direction). A plurality of (nine according to the embodiment) contact regions 522 of the cartridge-side terminal group 521 are accordingly arrayed to form a plurality of lines (two lines according to the embodiment) arranged at predetermined intervals in the −Y-axis direction. The plurality of lines are two lines according to the embodiment but may be three or more lines.

The surface 50fa of the circuit board 50 is inclined to the mounting direction (−Y-axis direction). The plurality of contact regions 522 are located on the surface 50fa of the circuit board 50. Accordingly a virtual plane VS passing through the plurality of contact regions 522 is a plane that comes into contact with the surface 50fa of the circuit board 50 and is inclined to the mounting direction (−Y-axis direction).

As shown in FIG. 10, the apparatus-side terminal assembly 70 is mounted to the apparatus-side front wall portion 62 (more specifically, the terminal mounting structure 694) to be movable in the X-axis direction and in the Z-axis direction. In other words, the apparatus-side terminal assembly 70 is mounted to the apparatus-side front wall portion 62 to be movable in intersecting directions that intersect with the mounting direction (−Y-axis direction). The intersecting directions are directions including the X-axis direction and the Z-axis direction.

According to the embodiment, the terminal placing structure 900A includes a convex 915. The convex 915 is provided on the rear wall 986 of the supporting structure and is protruded in a direction away from the rear wall 986. More specifically, the convex 915 is protruded forward in the mounting direction (−Y-axis direction) from the rear wall 986 of the supporting structure. The convex 915 is formed in a shape having a dimension in the Z-axis direction decreasing from the +Y-axis direction side toward the −Y-axis direction side. As shown in FIG. 40, a lower portion 915a that is a −Z-axis direction-side portion of the convex 915 is parallel to an XY plane. An upper portion 915b that is a +Z-axis direction-side portion of the convex 915 is, on the other hand, inclined to the XY plane. In other words, the upper portion 915b of the convex 915 is inclined to the mounting direction (−Y-axis direction). A part including the circuit board 50 and the convex 915 is called terminal connection assembly 95. The terminal connection assembly 95 is a portion mountable to the printer 10. The terminal connection assembly 95 is accordingly a portion or a unit involved in connection with the apparatus-side terminal assembly 70 of the printer 10.

In the state that the cartridge 4 is mounted to the printer 10, the convex 915 is engaged with a positioning concave 754 of the apparatus-side terminal assembly 70 shown in FIG. 10. As shown in FIG. 14, the positioning concave 754 is a recess provided on the −Y-axis direction side and defined by the positioning structure 750 and the terminal base 724. More specifically, the positioning concave 754 is formed to have (i) the pair of wall portions 752t and 752w of the positioning structure 750; (ii) a surface 753 that is a surface on the −Y-axis direction side of the positioning structure 750 and is horizontal to the XY plane; and (iii) the surface 724fa of the terminal base 724 as primary surfaces.

FIG. 42 is a sectional view along a YZ plane illustrating the state that the convex 915 of the cartridge 4 is engaged with the positioning concave 754 of the printer 10. As shown in FIG. 42, in this state, the lower portion 915a of the convex 915 is in contact with the surface 753 of the positioning structure 750 that forms the positioning concave 754.

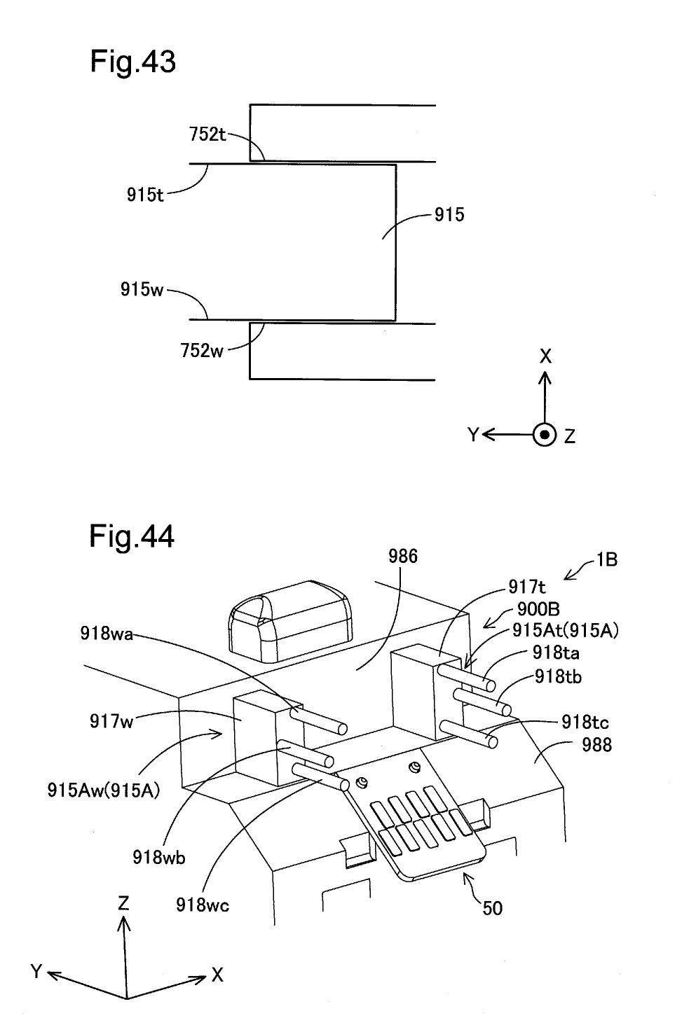

FIG. 43 is a sectional view along an XY plane illustrating the state that that the convex 915 of the cartridge 4 is engaged with the positioning concave 754 of the printer 10. As shown in FIG. 43, in this state, a first side portion 915t that is a +X-axis direction-side portion of the convex 915 is in contact with the first wall portion 752t of the positioning concave 754. A second side portion 915w that is a −X-axis direction-side portion of the convex 915 is in contact with the second wall portion 752w of the positioning concave 754. Accordingly the side portions 915t and 915w of the convex 915 are in contact with the wall portions 752 of the positioning structure 750.

According to this embodiment, in the state that the cartridge 4 is mounted to the printer 10, the convex 915 is engaged with the positioning concave 754 shown in FIG. 10. This configuration enables the apparatus-side terminal group 721 to be positioned relative to the cartridge-side terminal group 521 with high accuracy.

According to this embodiment, as shown in FIG. 42, the lower portion 915a of the convex 915 is in contact with the surface 753 of the positioning structure 750 that forms the positioning concave 754. The upper portion 915b of the convex 915 is in contact with the surface 724fa of the terminal base 724 that forms the positioning concave 754. The lower portion 915a and the upper portion 915b of the convex 915 accordingly restrict the motion of the apparatus-side terminal group 721 in the Z-axis direction. This results in ensuring the good contact between the apparatus-side terminal group 721 and the cartridge-side terminal assembly 521.

According to this embodiment, as shown in FIG. 43, the side portions 915t and 915w of the convex 915 are in contact with the wall portions 752 of the positioning structure 750. The side portions 915t and 915w of the convex 915 provided on the cartridge 4 accordingly restrict the motion of the apparatus-side terminal group 721 in the X-axis direction. This results in ensuring the good contact between the apparatus-side terminal group 721 and the cartridge-side terminal assembly 521.

### C. Third Embodiment

A printing material supply system 1B of a third embodiment differs from the printing material supply system 1A of the second embodiment by the configuration of a terminal placing structure 900B, but otherwise has the similar configuration to that of the printing material supply system 1A of the second embodiment.

The detailed configuration of the terminal placing structure 900B of the third embodiment is described below with reference to FIG. 44. FIG. 44 is an appearance perspective view illustrating the periphery of the terminal placing structure 900B.

As shown in FIG. 44, according to the third embodiment, convexes 915A are protruded in the −Y-axis direction from the rear wall 986. The convexes 915A are arrayed in the X-axis direction and include a first convex 915At on the +X-axis direction side of the circuit board 50 and a second convex 915Aw on the −X-axis direction side of the circuit board 50.

The first convex 915At includes (i) a member 917t that abuts on the rear wall 986 and is formed in an approximately rectangular prism shape; and (ii) members 918t that are extended in the −Y-axis direction from the member 917t and are formed in an approximately cylindrical shape. Similarly, the second convex 915Aw includes (i) a member 918w that abuts on the rear wall 986 and is formed in an approximately rectangular prism shape; and (ii) members 918w that are extended in the −Y-axis direction from the member 917w and are formed in an approximately cylindrical shape. The members 917t and 917w may be collectively called members 917, and the members 918t and 918w may be collectively called members 918.

Each of the first convex 915At and the second convex 915Aw includes three members 918. More specifically, the members 918t of the first convex 915At include members 918ta, 918tb and 918tc arranged sequentially from the +Z-axis direction side. Similarly the members 918w of the second convex 915Aw include members 918wa, 918wb and 918wc arranged sequentially from the +Z-axis direction side. The members 918ta, 918tb and 918tc are arranged at equal intervals in the Z-axis direction. Similarly the members 918wa, 918wb and 918wc are arranged at equal intervals in the Z-axis direction. The member 918ta and the member 918tc are located on the same position in the X-axis direction. The member 918tb is located on the +X-axis direction side of the members 918ta and 918tc. The member 918wa and the member 918wc are located on the same position in the X-axis direction. The member 918wb is, on the other hand, located on the −X-axis direction side of the members 918wa and 918wc.

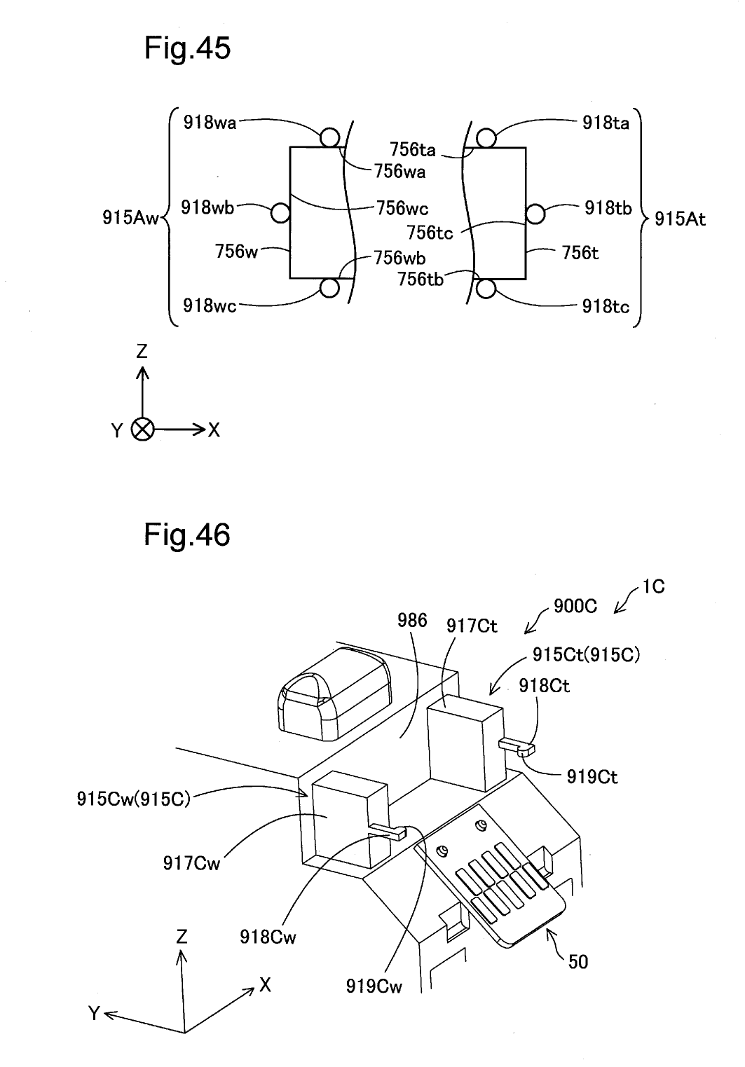

FIG. 45 is an XZ sectional view illustrating a relationship between the members 918 of the cartridge 4 and the positioning convexes 756 of the apparatus-side terminal assembly 70 in the state that the cartridge 4 is mounted to the printer 10. In the state that the cartridge 4 is mounted to the printer 10, the convexes 915A restrict the motion of the positioning convexes 756 of the apparatus-side terminal assembly 70 in the intersecting direction (X-axis direction and Z-axis direction). More specifically, the contact plane 756ta of the positioning convex 756t that is the plane located on the +Z-axis direction side is in contact with the member 918ta of the first convex 915At. The contact plane 756tc of the positioning convex 756t that is the plane crossing the X-axis direction is in contact with the member 918tb of the first convex 915At. Similarly, the contact plane 756wa of the positioning convex 756w that is the plane located on the +Z-axis direction side is in contact with the member 918wa of the second convex 915Aw. The contact plane 756wc of the positioning convex 756w that is the plane crossing the X-axis direction is in contact with the member 918wb of the second convex 915Aw. Although not being specifically illustrated, the contact plane 756td of the positioning convex 756t that is the plane located on the +Y-axis direction side is in contact with the member 917t of the first convex 915At. Similarly, the contact plane 756wd of the positioning convex 756w that is the plane located on the +Y-axis direction side is in contact with the member 917w of the second convex 915Aw.

According to this embodiment, as shown in FIG. 45, the convexes 915A are engaged with the positioning convexes 756 of the apparatus-side terminal assembly 70. This configuration enables the apparatus-side terminal group 721 to be positioned relative to the cartridge-side terminal group 521 with high accuracy. Each of the first convex 915At and the second convex 915Aw includes three members 918 according to this embodiment but may include four or more members 918. Alternatively each of the first convex 915At and the second convex 915Aw may include two members 918. In the latter case, the convex 915At or 915Aw may not include the member 918tb or 918wb. The first wall portion 752t of the apparatus-side terminal assembly 70 (shown in FIG. 16) may be arranged to be in contact with the members 918ta and 918tc, and the second wall portion 752w of the apparatus-side terminal assembly 70 may be arranged to be in contact with the members 918wa and 918wc.

### D. Fourth Embodiment

A printing material supply system 1C of a fourth embodiment differs from the printing material supply system 1B of the third embodiment by the configuration of a terminal placing structure 900C, but otherwise has the similar configuration to that of the printing material supply system 1B of the third embodiment.

The detailed configuration of the terminal placing structure 900C of the fourth embodiment is described below with reference to FIG. 46. FIG. 46 is an appearance perspective view illustrating the periphery of the terminal placing structure 900C.

As shown in FIG. 46, according to the fourth embodiment, a plurality of (two in this embodiment) convexes 915C are provided and are protruded in the −Y-axis direction from the rear wall 986. The convexes 915C are arrayed in the X-axis direction and include a first convex 915Ct on the +X-axis direction side of the circuit board 50 and a second convex 915Cw on the −X-axis direction side of the circuit board 50.

The first convex 915Ct includes (i) a member 917Ct that abuts on the rear wall 986 and is formed in an approximately rectangular prism shape; and (ii) a member 918Ct that is extended in the −Y-axis direction from the member 917Ct and is formed in an approximately rectangular prism shape. Similarly, the second convex 915Cw includes (i) a member 917Cw that abuts on the rear wall 986 and is formed in an approximately rectangular prism shape; and (ii) a member 918Cw that is extended in the −Y-axis direction from the member 917Cw and is formed in an approximately rectangular prism shape. The members 917Ct and 917Cw may be collectively called members 917C, and the members 918Ct and 918Cw may be collectively called members 918C.

A protruded portion 919Ct is provided on the −Y-axis direction side of the member 918Ct to be protruded in the −X-axis direction. Similarly, a protruded portion 919Cw is provided on the −Y-axis direction side of the member 918Cw to be protruded in the +X-axis direction. The protruded portion 919Ct and the protruded portion 919Cw are protruded in the X-axis direction to be opposed to each other. In other words, respective parts of the convexes 915Ct and 915Cw are protruded in the X-axis direction to be opposed to each other. The protruded portions 919Ct and 919Cw may be collectively called protruded portions 919C.

In the state that the cartridge 4 is mounted to the printer 10, the protruded portions 919C of the convexes 915C are engaged with concaves 777 shown in FIG. 10. The concaves 777 are provided on the positioning structure 750 and are also called positioning concaves 777. As shown in FIG. 16, the concaves 777 are recesses formed on the +Y-axis direction side of the positioning convexes 756. The recess formed in the positioning convex 756t is called concave 777t, and the recess formed in the positioning convex 756w is called concave 777w.

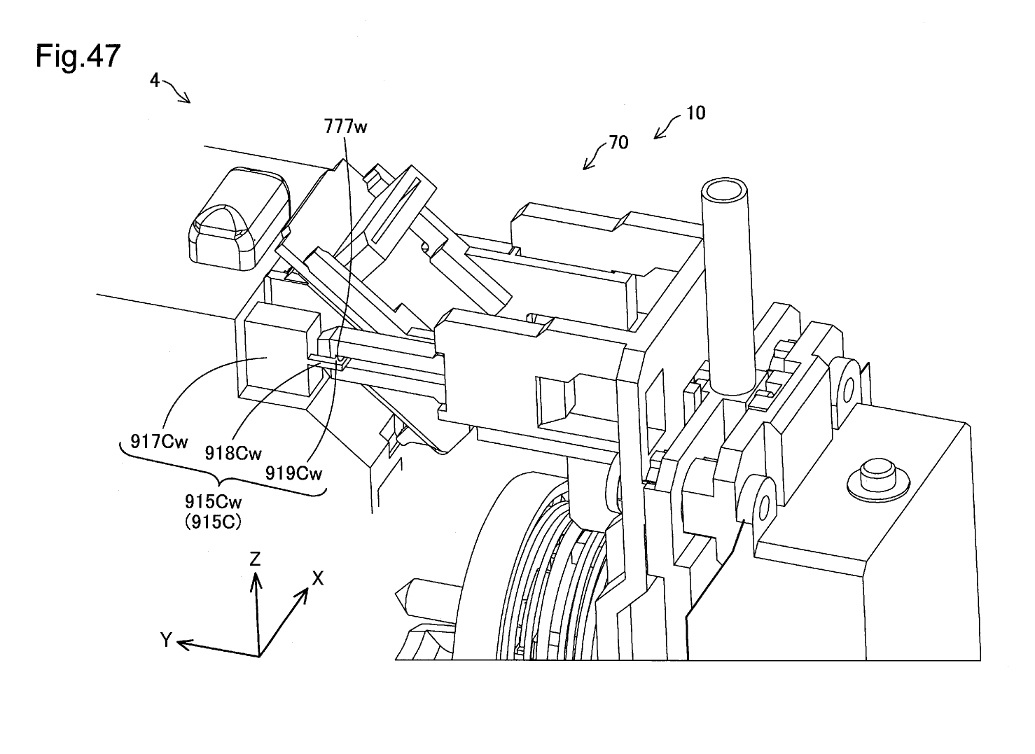

FIG. 47 is an appearance perspective view illustrating the state that the convexes 915C of the cartridge 4 are engaged with the concaves 777 of the printer 10. As shown in FIG. 47, the convexes 915C of the cartridge 4 are inserted into the concaves 777 of the printer 10. More specifically, the protruded portion 919Ct of the first convex 915Ct is inserted into the concave 777t, and the protruded portion 919Cw of the second convex 915Cw is inserted into the concave 777w.

According to this embodiment, the convexes 915C serve as restriction elements to restrict the motions of the positioning convexes 756 in the intersecting directions (X-axis direction and Z-axis direction). This configuration enables the apparatus-side terminal group 721 to be positioned relative to the cartridge-side terminal group 521 with high accuracy.

The convexes 915C of the cartridge 4 are engaged with the concaves 777 of the printer 10. This configuration suppresses the cartridge-side terminal group 521 from being moved away relative to the apparatus-side terminal group 721. Accordingly the protruded portions 919C of the convexes 915C prevent the cartridge 4 from readily coming off from the printer 10.

### E. Fifth Embodiment

A printing material supply system 1D of a fifth embodiment differs from the printing material supply system 1C of the fourth embodiment by the configuration of a terminal placing structure 900D, but otherwise has the similar configuration to that of the printing material supply system 1C of the fourth embodiment.

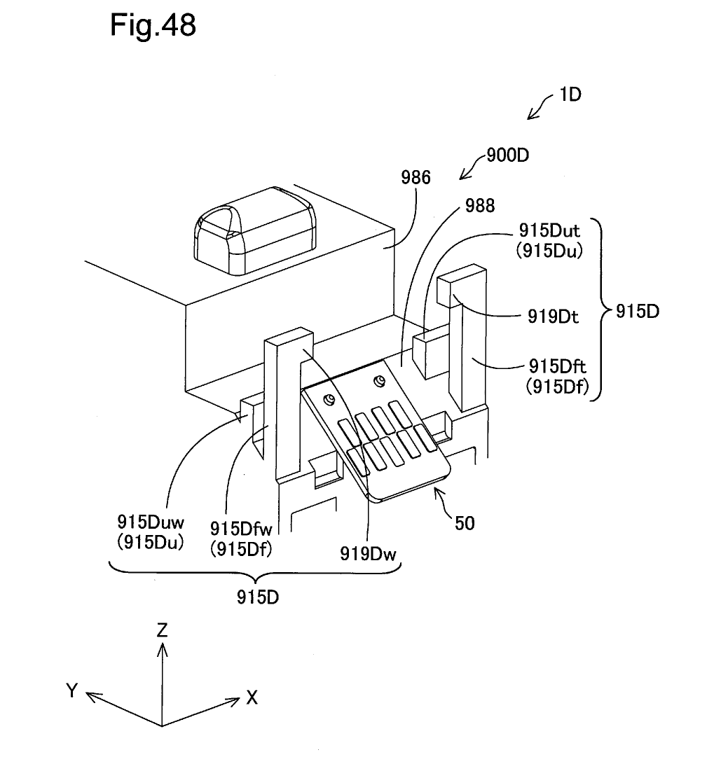

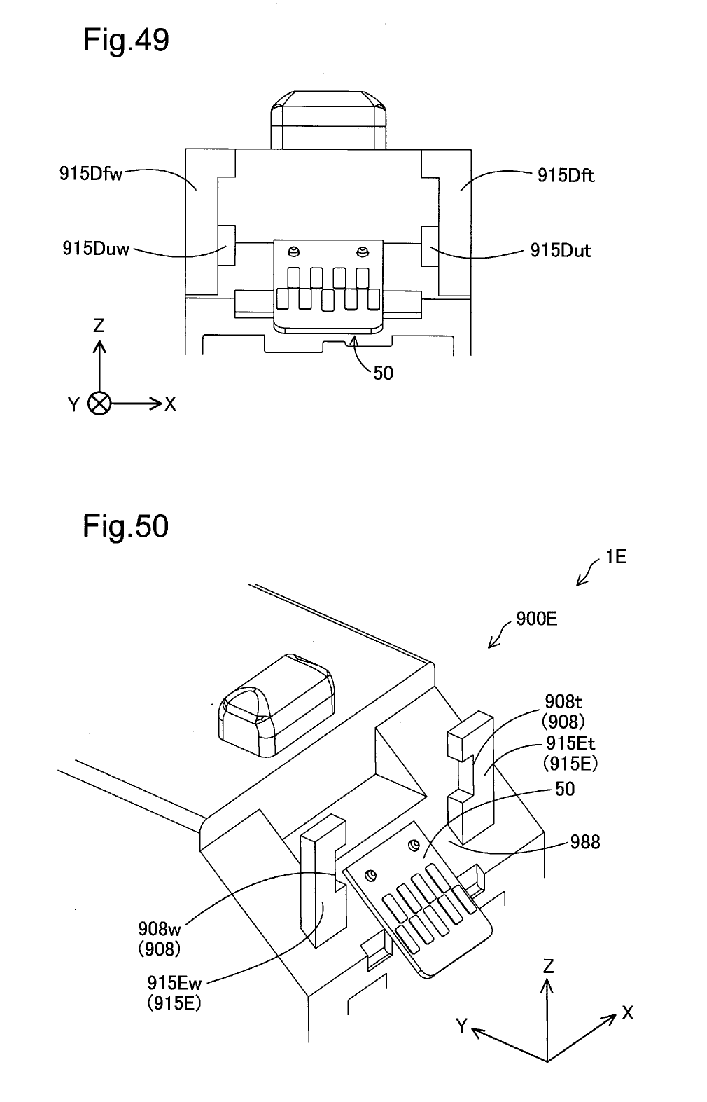

The detailed configuration of the terminal placing structure 900D of the fifth embodiment is described below with reference to FIGS. 48 and 49. FIG. 48 is an appearance perspective view illustrating the periphery of the terminal placing structure 900D. FIG. 49 is a front view illustrating the periphery of the terminal placing structure 900D.

As shown in FIGS. 48 and 49, according to the fifth embodiment, a pair of convexes 915D are provided on the −Y-axis direction side, and a pair of convexes 915D are also provided on the +Y-axis direction side. All the convexes 915D are protruded in the +Z-axis direction from a bottom wall 988 of a supporting structure for the circuit board 50. In other words, the convexes 915D are protruded upward from the bottom wall 988. The pair of convexes 915D located on the −Y-axis direction side are called convexes 915Df. One of the convexes 915Df located on the +X-axis direction side of the circuit board 50 is called first convex 915Dft, and the other of the convexes 915Df located on the −X-axis direction side of the circuit board 50 is called second convex 915Dfw. The pair of convexes 915D located on the +Y-axis direction side are called convexes 915Du. One of the convexes 915Du located on the +X-axis direction side of the circuit board 50 is called third convex 915Dut, and the other of the convexes 915Du located on the −X-axis direction side is called fourth convex 915Duw. The convexes 915D are formed in approximately rectangular prism shapes.

The first convex 915Dft includes a protruded portion 919Dt on the +Z-axis direction side. The protruded portion 919Dt is protruded in the −X-axis direction. The second convex 915Ddfw includes a protruded portion 919Dw on the +Z-axis direction side. The protruded portion 919Dw is protruded in the +X-axis direction.

According to this embodiment, in the state that the cartridge 4 is mounted to the printer 10, the convexes 915D are engaged with the positioning convexes 756 of the apparatus-side terminal assembly 70 (shown in FIG. 16). More specifically, (i) the contact plane 756ta of the positioning convex 756t that is the plane located on the +Z-axis direction side and (ii) the contact plane 756tc of the positioning convex 756t that is the plane crossing the X-axis direction are in contact with the first convex 915Dft. Similarly, (i) the contact plane 756wa of the positioning convex 956w that is the plane located on the +Z-axis direction side and (ii) the contact plane 756wc of the positioning convex 756w that is the plane crossing the X-axis direction are in contact with the second convex 915Dfw. This configuration restricts the motions of the positioning convexes 756 of the apparatus-side terminal assembly 70 (shown in FIG. 16) in the intersecting directions (X-axis direction and Z-axis direction).

### F. Sixth Embodiment

A printing material supply system 1E of a sixth embodiment differs from the printing material supply system 1D of the fifth embodiment by the configuration of a terminal placing structure 900E, but otherwise has the similar configuration to that of the printing material supply system 1D of the fifth embodiment.

The detailed configuration of the terminal placing structure 900E of the sixth embodiment is described below with reference to FIG. 50. FIG. 50 is an appearance perspective view illustrating the periphery of the terminal placing structure 900E.

As shown in FIG. 50, a pair of convexes 915E are provided on a bottom wall 988 of a supporting structure and are protruded in the +Z-axis direction. The convexes 915E are formed in an approximately rectangular prism shape. One of the pair of convexes 915E located on the +X-axis direction side of the circuit board 50 is also called first convex 915Et, and the other located on the −X-axis direction side of the circuit board 50 is also called second convex 915Ew. The pair of convexes 915E have a pair of grooves 908. The first groove 908t of the first convex 915Et is recessed in the +X-axis direction, and the second groove 908w of the second convex 915Ew is recessed in the −X-axis direction.

According to this embodiment, in the state that the cartridge 4 is mounted to the printer 10, the grooves 908 of the convexes 915E are engaged with the positioning convexes 756 of the apparatus-side terminal assembly 70 (shown in FIG. 16). This configuration restricts the motions of the positioning convexes 756 of the apparatus-side terminal assembly 70 in the intersecting directions (X-axis direction and Z-axis direction).

### G. Seventh Embodiment

A printing material supply system 1F of a seventh embodiment differs from the printing material supply system 1E of the sixth embodiment by the configuration of a terminal placing structure 900F, but otherwise has the similar configuration to that of the printing material supply system 1E of the sixth embodiment.

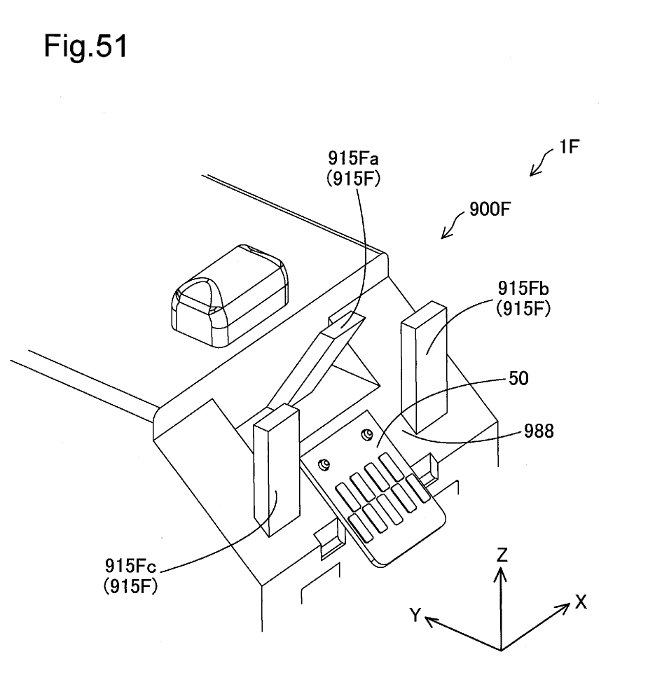

The detailed configuration of the terminal placing structure 900F of the seventh embodiment is described below with reference to FIG. 51. FIG. 51 is an appearance perspective view illustrating the periphery of the terminal placing structure 900F.

As shown in FIG. 51, according to the seventh embodiment, one convex 915F is provided on the +Y-axis direction side, and a pair of convexes 915F are provided on the −Y-axis direction side. The convexes 915F are formed in approximately rectangular prism shapes. The convex 915F located on the +Y-axis direction side is called convex 915Fa. In the pair of convexes 915F provided on the −Y-axis direction side, one located on the +X-axis direction side of the circuit board 50 is called convex 915Fb, and the other located on the −X-axis direction side of the circuit board 50 is called convex 915Fc. The convex 915Fa is protruded to be inclined in a direction including a −Y-axis direction component and a +Z-axis direction component. The convex 915Fb and the convex 915Fc are protruded in the +Z-axis direction.

According to the seventh embodiment, in the state that the cartridge 4 is mounted to the printer 10, the convex 915Fa is in contact with a surface 724fc of the terminal base 724 (shown in FIG. 14). The surface 724fc of the terminal base 724 is a surface facing in a direction including a +Y-axis direction component and a +Z-axis direction component. The convex 915Fb is in contact with the first wall portion 752t of the positioning structure 750. The convex 915Fc is in contact with the second wall portion 752w of the positioning structure 750. The convexes 915F accordingly serve to restrict the motions of the positioning convexes 756 of the apparatus-side terminal assembly 70 in the intersecting directions (X-axis direction and Z-axis direction).

### H. Modifications

The invention is not limited to any of the embodiments described above but may be implemented by a diversity of other aspects without departing from the scope of the invention. Some of possible modifications are given below.

### H-1. Modification 1

In the above embodiments, the circuit board 50 is integrally provided with the storage unit 525 as shown in FIG. 29. The invention is, however, not limited to this configuration. The storage unit 525 may be provided at a location away from the circuit board 50.

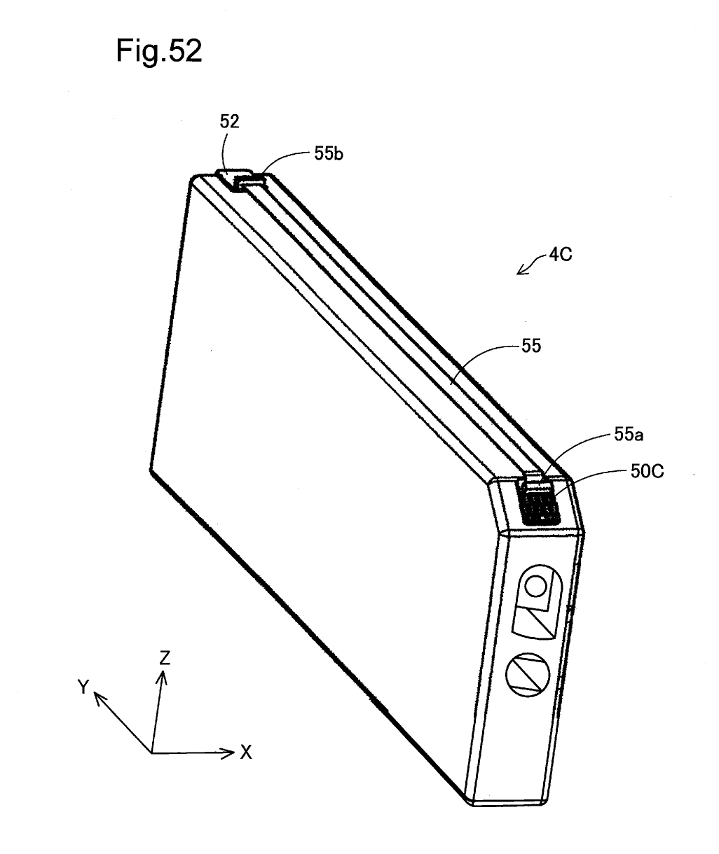

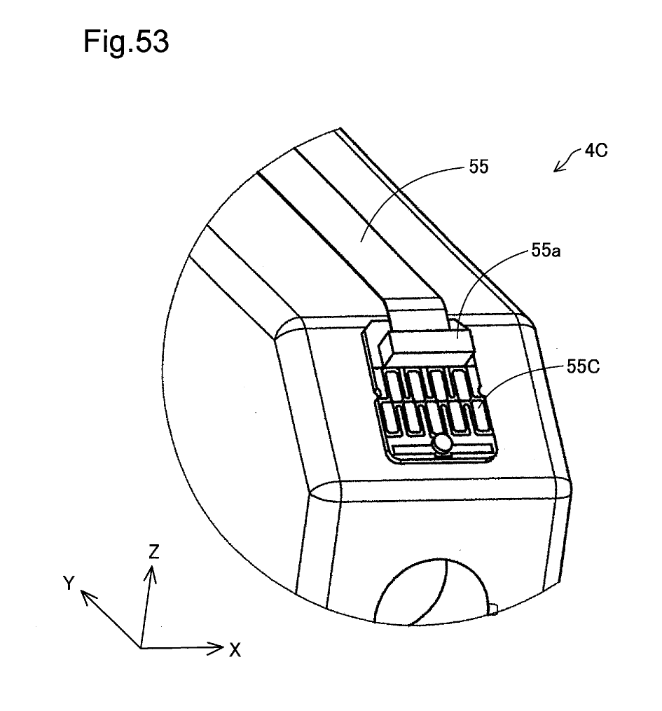

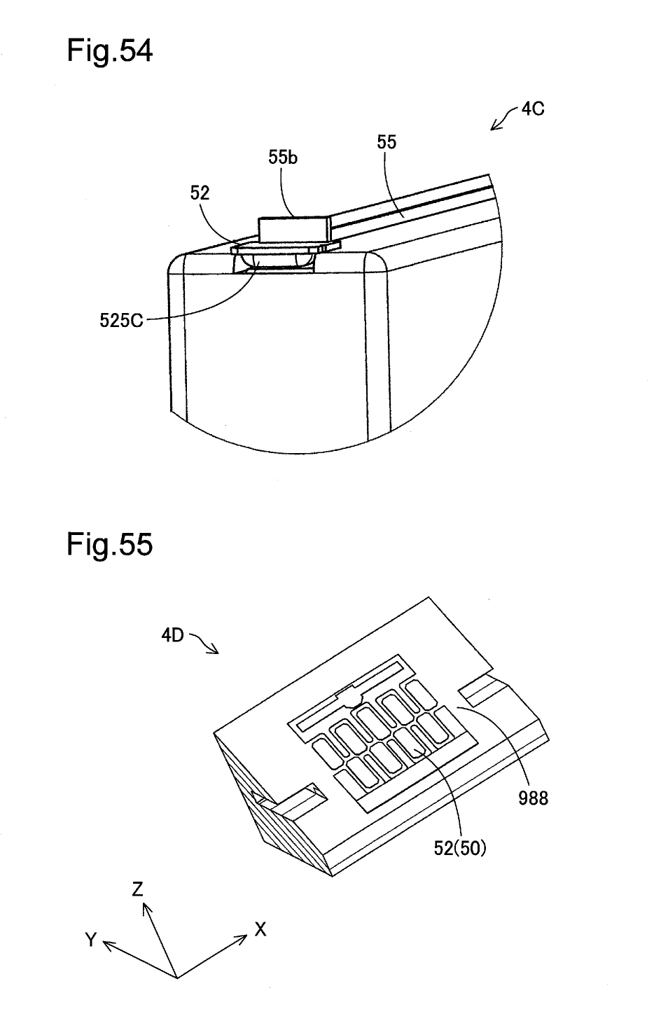

FIGS. 52 to 54 are diagrams illustrating a cartridge 4C as an example of the configuration having a storage unit separate from a circuit board. The configuration other than the circuit board and the storage unit is simplified in the illustration of FIGS. 52 to 54. FIG. 52 is an appearance perspective view illustrating the cartridge 4C. FIG. 53 is an enlarged view illustrating the periphery of a circuit board 50C provided on the −Y-axis direction side of the cartridge 4C. FIG. 54 is an enlarged view illustrating the periphery of a storage unit 525C provided on the +Y-axis direction side of the cartridge 4C. According to this modification, the circuit board 50C and the storage unit 525C are electrically connected via a cable 55. According to this modification, an FFC (flexible flat cable) is used for the cable 55. As shown in FIG. 53, the circuit board 50C and the cable 55 are electrically connected by a connector 55a. As shown in FIG. 54, the storage unit 525C and the cable 55 are electrically connected by a connector 55b. As shown in FIG. 54, the storage unit 525C is provided on a substrate 52. Providing the storage unit 525C at a position away from the circuit board 50C enables the location of the storage unit 525C to be determined flexibly. The circuit board 50C and the cable 55 may be configured from an FPC (flexible printed circuit) board. The cable 55 and the substrate 52 may be configured from an FPC board. The circuit board 50C, the substrate 52 and the cable 55 may be configured from an FPC board.

### H-2. Modification 2

In the above embodiments, the circuit board 50 is supported by the supporting structure 988 as shown in FIG. 29. In other words, the circuit board 50 and the supporting structure 988 are provided as separate bodies. The invention is, however, not limited to this configuration. The circuit board 50 and the supporting structure 988 may be integrated with each other.

FIG. 55 is a top view illustrating a cartridge 4D having a circuit board 55 integrated with a supporting structure 988. According to this modification, a cartridge-side terminal group 521 is directly patterned on a bottom wall 988 serving as the supporting structure. According to another modification, a cartridge-side terminal group 521 may be directly patterned on a member constituting the bottom wall 988, and the member may be fit in the recess 90.

### H-3. Modification 3

Information, such as the remaining amount of ink and the presence or the absence of ink, stored in the storage unit 525 may be configured to be resettable or rewritable. The information may be reset or rewritten by the printer 10 or by another apparatus.

### H-4. Modification 4

In the above embodiments, the cartridge 4 contains ink inside thereof as shown in FIG. 3. The invention is, however, not limited to this configuration. The cartridge 4 may be configured to contain ink outside thereof.

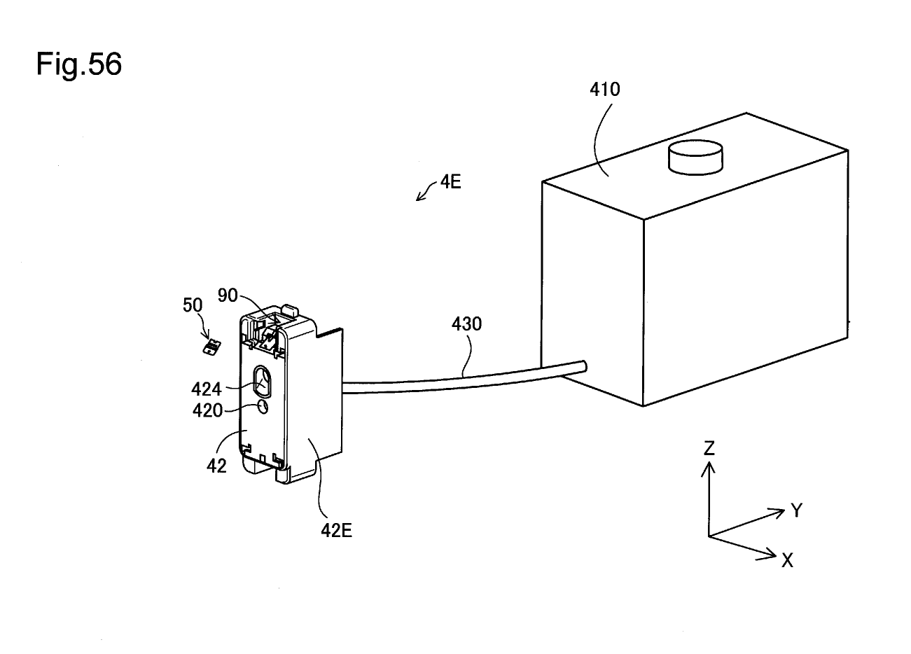

FIG. 56 is a diagram illustrating a cartridge 4E configured to contain ink outside thereof. According to this modification, the cartridge 4E includes a member 42E having a front face 42 with a circuit board 50, a recess 90 and a supply pipe insertion hole 424 provided thereon, an ink tank 410 and a tube 430 arranged to connect the member 42E with the ink tank 410. Ink contained in the ink tank 410 flows through the tube 430 into the member 42E. The ink flowing into the member 42E is then supplied to the printer 10. This modified configuration allows the ink tank 410 to be located away from the printer 10.

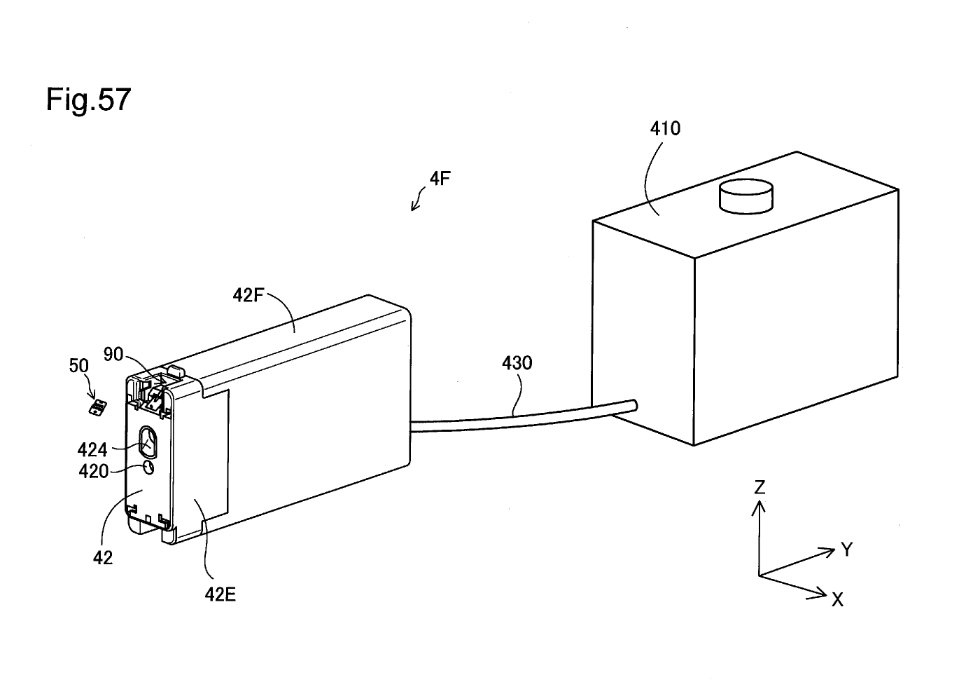

FIG. 57 is a diagram illustrating a cartridge 4F configured to contain ink outside thereof. The cartridge 4F differs from the cartridge 4E by the configuration that a box-like member 42F having surfaces corresponding to the top face 43, the bottom face 44, the right side face 45 and the left side face 46 is connected with a +Y-axis direction-side end of the member 42E for facilitating attachment to the printer 10, but otherwise has the similar configuration to that of the cartridge 4E.

### H-5. Modification 5

In the above embodiments, as shown in FIG. 27, the circuit board 50 is inclined to the mounting direction (−Y-axis direction) even in the state that the circuit board 50 is not mounted to the printer 10, like in the state that the circuit board 50 is mounted to the printer 10. The invention is, however, not limited to this configuration. The circuit board 50 may not be inclined to the mounting direction (−Y-axis direction) in the state that the circuit board 50 is not mounted to the printer 10.

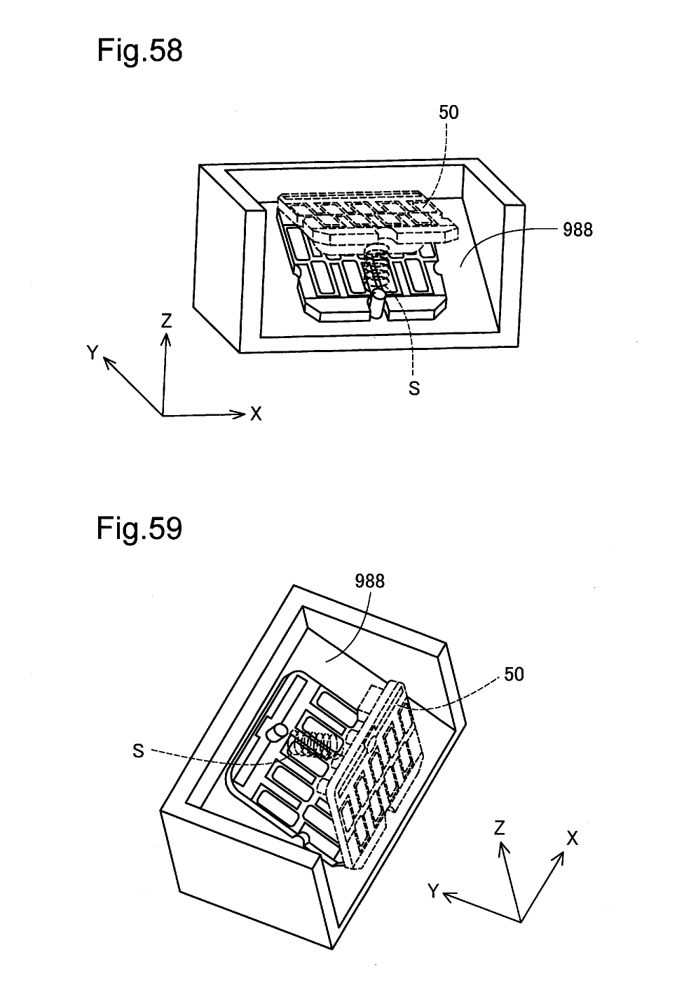

FIG. 58 is a diagram illustrating one example of a circuit board 50 configured to be not inclined to the mounting direction (−Y-axis direction) in the state that the circuit board 50 is not mounted to the printer 10. According to this modification, a spring S is provided between the rear face of the circuit board 50 and the supporting structure 988. The circuit board 50 is accordingly kept parallel to the mounting direction (−Y-axis direction) in the state that the circuit board 50 is not mounted to the printer 10, and is inclined to the mounting direction (−Y-axis direction) in the state that the circuit board 50 is mounted to the printer 10.

FIG. 59 is a diagram illustrating another example of a circuit board 50 configured to be not inclined to the mounting direction (−Y-axis direction) in the state that the circuit board 50 is not mounted to the printer 10. According to this modification, a spring S is provided between the rear face of the circuit board 50 and the supporting structure 988. The circuit board 50 is accordingly kept perpendicular to the mounting direction (−Y-axis direction) in the state that the circuit board 50 is not mounted to the printer 10, and is inclined to the mounting direction (−Y-axis direction) in the state that the circuit board 50 is mounted to the printer 10.

### H-6. Modification 6

Various configurations of the convexes 915 are described in the above embodiments. The invention is, however, not limited to these configurations. The configurations of the convexes 915 described in the embodiments may be employed in combination. For example, the convexes 915C of the fourth embodiment (shown in FIG. 46) may be combined with the convexes 915D of the fifth embodiment.

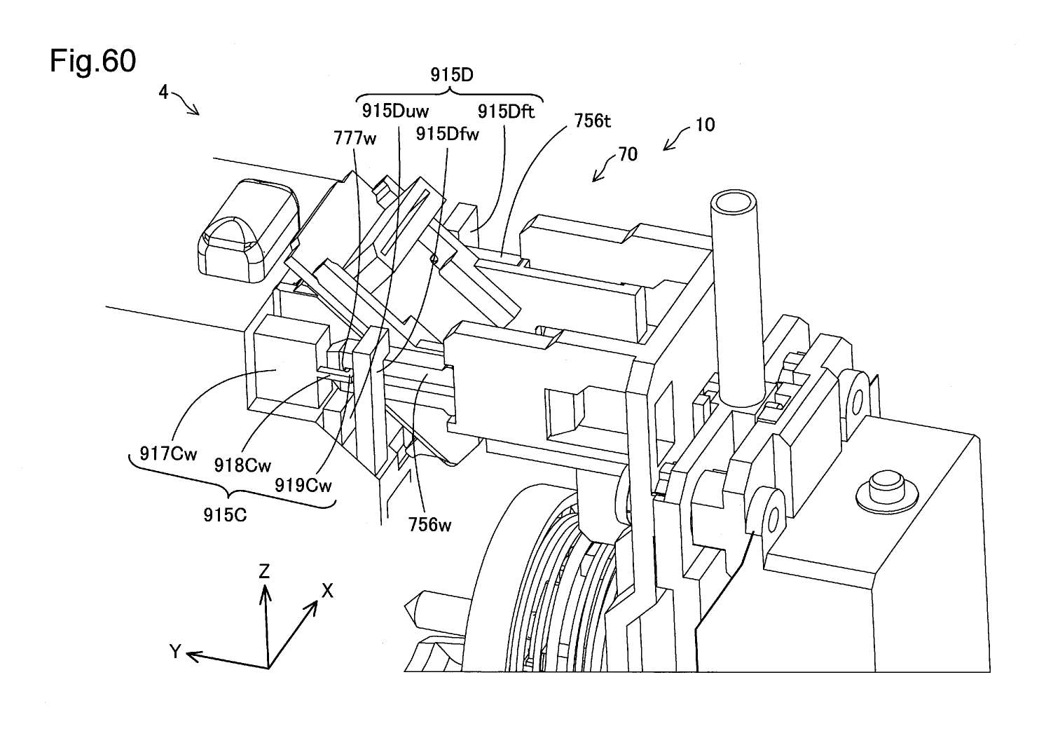

FIG. 60 is an appearance perspective view illustrating the state that the convexes 915C and the convexes 915D of the cartridge 4 are engaged with the concaves 777 and the positioning convexes 756 of the printer 10. As shown in FIG. 60, the convexes 915C of the cartridge 4 are inserted into the concaves 777 of the printer 10. More specifically, the protruded portion 919Ct of the first convex 915Ct is inserted into the recess 777t, and the protruded portion 919Cw of the second convex 915Cw is inserted into the recess 777w. The convexes 915D are engaged with the positioning convexes 756 of the apparatus-side terminal assembly 70.

### H-7. Modification 7

An FPC (flexible printed circuit) board may be used for the circuit board 50.

### H-8. Modification 8

The present invention is not limited to the inkjet printer or its ink cartridge but is also applicable to any printing apparatus configured to eject another liquid but ink and its cartridge. For example, the invention may be applied to any of various printing apparatuses and their cartridges given below:

(1) image recording apparatus such as a facsimile machine;

(2) printing apparatus configured to eject a color material used for manufacturing color filters for an image display apparatus such as a liquid crystal display;

(3) printing apparatus configured to eject an electrode material used for forming electrodes of, for example, an organic EL (electroluminescence) display and a field emission display (FED);

(4) printing apparatus configured to eject a bioorganic material-containing liquid used for manufacturing biochips;

(5) sample printing apparatus used as a precision pipette;

(6) printing apparatus of lubricating oil;

(7) printing apparatus of a resin solution;

(8) printing apparatus for pinpoint ejection of lubricating oil on precision machines such as watches or cameras;

(9) printing apparatus configured to eject a transparent resin solution, such as an ultraviolet curable resin solution, onto a substrate in order to manufacture a hemispherical microlens (optical lens) used for, for example, optical communication elements;

(10) printing apparatus configured to eject an acidic or alkaline etching solution in order to etch a substrate or the like; and

(11) printing apparatus equipped with a liquid ejection head configured to eject a very small volume of droplets of any other liquid.

The “droplet” herein means the state of liquid ejected from the printing apparatus and may be in a granular shape, a teardrop shape or a tapered threadlike shape. The “liquid” herein may be any material ejectable from the printing apparatus. The “liquid” may be any material in the liquid phase. For example, liquid-state materials of high viscosity or low viscosity, sols, aqueous gels and other liquid-state materials including inorganic solvents, organic solvents, solutions, liquid resins and liquid metals (metal melts) are included in the “liquid”. The “liquid” is not limited to the liquid state as one of the three states of matter but includes solutions, dispersions and mixtures of the functional solid material particles, such as pigment particles or metal particles, solved in, dispersed in or mixed with a solvent. Typical examples of the liquid include ink described in the above embodiment and liquid crystal. The ink herein includes general water-based inks and oil-based inks, as well as various liquid compositions, such as gel inks and hot-melt inks.

1. A terminal connection assembly configured to be mountable to a printing apparatus, the printing apparatus comprising an apparatus-side terminal assembly configured to be movable in an intersecting direction that intersects with a mounting direction in which the terminal connection assembly is mounted; and a positioning structure included in the apparatus side terminal assembly,
the terminal connection assembly comprising:
terminals configured to be electrically connectable with the apparatus-side terminal assembly;
contact regions where the apparatus-side terminal assembly is in contact with the terminals;
a substrate on which the terminals are provided;
a supporting structure configured to support the substrate; and
convexes configured to restrict motion of the positioning structure in the intersecting direction, wherein
in a state that the terminal connection assembly is mounted to the printing apparatus, a plurality of the contact regions are arranged to form a plurality of lines arrayed at predetermined intervals in the mounting direction,
a virtual plane passing through the plurality of contact regions is inclined to the mounting direction, and
the convex is protruded in a direction away from the supporting structure.

2. The terminal connection assembly according to claim 1,
wherein the convex is protruded forward in the mounting direction from the supporting structure.

3. The terminal connection assembly according to claim 1,
wherein the convex is engaged with a positioning concave provided in the positioning structure.

4. The terminal connection assembly according to claim 1,
wherein some of a plurality of the convexes are protruded in the intersecting direction to face each other.

5. The terminal connection assembly according to claim 1,
wherein the convex has a lower portion arranged to abut on the positioning structure.

6. The terminal connection assembly according to claim 1,
wherein the convex has a side portion arranged to abut on the positioning structure.

7. The terminal connection assembly according to claim 1,
wherein the convex is protruded upward from the supporting structure.

8. The terminal connection assembly according to claim 1,
wherein the convex is engaged with a positioning convex provided in the positioning structure.

9. The terminal connection assembly according to claim 7,
wherein some of a plurality of the convexes are protruded in the intersecting direction to face each other.

10. The terminal connection assembly according to claim 7,
wherein the convex has a lower portion arranged to abut on the positioning structure.

11. The terminal connection assembly according to claim 7,
wherein the convex has a side portion arranged to abut on the positioning structure.

12. A cartridge configured to be mountable to a printing apparatus, the printing apparatus comprising an apparatus-side terminal assembly configured to be movable in an intersecting direction that intersects with a mounting direction in which the cartridge is mounted; and a positioning structure included in the apparatus side terminal assembly,
the cartridge comprising:
terminals configured to be electrically connectable with the apparatus-side terminal assembly;
contact regions where the apparatus-side terminal assembly is in contact with the terminals;
a substrate on which the terminals are provided;
a supporting structure configured to support the substrate; and
convexes configured to restrict motion of the positioning structure in the intersecting direction, wherein
in a state that the cartridge is mounted to the printing apparatus, a plurality of the contact regions are arranged to form a plurality of lines arrayed at predetermined intervals in the mounting direction,
a virtual plane passing through the plurality of contact regions is inclined to the mounting direction, and
the convex is protruded in a direction away from the supporting structure.

13. The cartridge according to claim 12,
wherein the convex is protruded forward in the mounting direction from the supporting structure.

14. The cartridge according to claim 12,
wherein the convex is engaged with a positioning concave provided in the positioning structure.

15. The cartridge according to claim 12,
wherein some of a plurality of the convexes are protruded in the intersecting direction to face each other.

16. The cartridge according to claim 12,
wherein the convex has a lower portion arranged to abut on the positioning structure.

17. The cartridge according to claim 12,
wherein the convex has a side portion arranged to abut on the positioning structure.

18. The cartridge according to claim 12,
wherein the convex is protruded upward from the supporting structure.

19. The cartridge according to claim 12,
wherein the convex is engaged with a positioning convex provided in the positioning structure.

20. The cartridge according to claim 18,
wherein some of a plurality of the convexes are protruded in the intersecting direction to face each other.

21. The cartridge according to claim 18,
wherein the convex has a lower portion arranged to abut on the positioning structure.

22. The cartridge according to claim 18,
wherein the convex has a side portion arranged to abut on the positioning structure.
